(19) United States
(12) Patent Application Publication
(10) Pub. No.: US 2009/0189830 A1
(43) Pub. Date: Jul. 30, 2009

(54) Eye Mounted Displays

(76) Inventors: Michael F. Deering, Los Altos, CA (US); Alan Huang, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/359,211

(22) Filed: Jan. 23, 2009

Related U.S. Application Data
(60) Provisional application No. 61/023,073, filed on Jan. 23, 2008.

(51) Int. Cl. G09G 5/00

(52) U.S. Cl. 345/1.3; 345/8; 345/8

(57) ABSTRACT

A display device is mounted on and/or inside the eye. The eye mounted display contains multiple sub-displays, each of which projects light to different retinal positions within a portion of the retina corresponding to the sub-display. The projected light propagates through the pupil but does not fill the entire pupil. In this way, multiple sub-displays can project their light onto the relevant portion of the retina. Moving from the pupil to the cornea, the projection of the pupil onto the cornea will be referred to as the corneal aperture. The projected light propagates through less than the full corneal aperture. The sub-displays use spatial multiplexing at the corneal surface.

### CROSS-REFERENCE TO RELATED APPLICATION(S)

This application claims priority under 35 U.S.C. § 119(e) to U.S. Provisional Patent Application Ser. No. 61/023,073, “Eye Mounted Displays,” filed Jan. 23, 2008 by Michael F. Deering and Alan Huang. The subject matter of all of the foregoing is incorporated herein by reference in its entirety.

### BACKGROUND OF THE INVENTION

1. Field of the Invention

This invention relates generally to visual display technology. More particularly, it relates to display technology for eye mounted displays.

2. Description of Related Art

More and more our technological society relies on visual display technology for work, home internet and email use, and entertainment applications: HDTV, video games, portable electronic devices, etc. There is a need for improvements in display technologies with respect to spatial resolution, quality, field of view, portability (both size and power consumption), cost, etc.

However, the current crop of display technologies makes a number of tradeoffs between these goals in order to satisfy a particular market segment. For example, direct view color CRTs do not allow direct addressing of individual pixels. Instead, a Gaussian spread out over several phosphor dots (pixels) both vertically and horizontally (depending on spot size) results. Direct view LCD panels have generally replaced CRTs in most computer display and large segments of the TV display markets, but at the trade-offs of higher cost, temporal lag in sequences of images, lower color quality, lower contrast, and limitations on viewing angles. Display devices with resolutions higher than the 1920×1024 HDTV standards are now available, but at substantially higher cost. The same is true for displays with higher dynamic range or high frame rates. Projection display devices can now produce large, bright images, but at substantial costs in lamps and power consumption. Displays for cell phones, PDAs, handheld games, small still and video cameras, etc., must currently seriously compromise resolution and field of view. Within the specialized market where head mounted display are used, there are still serious limitations in resolution, field of view, undo warping distortion of images, weight, portability, and cost.

The existing technologies for providing direct view visual displays include CRTs, LCDs, OLEDs, LEDs, plasma, SEDs, liquid paper, etc. The existing technologies for providing front or rear projection visual displays include CRTs, LCDs, DLP™, LCOS, linear MEMs devices, scanning laser, etc. All these approaches have much higher costs when higher light output is desired, as is necessary when larger display surfaces are desired, when wider useable viewing angles are desired, for stereo display support, etc.

Another general problem with current direct view display technology is that they are all inherently limited in the perceivable resolution and field of view that they can provide when embedded in small portable electronics products. Only in laptop computers (which are quite bulky compared to cell phones, PDAs, hand held game systems, or small still and/or video cameras) can one obtain higher resolution and field of view in exchange for size, weight, cost, battery weight and life time between charges. Larger, higher resolution direct view displays are bulky enough that they must remain in the same physical location day to day (e.g., large plasma or LCD display devices).

One problem with current rear projection display technologies is that they tend to come in very heavy bulky cases to hold folding mirrors. And to compromise on power requirement and lamp cost most use display screen technology that preferentially passes most of the light over a narrow range of viewing angles.

One problem with current front projection display technology is that they take time to set up, usually need a large external screen, and while some are small enough to be considered portable, the weight savings comes at the price of color quality, resolution, and maximum brightness. Many also have substantial noise generated by their cooling fans.

Current head mounted display technology have limitations with respect to resolution, field of view, image linearity, weight, portability, and cost. They either must make use of display devices designed for other larger markets (e.g., LCD devices for video projection), and put up with their limitations; or custom display technologies must be developed for what is still a very small market. While there have been many innovative optical designs for head mounted displays, controlling the light from the native display to the device's exit pupil can be result in bulky, heavy optical designs, and rarely can see-through capabilities (for augmented reality applications, etc.) be achieved. While head mounted displays require lower display brightness than direct view or projection technologies, they still require relatively high display brightness because head mounted displays must support a large exit pupil to cover rotations of the eye, and larger stand-off requirements, for example to allow the wearing of prescription glasses under the head mounted display.

Thus, there is a need for new display technologies to overcome the resolution, field of view, power requirements, bulk and weight, lack of stereo support, frame rate limitations, image linearity, and/or cost drawbacks of present display technologies.

### SUMMARY OF THE INVENTION

The present invention overcomes various limitations of the prior art by mounting the display device on and/or inside the eye. The eye mounted display contains multiple sub-displays, each of which projects light to different targeted portions of the retinal surface, in the aggregate forming a virtual display image. These sub-displays utilize optical properties of the eye to avoid or reduce interference between different sub-displays and, in many cases, also to avoid or reduce interference with the natural vision through the eye.

It is known that retinal receptive fields do not have anything close to constant area or density across the retina. The receptive fields are much more densely packed towards the fovea, and become progressively less densely packed as you travel away from the fovea. In another aspect of the invention, the sub-displays generate the “pixel” resolution required by their corresponding targeted retinal regions. Thus, the entire display, made up of all the sub-displays, is a variable resolution display that generates only the resolution that each region of the eye can actually see, vastly reducing the total number of individual “display pixels” required compared to displays of equal resolution and field of view that are not eye mounted. For displays that are not eye mounted, in order to match the eye's resolution, each pixel on the display must have a resolution sufficient to match the highest foveal resolution since the viewer may, at some point, view that display pixel using his fovea. In contrast, pixels in an eye mounted display that are viewed by lower resolution off-foveal regions of the retina will always be viewed by those lower resolution regions and, therefore, can have larger pixels while still matching the eye's resolution. As a result, a 400,000 pixel eye mounted display using variable resolution can cover the same field of view as a fixed external display containing tens of millions of discrete pixels.

Nature produces images on the human eye through interaction of visible light wavefronts from the sun with physical objects. Man made displays produce images on the human eye either through the direct generation of visible light wavefronts (Plasma, CRT, LED, SED, etc.), front or rear projection onto screens (DMD™, LCOS, LCD, CRT, laser, etc.), or reflection of light (LCD, liquid paper, etc.). However, these displays all have defects as previously noted. Mounting the display on the head of the viewer (Head Mounted Displays: HMDs) reduces the required brightness, but introduces limits on linearity of optics, resolution, field of view, abilities for “see-through”, weight, cost, etc.

Many of these defects can be cured by mounting a display to and/or within the eye itself. For example, FIG. 57, reference 5700, shows a representation of 52 “femto projector” sub-displays placed on the surface of the cornea. Because each display resolution is matched to the corresponding receptor field resolution, a much lower number of pixels (˜400,000) is sufficient to match the field of view of an equivalent resolution external display (tens of millions of pixels). However, a direct physical implementation of the geometry of FIG. 57 is impractical. The viewer cannot blink, or rotate his eyes much.

FIGS. 62 and 63 show one solution to this drawback. The projectors of FIG. 57 have had their optical paths folded such that they lie in a volume thin enough to be contained within a conventional sclera contact lens. The result is a new type of visual display—an Eye Mounted Display (EMD). Together with external free space pixel data transmitters, eye trackers, power supplies, audio support, etc. which can be mounted in a headpiece (which can take the form of a pair of glasses), and additional electronics to couple with image generators and head tracker sub-systems, the result is an Eye Mounted Display System (EMDS), as will be described in more detail below.

In one embodiment, the eye mounted display is based on a sclera contact lens that is mountable on the eye. The center of the sclera contact lens is occupied by a display capsule that has an anterior shell, a posterior shell and an interior. The display capsule is mounted in the sclera contact lens so that the anterior shell of the display capsule is flush to an anterior surface of the sclera contact lens. The sub-displays are femto projectors located in the interior of the display capsule. The femto projectors project light through underfilled corneal apertures that are substantially non-overlapping. The apertures are underfilled in the sense that the projected light does not fill the entire pupil. This allows all of the femto projectors to project their light through the common pupil. After the posterior shell of the display there is a slight air-gap before a prescription hard contact lens (optional) is present.

In addition to the eye mounted display, an exemplary eye mounted display system also includes an eye tracker and a scaler. The eye tracker tracks the orientation (and possibly also slight positional shifts) of the eye. The digital pixel processing scaler is coupled to the eye mounted display and to the eye tracker. It receives video input and converts it, based in part on the orientation of the eye received from the eye tracker, to a format suitable for projection by the eye mounted display.

In one implementation, the user wears a headpiece. On the headpiece are mounted part of a head tracker, part of an eye tracker and a data link component. The other part of the head tracker is positioned in an external physical frame of reference, and the two parts of the head tracker cooperate to track the position and orientation of the user's head. The eye mounted display contains the other part of the eye tracker, e.g., fiducial or other marks tracked by a camera mounted on the headpiece. The combination of the head and eye tracking data can be used to form an absolute transform from the external physical reference and the position of points of interest on the eye: the cornea, cones on the retina, etc.

The scaler performs conversion of video from standard or non-standard video sources to a retinal based raster based on the absolute transform. The data link component receives the converted video from the scaler and wirelessly transmits it to the headpiece which will pass it on to the eye mounted display. The (usually) planar video inputs may be mapped to planar virtual displays generated by the eye mounted display, or they may be mapped to a cylindrical display or to displays of more complex shape.

There are many advantages of eye mounted displays. Depending on the embodiment, some of the advantages can include variable resolution displays where the number of pixels in the display is significantly less than prior art non-eye mounted displays for the same effective resolution; very low brightness required of the display (literally as low as a few thousand photons per retinal cone, approximately one million times less photons than a 2,000 lumen video projector); extremely small size and inherent portability (e.g. worn as a contact lens, and/or implanted within the eye, etc.); extremely high resolution and wide field of view; and potentially lower cost compared to the set of multiple displays that can be replaced by one eye mounted display.

Other aspects of the invention include methods corresponding to the devices and systems described above, and applications for all of the foregoing.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 shows one embodiment of a logical partitioning of an eye mounted display system.

FIG. 2 shows one embodiment of a physical partitioning of an eye mounted display system.

FIG. 3 shows one embodiment of additional electronics in an eye mounted display system.

FIG. 4 shows example inputs and outputs for a scaler black box.

FIG. 5 shows an example portion of a head tracker system.

FIG. 6 (prior art) shows a computer workstation with a single direct view physical LCD display.

FIG. 7 shows an example of a computer work station with a single virtual display that has the same spatial position, orientation, and size as the physical display of FIG. 6.

FIG. 8 (prior art) shows an example of a computer workstation with six direct view physical LCD displays.

FIG. 9 shows an example of a computer work station with a single cylindrical virtual display that has substantially the same spatial position, orientation, and size as the array of physical displays shown in FIG. 8.

FIG. 10 shows three example virrual desk screen configurations.

FIG. 11 (prior art) shows how photons in the natural physical environment can result in visual perception: photons from the sun reflect off a point somewhere on a rock cliff and possibly into a human 110 observer's eyes.

FIG. 12 (prior art) is a small section of a projection screen where a single incoming wavefront of light may produce many more possible reflected point sources that will propagate out from the screen.

FIG. 13 (prior art) is a three dimensional human eye 1300, illustrated in two dimensions by a perspective drawing.

FIG. 14 (prior art) is a two dimensional horizontal cross section of the three dimensional human eye 1300.

FIG. 15 (prior art) is a zoom into the corneal portion of the human eye 1300.

FIG. 16 (prior art) is a zoom into the foveal region of the retinal portion of the human eye 1300.

FIG. 17 (prior art) is a two dimensional vertical cross section of the three dimensional human eye 1300.

FIG. 18 (prior art) shows the limits on the field of view of the left eye.

FIG. 19 (prior art) shows the limits on the field of view of the right eye.

FIG. 20 (prior art) shows the limits on the field of view of stereo overlap.

FIG. 21 (prior art) is an idealized drawing of a cross section of a single human biological cell.

FIG. 22 (prior art) is an idealized drawing of a cross section of a single human neuron cell.

FIG. 23 (prior art) is an idealized drawing of a cross section of a single human photoreceptor neuron cell.

FIG. 24 (prior art) is an idealized drawing of a cross section of a single human rod photoreceptor neuron cell.

FIG. 25 (prior art) is an idealized drawing of a cross section of a single human cone photoreceptor neuron cell.

FIG. 26 (prior art) are idealized drawings of human photoreceptor neuron red, green, and blue cone cells.

FIG. 27 (prior art) is an idealized drawing of a cross section of a single human peripheral cone photoreceptor neuron cell.

FIG. 28 (prior art) is an idealized drawing of a cross section of a single human foveal cone photoreceptor neuron cell.

FIG. 29 (prior art) shows an abstract model of a retinal receptive field.

FIG. 30 (prior art) shows a “center on” retinal receptive field.

FIG. 31 (prior art) shows a “center off” retinal receptive field.

FIG. 32 (prior art) shows how cone retinal receptive field duals are formed from cone cells at 0° (reference 3210), 0.9° (reference 3220), and 10° (reference 3230) of retinal eccentricity.

FIG. 33 (prior art) shows several one dimensional test inputs to the retina, as well as some example retinal circuitry outputs.

FIG. 34 (prior art) shows a series of several drifts followed by micro saccades.

FIG. 35 shows a point source emitting spherical wavefronts of visible frequency electromagnetic radiation, and what happens to the portions of the wavefronts that encounters the human eye.

FIG. 36 shows more detail on wavefront changes inside the eye of FIG. 35.

FIG. 37 is a modification of FIG. 35, in which wavefront portions are drawn as dotted, dashed, or solid, depending on how their future encounter with the human eye will go.

FIG. 38 is a modification of FIG. 35, in which only the portions of the wavefronts that will make it to the retina (the solid portions of FIG. 37) are shown, along with a thicker line outline showing the envelope of this truncated set of wavefronts.

FIG. 39 is a modification of FIG. 38, in which the portions of circular arcs representing the wavefronts at different locations are no longer drawn, leaving only the envelope to show the limits of all the wavefronts (of FIG. 38).

FIG. 40 is a modification of FIG. 39, in which the point source of light is not in focus on the surface of the retina, producing a larger (blurrier) retinal illumination area.

FIG. 41 is a modification of FIG. 39, in which a second point source of light and the envelope that is the portion of its emitted wavefront that is destined to make it to the retina are shown together with the first point source and its associated envelope (the one from FIG. 39).

FIG. 42 is a perspective drawing of the situation of FIG. 39; as seen from the point of view of the point source.

FIG. 43 shows the same situation as FIG. 42, except from a point of view rotated half way from the location of the point source and head-on to the face.

FIG. 44 shows the same situation as FIG. 42, except from a point of view now looking head-on to the face.

FIG. 45 is a nine cone retina, to be used as a simplified example.

FIG. 46 shows the optical aperture at the surface of the cornea for each of the nine cones.

FIG. 47 shows how a single display can address three of the nine cones at the same time.

FIG. 48 shows how three displays can address all nine cones at the same time.

FIG. 49 shows how to generate the desired point source relative angles, and then use a converging lens to convert them to natural expanding spherical wavefronts for reception by the eye/contact lens.

FIG. 50 shows a mirror angled at 45 degrees to fold the display of FIG. 49 flat, so as to better fit within the narrow confines of many types of EMDs, e.g. contact lens based EMDs, intraocular lens based EMDs, etc.; and also shows a simple converging lens.

FIG. 51 shows a single front surface curved mirror that can provide both the function of the 45′-angled mirror and the converging lens of FIG. 50, also eliminating chromatic aberration and fitting into a shorter space.

FIG. 52 shows an overhead view of the optical components of FIG. 50.

FIG. 53 shows an overhead view of a variation of the optical pipeline of the last two figures, but folding the projection path with a front surface mirror.

FIG. 54 shows how four femto-displays can form a four times larger area synthetic apature.

FIG. 55 shows how an overhead mirror can make a long femto projector more compactly fit into the area between two parabolic surfaces (such as within a contact lens).

FIG. 56 shows an overhead view of an array of femto displays, tiling the retina to be able to produce a complete eye field of view display.

FIG. 57 shows the unfolded lengths of the projection paths.

FIG. 58 shows a human eye optically modeled in the commercial optical package ZMAX.

FIG. 59 shows spot diagrams of the divergence of the optical beams from different portions of the femto-display surface as produced by ZMAX

FIG. 60 shows a 3D perspective of an assembled contact lens display.

FIG. 61 shows an exploded view of a contact lens display.

FIG. 62 shows one layer of optical routing.

FIG. 63 shows a second layer of optical routing.

FIG. 65 shows a horizontal slice view of six time steps of an eye blinking over a sclera contact lens based EMD.

FIG. 66 shows a horizontal slice view of a contact lens based eye mounted display located on top of the cornea.

FIG. 67 shows a horizontal slice view of an eye mounted display located within the cornea.

FIG. 68 shows a horizontal slice view of an eye mounted display located on the posterior of the cornea.

FIG. 69 shows a horizontal slice view of an intraocular lens based eye mounted display implanted within the eye between the cornea and the lens.

FIG. 70 shows a horizontal slice view of an eye mounted display attached to the front of the lens.

FIG. 71 shows a horizontal slice view of an eye mounted display attached within the lens.

FIG. 72 shows a horizontal slice view of an eye mounted display attached to the posterior of the lens.

FIG. 73 shows a horizontal slice view of an eye mounted display placed within the posterior chamber between the lens and the retina.

FIG. 74 shows a horizontal slice view of an eye mounted display attached to the retinal surface.

FIG. 75 shows an example headpiece.

FIG. 76 shows an example of headpiece electronics at a logical level.

FIG. 77 shows an example headpiece from the back side.

FIG. 78 shows an overhead view of an example of electronics contained in a contact lens display capsule.

FIG. 79 shows a block diagram of an example IC internal to the contact lens display capsule.

FIG. 80 shows an example driver chip for a UV-LED bar.

FIG. 81 shows a horizontal cross section of the light creation portion of a femto projector, in this case the phosphor is illuminated from behind.

FIG. 82 shows a three dimensional perspective view of the light creation portion of a femto projector, in this case the phosphor is illuminated from behind.

FIG. 83 shows a horizontal cross section of the light creation portion of a femto projector, in this case the phosphor is illuminated from the front.

FIG. 84 shows a three dimensional perspective view of the light creation portion of a femto projector, in this case the phosphor is illuminated from the front.

FIG. 85 shows an overhead view of a contact lens display with larger than minimal required exit appatures for the femto-displays.

### DETAILED DESCRIPTION OF THE PREFERRED EMBODIMENTS

### Outline

### I. Overview

### II. Some Definitions and Descriptions

II.A. Types of Eye Mounted Displays

II.B. Further Descriptions of Eye Mounted Displays

II.C. Components of an Eye Mounted Display System

### III. Underlying Concepts

III.A. Formation of Wavefronts of Light

III.B. Anatomy of the Human Eye

III.C. Retinal Receptive Fields

III.D. Formation of Images on the Photosensitive Retinal Surface from Collections of Incoming Expanding Spherical Wavefronts of Light

IV. Eye mounted Displays and Eye mounted Display Systems

IV.A. Optical Basis for Eye mounted Displays

IV.B A New Approach for Display Technologies

IV.C Sub-Displays

IV.D Embodiments of Contact Lens Mounted Displays

IV.E Internal Electronics of Eye Mounted Display Systems

IV.F Systems Aspects for Image Generators and Eye Mounted Displays

IV.G Meta-Window Systems for Eye Mounted Displays

IV.H Advantages of Eye Mounted Display Systems

### I. Overview

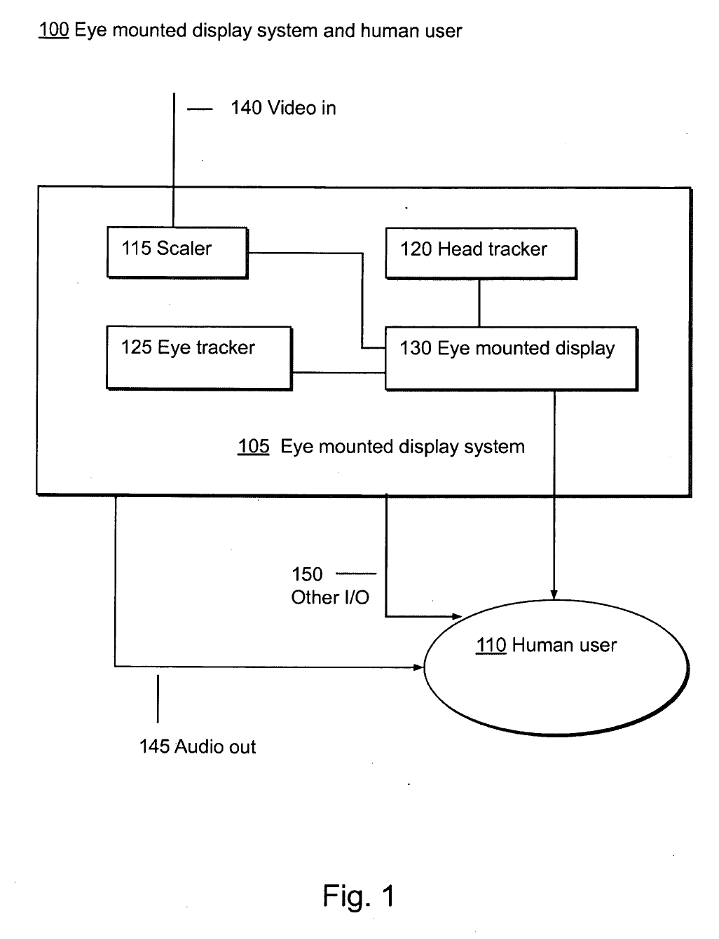

FIG. 1 shows an example logical partitioning of an eye mounted display system (EMDS) 105 according to the invention. In this partitioning, there are four elements: the scaler 115, the head tracker 120, the eye tracker 125, and the left and right eye mounted displays (EMDs 130). For simplicity, only one EMD 130 is shown in FIG. 1. Two EMDs are generally preferred but not required. The human user 110, the logical video inputs 140, the logical audio outputs 145, and the other I/O 150 are not part of the partitioning.

The EMD system 105 operates as follows. It receives logical video inputs 140 as its input, which is to be displayed to the human user 110 via the EMDs 130. In one approach, the EMDs 130 use “femto projectors” (not shown) to project the video on the human retina, thus creating a virtual display image. The scaler 115 receives the video inputs 140 and produces the appropriate data and commands to drive the EMDs 130. The head tracker 120 and eye tracker 125 provide information about head movement/position and eye movement/position, so that the information provided to the EMDs 130 can be compensated for these factors. Audio outputs 145 (optional) can also be provided from the logical video inputs 140. Additional I/O (optional) can also be provided from the logical I/O 150.

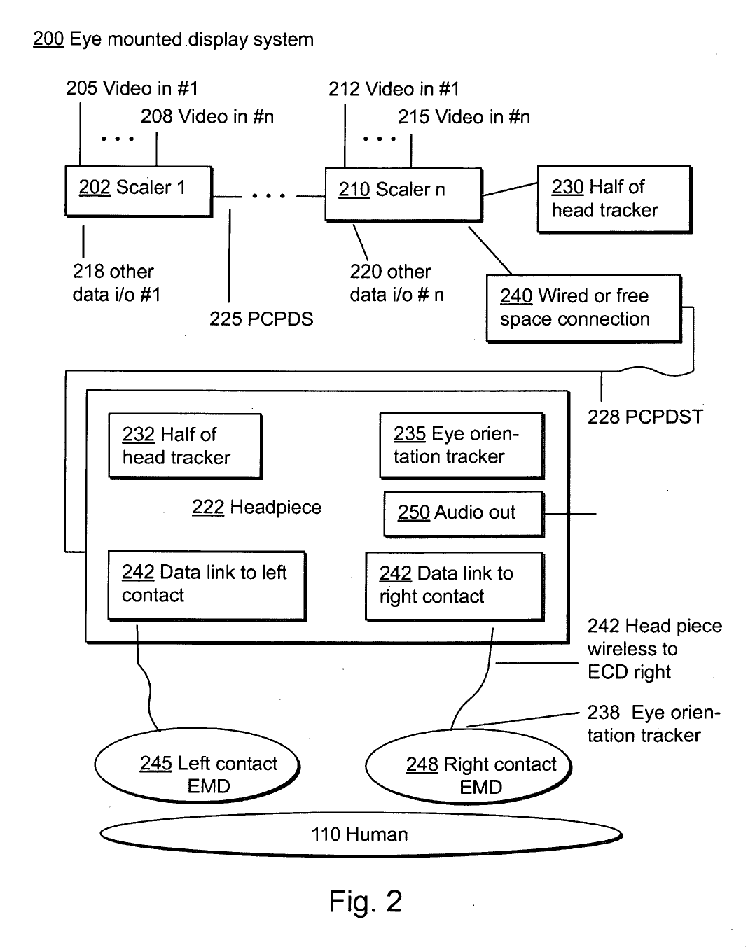

There are many ways in which sub-systems can be configured with an eye mounted display(s) to create embodiments of eye mounted display systems. Which is optimal depends on the application for the EMDS 105, changes in technology, etc. This disclosure will describe several embodiments, specifically including the one shown in FIG. 2. In this example, portions of the EMDS 105 are worn by a human 110. The overall EMDS 200 includes the following subsystems: a daisy-chainable video input re-sampler subsystem (scalers) 202 through 210, which accept the video inputs 205 through 208, and 212 through 215, respectively, and additional I/O (optional) can also be provided from the logical I/O 218 through 220; a head tracker subsystem comprised of two parts, 230 and 232; an eye tracker subsystem also comprised of two parts, 235 and 238, and a subsystem to transmit in free-space the display information from the headpiece to the two EMDs 245 and 248 (left and right eyes).

Portions of these subsystems may be external to the human 110, while other portions may be worn by the human 110. In this example, the human 110 wears a headpiece 222. Much of the data transferred between the sequential scalers 202 through 210 and the headpiece 222, and the headpiece to the EMDs 245 and 248 is the pseudo cone pixel data stream (PCPDS) 225, to be described in more detail later. The transfer of PCPDS from the last scaler 210 to the headpiece 222 can be wired or wireless. If wireless (e.g., the user is un-tethered), then an optional element, the PSPDST pseudo cone pixel data stream transceiver 228 is present.

The head tracker element 120 is partition into two physical components 230 and 232, one of which 232 is mounted on the headpiece 222. The other head tracker component 230 can be located elsewhere, typically in a known reference frame so that head movement/position is tracked relative to the reference frame. This component will be referred to as the tracker frame. The eye tracker element 125 is partitioned into two physical components 235 and 238. In this example, one of the components 238 (not shown) is mounted on the contacts 245 and/or 248, and the other component 235 is mounted on the headpiece 222 to be able to track movement of the eye mounted component 238. In this way, eye movement/position can be tracked relative to the head. The EMDs 130 and 135 are implemented as contact lens displays 245 and 248, one worn on each eye. The audio output an audio output 145 is implemented as an audio element 250 (e.g., headphone or earbud) that is an optional part of the headpiece 222.

In some cases (to be described later) the head tracker subsystem may not be required. Each of these subsystems will be described in greater detail in the following sections.

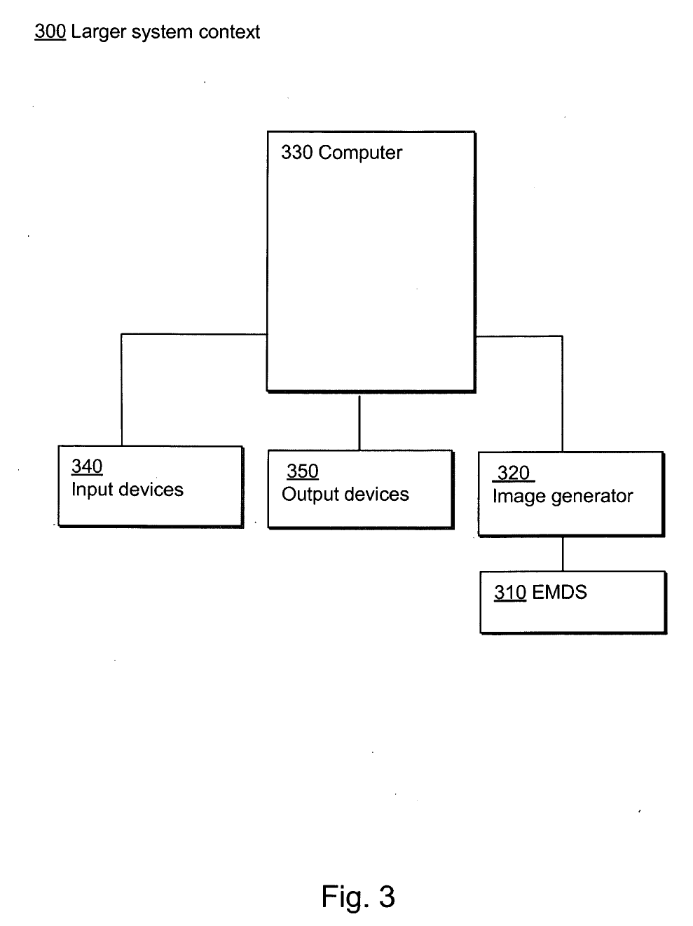

An EMDS can be the display portion of a larger electronics system. FIG. 3 reference 300 shows the EMDS 310 and other portions of this larger electronic system that are present. The image generator 320 produces the logical video inputs 140. This video input could be a still or motion video camera, or television receiver or PVR or video disc player (HDTV or otherwise), or a general purpose computer, or a computer game system. This last device, a computer game system could be a general purpose computer running a video game or 3D simulator, or a video game console, of a handheld video game player, or a cell phone that is running a video game, etc. The phrase image generator will be used as a higher level of abstraction phrase for all such devices. Note that traditional definitions of image generator do not always include simple video receiver or playback devices. Here, the phrase image generator explicitly does include such devices.

Also included in the generic larger electronic system are human input devices 340 and non-video output devices 350: audio, vibration, tactile, motion, temperature, olfactory, etc. An important subclass of input devices 340 are three dimensional input devices. These can range from a simple 3D (6 degree of freedom) mouse, to a data glove, to a full body suit. In many cases, much of the support hardware for such devices is similar to and potentially shared with the head tracker sub-system 120, thus lowering the cost of supporting these additional human input devices.

The phrase scaler, when used in the context of conventional video processing, usually means a processing unit that can convert a video input in the format of a rectangular raster of a given height and width number of pixels, with each pixel of a fixed sized, to a video output of a different format of a rectangular raster of a given height and width number of pixels, with each pixel of a fixed sized. A common example is the up-conversion of an input NTSC interlaced video stream of 720 by 480 (non-square) pixels to an output HDTV 1080i interlaced video stream of 1920 by 1080 pixels. However in this disclosure, the term scaler, unless stated otherwise, will refer to a much more complicated processing unit that converts incoming video formats, typically of fixed size pixel rasters, to a format suitable for use with the EMDs 130. One example format is a re-sampled and re-filtered non-uniform density video format which will be referred to as the pseudo cone pixel video format, and the sequence of pseudo pixel data will be referred to as the pseudo cone pixel data stream. This video format will be described in more detail in a later section. Scalers usually require working storage for the frames of video in. This will be defined as the attached memory sub-system. The scalers in FIG. 2 implicitly include such memory at this high block level.

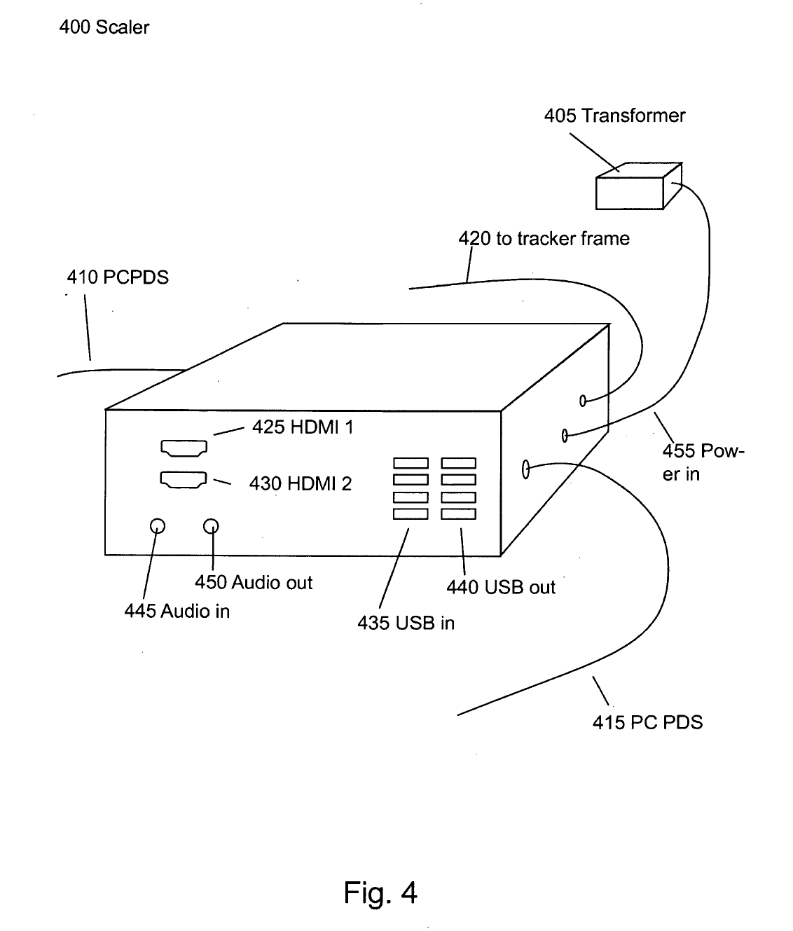

FIG. 4, reference 400, shows a particular example scaler “black box” with a specific set of inputs and outputs. The power in is through an AC to DC transformer 405 and DC cable 455, or internal re-chargeable batteries (not shown) when the scaler is being used in a portable application, or power over one or more of the USB connections 435. The logical video inputs 205 through 208 are realized through two physical HDMI inputs 425 and 430. CAT6 physical cables are used to pass the Pseudo Cone Pixel Data Stream (PCPDS) from one scaler to another: one side to/from 410, on the other side from/to 415. Note that while the PCPDS flows only in one direction, the signals carried on the CAT6 cables are bi-directional. Other classes of data flow in the opposite or both directions.

In this example configuration, each scaler box has an input 420 for the head tracker sub-system, even though typically only one head tracker per system will be employed. This avoids having to have a separate headtracker only black-box. Also, while most configurations will have only a single physical head tracker reference frame, for coverage over a larger virtual space multiple head tracker units can be used in a cellular fashion.

The box supports four USB inputs 435 and four USB outputs 440. These can be used for supporting keyboard and mice. The system is capable of performing KM (keyboard mouse) switching mapping the same keyboard and mouse inputs to any one of a number of computers connected in the video chain. As many modern displays support USB hubs, if the EMDS system is to replace them, it should support the same hub functionality.

Finally, the scaler supports digital optical fiber TOSLINK audio in 445 and out 450. This way, the audio from each of several computers attached can either have just their audio output switch in or all or some subset mixed together (remember that audio is also carried by the HDMI links). If a wireless transport of the PCPDS is supported, this functionality could be provided via a separate industry standard box, attached to the output CAT6 410 of the last scaler in the line. The scaler may be using only the lower layers of the Ethernet data transmission protocol for the transport of the PCPDS and other data, but it preferably follows the specifications far enough to allow use of common Ethernet switchers and free space transceivers. The scaler black box shown in FIG. 4 is merely an example, representing specific I/O choices for sake of providing a concrete example.

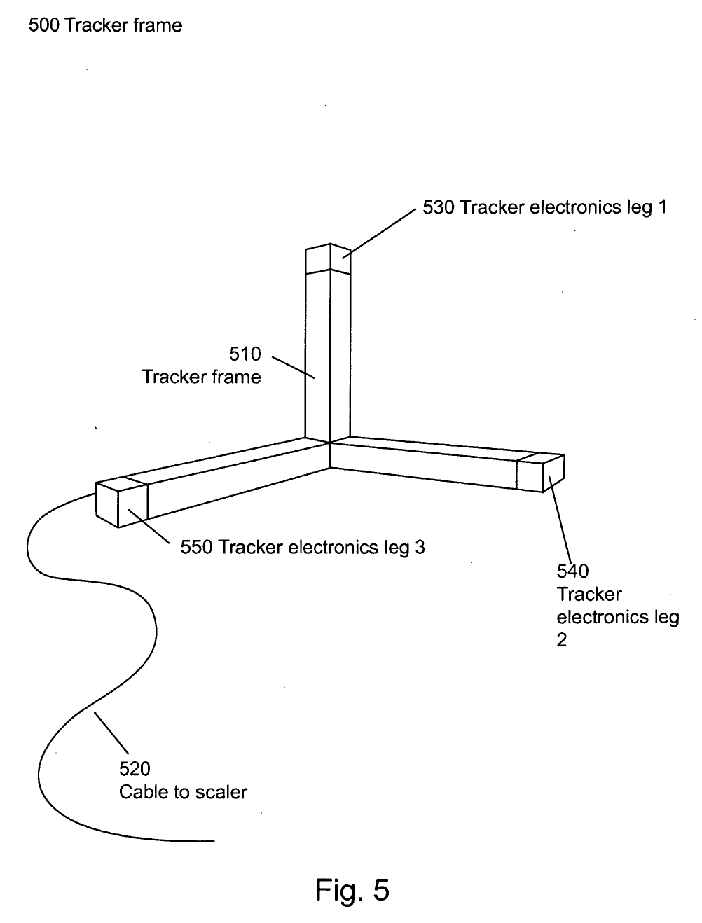

One example of the head tracker component 230, the tracker frame, is shown in detail in FIG. 5, reference 500. Reference 510 is the physical tracker body, which may be in the form of a x-y-z set of sticks, but not always. At each of the three ends of this tracker frame, there are active electronics 530, 540, and 550. The active electronics might only include the simplest of timing and sensor I/O capabilities. The computation to turn the sensed signals into transform matrices typically would not be included in the tracker frame. Instead, the nearly raw sensor inputs would be passed down the data link, via cable 520 in this example. The number crunching on the data will be performed elsewhere in the EMDS. For example, this computation could take place within one or more of the embedded DSP elements on the headpiece electronics chip.

To put all this and what follows in context, two examples of pre-EMDS displays and the EMDSs that replace are described below.

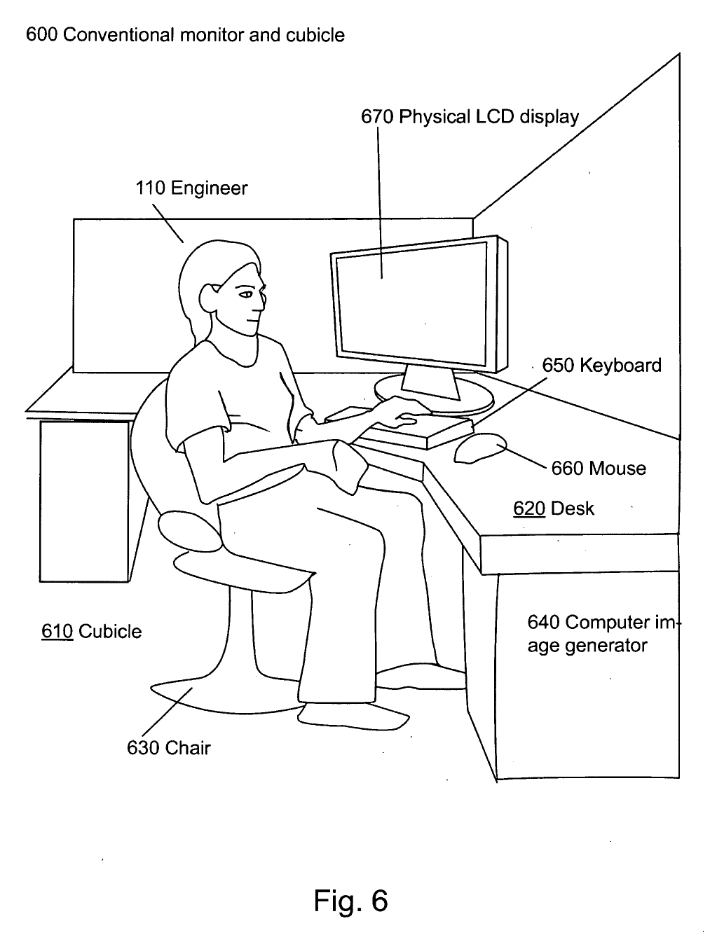

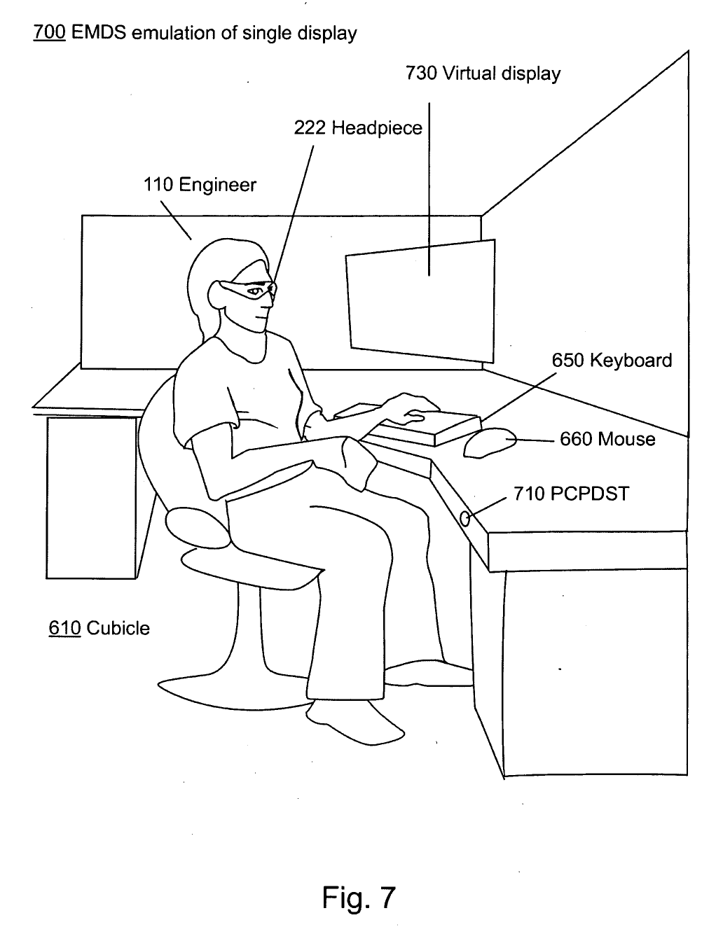

FIG. 6, reference 600, shows a typical work cubicle 610 with a desk 620, chair 630, computer with integral image generator (e.g., a graphics card) 640, keyboard 650, mouse 660, and a traditional direct view LCD display 670. The next figure shows what an Eye Mounted Display System can do. In FIG. 7, reference 700, everything is the same as in FIG. 6 except the user is wearing an EMDS headpiece 222, a wireless video transceiver the PCPDST 710 has been added, and the physical LCD display 670 is replaced by a virtual display 730 of otherwise the same characteristics. One other change is the fabric walls of the cubicle 610 are preferably a dark black fabric and the top of the desktop is also preferably made of a black material. This will increase the contrast of the virtual images against the physical world, without the need for overly low ambient lighting or overly dark shades on the headpiece.

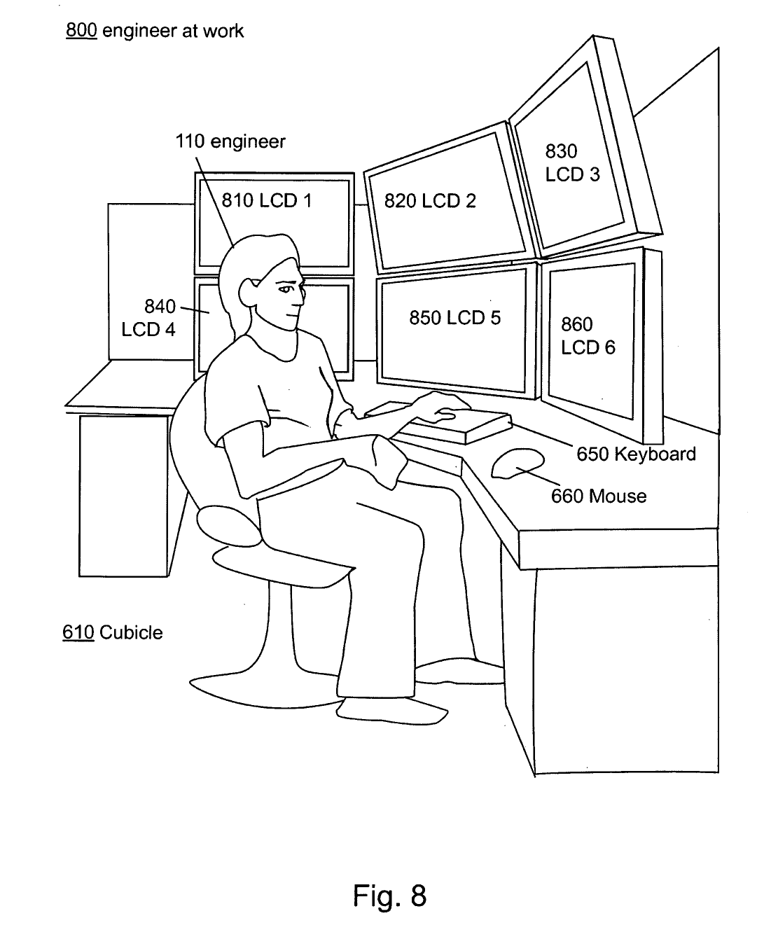

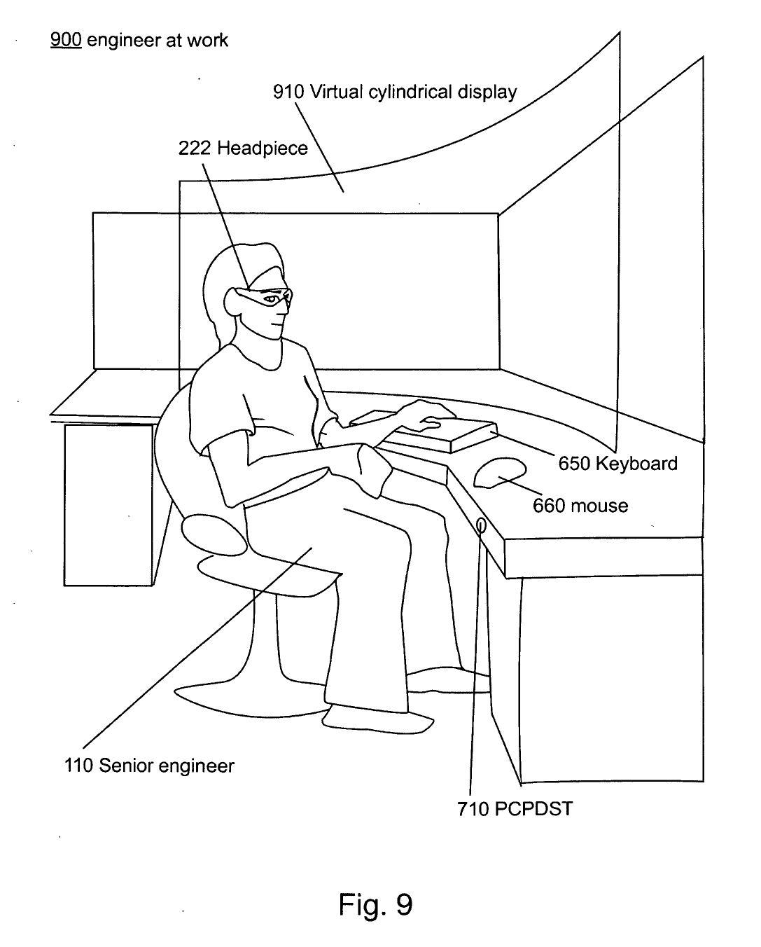

A more interesting example is when more money has been invested in LCD displays. FIG. 8, reference 800, shows a work cubicle 610 with not one, but six physical LCD displays: 810, 820, 830, 840, 850, and 860. Now the (almost) same EMDS of FIG. 7 can take in the six video outputs that in FIG. 8 were connected to the six physical LCD displays, and instead they are connected to six “scaler” virtual video inputs. FIG. 9, reference 900, shows the results: six virtual screens placed on a continuous cylindrical display 910, otherwise delivering the same visual information as the set-up in FIG. 8 does, but much more flexibly, and potentially at a lower cost. Note: rather than just projecting to a cylinder, the projected surface can be a more general elispse.

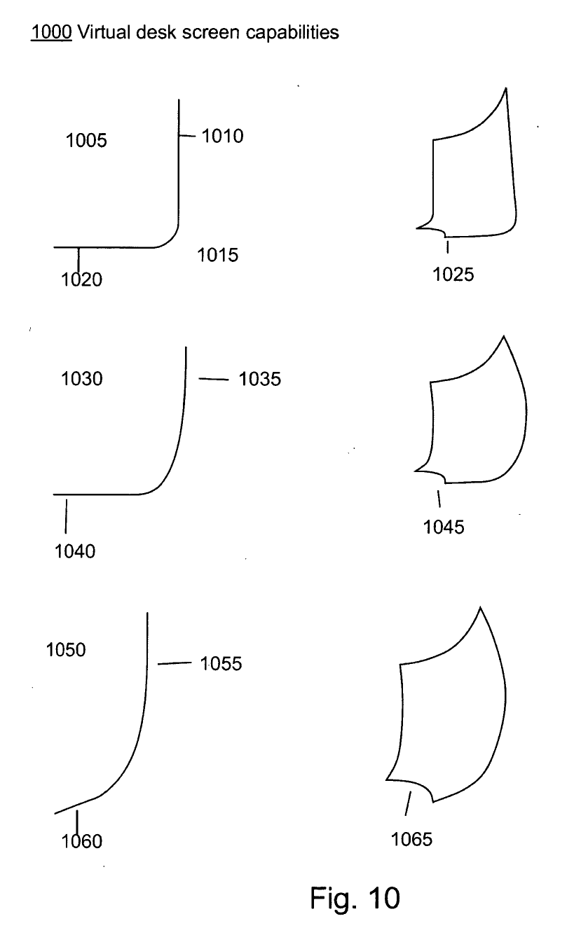

More complex virtual display surfaces are possible and comlimplated. FIG. 10 shows the such additional types. The display 1005 has a flat desk surface 1020 as well as a flat (in the vertical) portion of the virtual display 1010, connected via a ninety degree circular section 1015 of the virtual display. Assuming circular curving, a three dimensional perspective view of this display is shown as reference 1025. The display 1030 has a flat desk surface 1040 as well as a parabolic (in the vertical) portion of the virtual display 1035, directly connected. Assuming circular curving, a three dimensional perspective view of this display is shown as reference 1045. The display 1050 is more appropriate for standing rather than seated use; it has a small tilted desk surface 1060 as well as a parabolic (in the vertical) portion of the virtual display 1055, directly connected. Assuming circular curving, a three dimensional perspective view of this display is shown as reference 1065. Three of the many ways in which such complex compound surfaces can be supported will be described. One method is for the scaler to directly support such compound surfaces. Another method is to dedicate a scaler to each one of the compound surfaces (e.g., 3 or 2 dedicated scalers). Another method is for such surfaces to be directly supported by the external image generator.

While the primary application of an EMD is to the human eye, and most of this disclosure will assume this as the target user base, an EMD can be made to work with animals.

### II. Some Definitions and Descriptions

II.A. Types of Eye Mounted Displays

An eye mounted display (EMD) is a device that is mounted on the eye (e.g., directly in contact with or embedded within the eye) and projects light along the optical path of the eye onto the retina to form the visual sensation of images and/or video. In most eye mounted displays, as the eye makes natural movements, the display's output is locked to, or approximately locked to, the (changing) orientation of the physical eye. In this way, the projected images will appear to be stationary with respect to the surrounding environment even if the user turns his head or looks in a different direction. For example, an image that appears to be four feet directly in front of the user will appear to be four feet to the user's left if the user looks to the right.

An eye mounted display system (EMDS) is a system containing at least one eye mounted display and that performs any additional sensing and/or processing to enable the eye mounted display(s) to present visual data to the eye(s) emulating aspects of the natural visual world, and/or aspects of virtual worlds. An eye mounted display system may also allow existing standard or custom video formats to be directly accepted for display. Significantly, in some implementations multiple such video inputs can be simultaneously accepted and displayed.

One example is the emulation of most present external direct view display devices (such as CRTs, LCDs, plasma panels, OLEDs, etc.) and front and rear view projection display devices (such as DLP™, LCD, LCOS, scanning laser, etc.) In this case, an EMDS 105 could take “standard” video data streams, and process them for display on a pair of eye mounted displays (one for each eye) to produce a virtual display surface that appears fixed in space. Just as with most present external display devices, an industry standard cable, carrying video frames in some industry standard video format, is physically plugged into an industry standard input socket on some portion of the EMDS 105, resulting in the user perceiving a display (controlled emission of photons) of the video frames at a particular (changeable) physical position in space.

One advantage of eye mounted display systems compared to existing devices is that there is no bulky external physical device emitting the photons. In addition, a large number of separate video inputs can be displayed at the same time on the same device. Also, EMDS 105 can be constructed with inherent variable resolution matching that of the eye, resulting in a significant reduction in the number of display elements, and also potentially external to the EMDS computation of display elements. Furthermore, in embodiments of eye mounted display systems that are implemented with high accuracy, they can produce imagery at the human eye's native resolution limits.

Not only can eye mounted display systems potentially replace existing display devices, because multiple video feeds can be accepted and displayed simultaneously (in different or overlapping regions of space), a single eye mounted display system could conceivably simultaneously replace several display devices. Furthermore, because eye mounted display systems are inherently portable; a person wearing a single eye mounted display system could use that system to replace display devices at a number of different fixed locations (home, office, train, etc.).

Eye mounted displays can be further classified as follows.

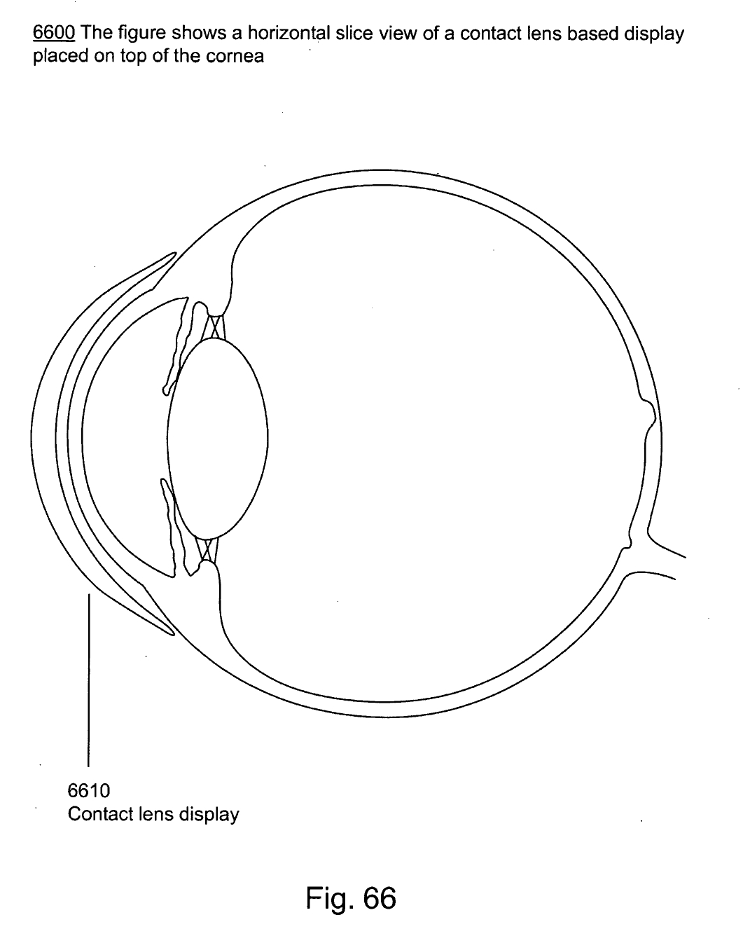

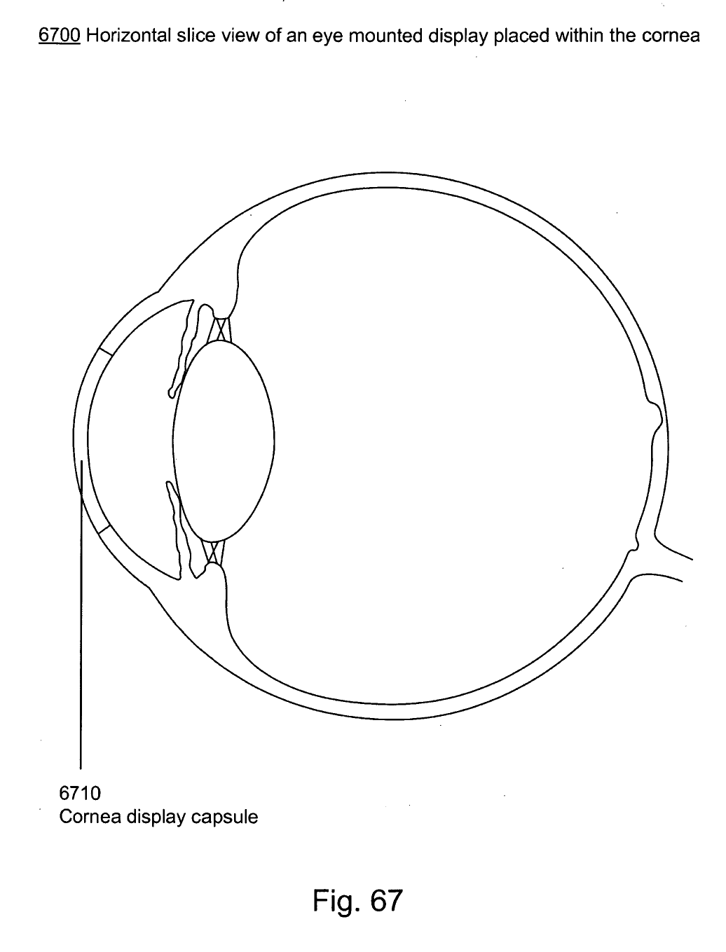

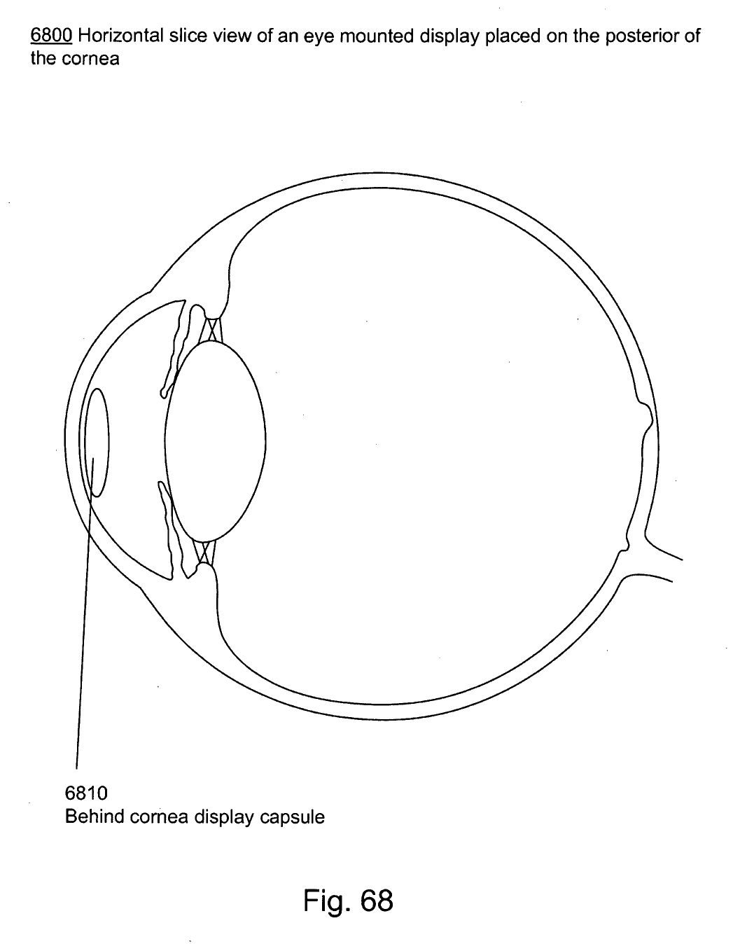

Cornea Mounted Displays (CMDs). Within this class, the display could be mounted just above the cornea, allowing an air interface between the display and the cornea. Alternately, the display could be mounted on top of the tear layer of the cornea, much as current contact lenses are. For example, see FIG. 66. In yet another approach, the display could be mounted directly on top of the cornea (but then would have to address the issue of providing the biological materials to maintain the cornea cells). In yet other approaches, the display could be mounted inside of or in place of the cornea (e.g., FIG. 67), or to or on the back of the cornea (e g., FIG. 68).

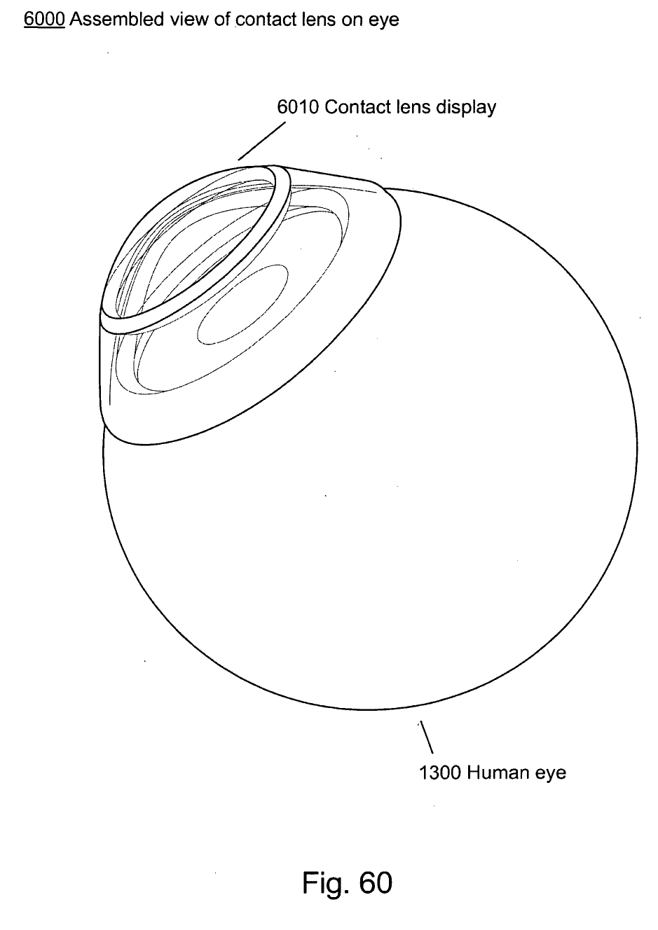

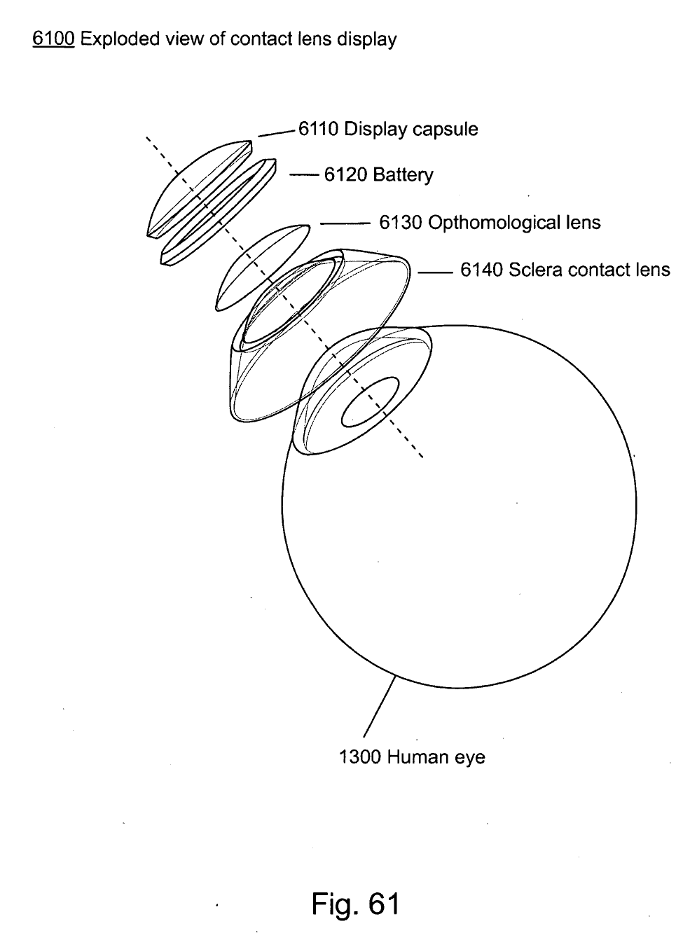

Contact Lens Mounted Displays (CLMDs). In this class of Cornea Mounted Displays, the display structure would include any of the many different current and future types of contact lenses, with appropriate modifications to include the display. Examples are shown in FIGS. 60 and 61.

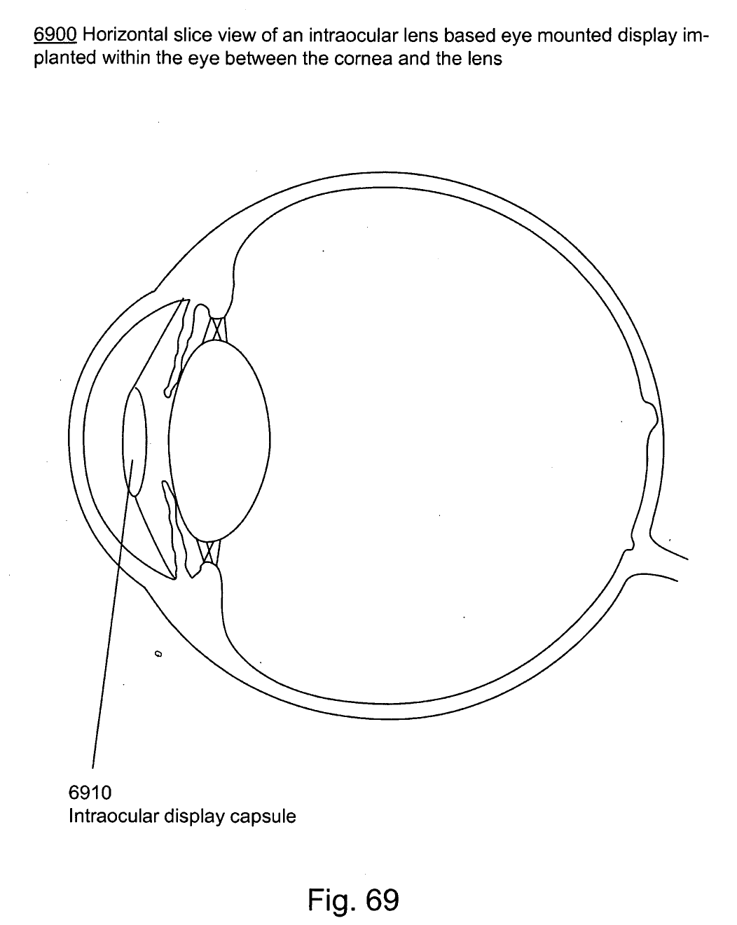

Inter-ocular Mounted Displays (IOMDs). In this class, the eye mounted display could be mounted within the aqueous humor, between the cornea and the crystalline lens, just as present “inter-ocular” lenses are (e.g., FIG. 69).

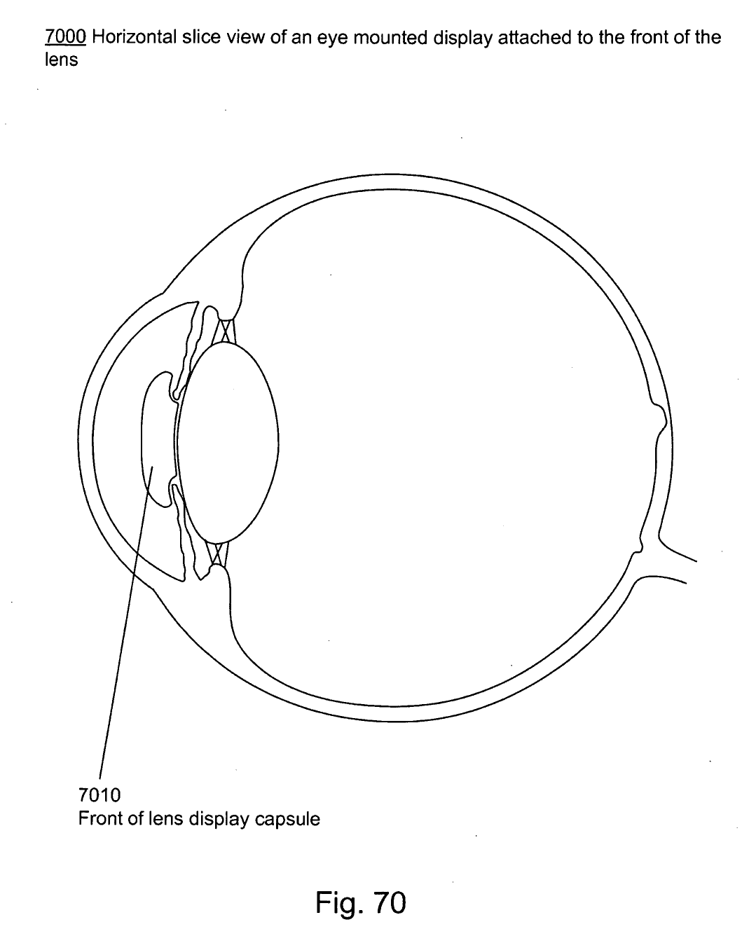

Lens Mounted Displays (LMDs). Just as an eye mounted display could be mounted in front, inside, behind, or in place of the cornea, instead these options could be applied to the lens, creating several more classes of embodiments. See FIGS. 70, 71, and 72. Replacing the lens with a LMD would likely be surgically very similar to current cataract solutions.

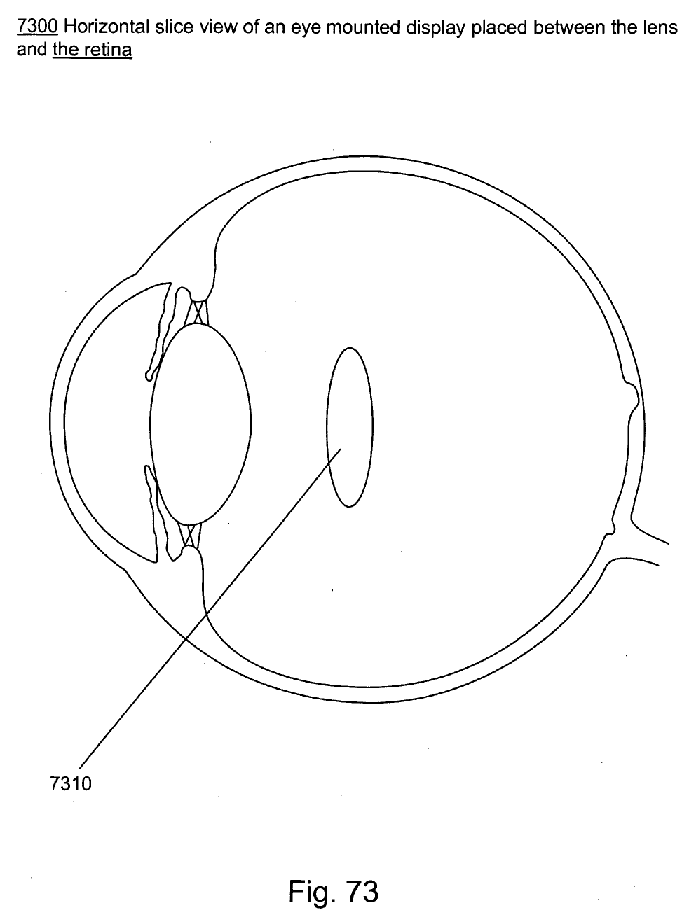

Posterior Chamber Displays. FIG. 73 shows a display which has been placed within the posterior chamber 1445, between the lens and the retina 1460.

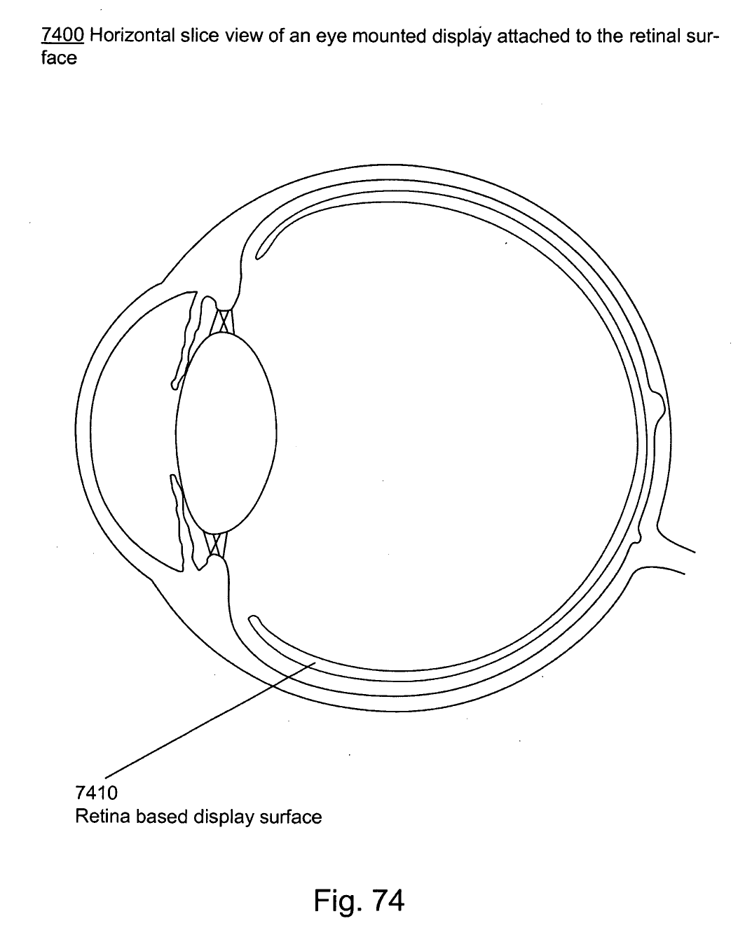

Retina Mounted Displays (RMDs). In this class, the eye mounted display could be mounted on the surface of the retina itself (e.g., FIG. 74). In this particular case, fewer optical components typically are required. The display pixels (or similar objects) could be placed right above the cones (and/or rods) to be displayed to. However, the display must be able to be fabricated as a doubly curved object (e.g. a portion of a sphere).

Relative Size of the Eye. Like other parts of the human body, the diameter of the human eye varies between individuals. Specifically for adults, the variance is a Gaussian distribution with a standard deviation of ±1 mm about 24 mm, and most other anatomical parts of the eye generally scale with the diameter. Most of the literature implicitly or explicitly assumes an eye diameter of 24 mm, though sometimes a different diameter is given. Some types of data, such as angular measurements, are implicitly relative, and thus the size of the eye does not matter. But other measurements, such as feature sizes on the retinal surface, or the size of the cornea, or the size of the pupil, do depend on the size of the eye in question. So while this document for simplicity follows the convention of a default 24 mm diameter eye, eye mounted displays could be made available in a range of sizes in order to accomplish better fit and function for the majority of the populace.

II.B. Further Descriptions of Eye Mounted Displays

EMDs in Both Eyes. In the general case, for a particular user, eye mounted displays would be mounted on or in both eyes. This eliminates (or greatly reduces) binocular rivalry, increases perceptual resolution, and allows for display of stereo images. There also is a physical redundancy factor. That does not mean that just a single eye mounted display might be used in special cases: people with only one functional eye, some patients with strabismus and in certain special applications where display in only one eye is sufficient. The discussion below is generally focused on how to couple a display to a single eye. This is just for simplicity of exposition. Nothing in that description should be construed to mean that the most typical application would not be coupling displays to both eyes.

Femto projectors. There are many different ways that the light generating component of an eye mounted display can control the emission of photon waterfronts that will focus on or about a particular photoreceptor of the eye (rods or cones). Many of these, if looked at in a certain way, roughly resemble various forms of video projectors, although at a vastly smaller scale. Also, such photon emitting sub-systems usually will not be able to address the entire retina. Many instances of them may be present in a single eye mounted display. To have a generic and consistent name for this entire class of photon emitters, the term “femto projectors” will be used. Femto, in this case, is not meant to indicate femto-technology, which is defined as having individual components in the femto-meter size range. Rather, the term femto projector is meant to differentiate such tiny projectors from small projectors currently called “pico projectors,” “nano projectors”; the large “micro projectors”; and their larger cousins—just projectors.

Pseudo Cone Pixels. An EMD contains internal light emitting regions that will be defined here as pseudo-cone pixels. Each pseudo cone pixel, when emitting light, will cause a spot of light to excite some specific (after calibration) (possibly extended) point on the user's physical retina. In general these pseudo cone pixels do not correspond exactly to the position and size of specific physical cones on the user's retina, but can be thought of as approximately doing that. Specifically, pseudo cone pixels projecting into the highest resolution central foveal portion of the retina may be somewhat larger than the actual cone cells. The lattice of the pseudo cone pixels (for example, an irregular hexagonal lattice) will not exactly match that of the physical cones, and in the periphery of the retina, pseudo cone pixels are sized to resemble the locked together sets of cones that make up the central portion of peripheral visual receptive fields.

However, for the computational task of converting “standard” video input into video data for non-uniformly spaced and sized pseudo cone pixels on an EMD, we can concentrate on the pseudo cone pixels as the target “pixels,” and ignore the actual physical retinal cones (or rods). It is likely that future versions of the technology will allow pseudo cone pixels to be manufactured or configured to more exactly match a particular individual's retinal cone and receptive field lattice. While such systems should provide some incremental additional improvement in user perceived resolution, such enhanced systems otherwise will be constructed quite similar to the systems described here.

Pseudo-Cone Pixel Shape. On the femto projectors on the EMD, one embodiment of the pseudo cone pixels could be hexagonal in shape. Hexagons are already more closely approximated as circles than as squares (in contrast to more traditional “square” pixels). However the hexagon spread function of light by the time that the pixels is imaged on the retina will be close to both the optical blur limit, as well as the diffraction limit (at least near the fovea). The end effect is that the hexagons will be distorted into very nearly circular shapes. This is important, because as various graphics and image processing functions are considered, they must usually think of pseudo cone pixels as circular, rather than square.

One must also take care with phrases like “imaged onto the surface of the retina.” In the periphery, shapes imaged onto a theoretical sphere representing the surface of the retina will be quite distorted (due to the high angle of incidence), but the cones (and rods) of the retina “fix” this problem by tilting by quite a number of degrees to point at the output pupil of the lens. Thus the “real” imaging surface of the retina is quite different than a simple spherical approximation. Within the art described here, these more accurate effects are understood, and taken into account where appropriate. Thus, phrases like “the surface of the retina” are to be understood as meaning the more complex “real” imaging surface defined by the orientations of the light sensors on the retina.

One could also take into account the effect that as pixels are presented to higher and higher eccentricities, the light enters the cornea at higher and higher angles tilted away from the local normal to the surface of the cornea (as described in greater detail elsewhere in this document). While in general this extra tilt will help to keep pseudo cone pixels imaged onto the retina close to uniformly circular in shape, pseudo cone pixels at the extreme ends of the femto projector can become slightly elliptical when imaged onto the surface of the retina. While slight distortions usually can be ignored, at some point the retinal shape of pseudo cone pixels should be modeled as elliptical (or other distorted shapes). Fortunately the elliptical ratio is constant, and can be computed beforehand, or in some cases is a simple function of lens focus (which can be indirectly determined by the relative vergence in the orientations of the two eyes). In some of the processing steps to be described in following passages, this complication will at first be ignored, and then addressed once the full concept has been developed.

Pseudo Cone Pixel Data Steam, Frame of Pseudo Cone Pixel Data. The sequence of pseudo cone pixel data that is transmitted between scaler units and between the last scaler and the headpiece is referred to as the pseudo cone pixel data stream. Pseudo cone pixel data streams are split up temporally into separate video frames of pseudo cone pixel data. All the pseudo cone pixel data contained in a single video frame of such data being sent to the headpiece for display on the EMD is referred to as one frame of pseudo cone pixel data.

Pseudo Cone Pixel Video Frame Format, Pseudo Cone Pixel Descriptors. A frame of pseudo cone pixel data has a pre-defined fixed sequence of pseudo cone pixel targets on the set of femto projectors that actually display the data. Because all the (typically, on the order of 40 to 80) femto projectors will be operating in parallel, the pseudo cone pixel video format preferably does not sequentially send the entire pseudo cone pixel data contents for one femto projector before sending any data to any other femto projectors. This constraint means that pseudo cone pixel data for different femto projectors preferably are interleaved together in the pseudo cone pixel video format. This interleaving does not have to be on an individual femto projector basis, but it can be. There is enough FIFO storage within the various processing elements that various forms of re-ordering are possible.

The scalers typically fetch from their attached storage a video frame worth sequence of pseudo cone pixel descriptors. Each descriptor contains the geometric and other data that defines them: for example, normal vector to its center, its normalized radius, its color, normalization gain and offset of the particular femto projector pixel it is targeted to, its femto projector pixel, and any femto projector edge feathering for seaming together with another neighboring femto projector. This is only one example collection of the contents of pseudo cone pixel descriptors. Other collections and ordering within the video stream are contemplated and possible.

Each scaler accepts a stream of pseudo pixel data from the scaler before it, except for the first, which will generate such a stream internally based on the pseudo cone pixel descriptors fetched from the attached storage, and send it on to the next. Depending on the physical world relative position and orientation associated with the frame of video input to a particular scaler, the scaler will contribute data only to a sub-set of all of the pseudo cone that pass through it. For this active subset, and given the internally fetched pseudo cone pixel descriptor, the scaler will generate a pseudo cone pixel value from contents from its frame of input video. This data may replace the corresponding data for the same pseudo cone pixel destination for the same femto projector pixel, or let the input override the internally generated pseudo cone pixel data, or a more complex merge of the two values. In some simple cases of the edges of the rectangle that is the output virtual video screen, the merge function may be simple addition. If multiple layers of virtual video screens are allowed to obscure portions of others, an even more complex merge function can take place when, for example, one screen partially obscures another. In a general form, merges between different pseudo cone pixels with the same target are not performed until all of such pseudo cone pixels are present. One way to accomplish this is to leave in the stream both pseudo cone pixels, plus any partial pixel coverage information. The pseudo cone pixel data stream can be inserted into more than one data frame for a single femto projector pixel pseudo cone pixel target. The number of pseudo cone pixels data frames that have to be taken up by these two will be at least two, and possibly more. In fact, as this unresolved data merge propagates though the scalers, additional active pseudo cone pixels addressing the same target may be encountered, and the result will be a further enlarging of the data frames dedicated to the same target.

It is conceivable that this enlarging of the data stream would result in possible data under-runs to the EMD. Because of the FIFOs over the EMDS 105, and because the scalers have 10% or more processing power available than otherwise needed, and because an upper limit on doubled and more pseudo cone pixels that may partially cover another can be computed, the EMDS can be designed so that the “surge” in data for one target can be absorbed without compromising the data rate to the pseudo cone pixels. The computation to be performed is to sort out all the partial pixel coverage claimed on this pixel, and then merge together, in proportion to its coverage, all such pixels that have not been totally obscured by another. This operation is the same or very similar to the operation of computing the continuation of various polygons in known sort order for antialiasing in the computer graphics literature. While many other methods are possible, one convenient one is to let the last scaler in the chain perform this merging operation. Then the output from the last scaler to the headpiece will be free of any duplicate (or more) pseudo cone pixels. In addition, note that each pseudo cone descriptor can include a gain and offset for its target femto projector pixel. The most bandwidth preserving place to apply this normalization is within the scaler as the rest of the pixel value is computed. Another place is in the last scaler in the chain. This might result in slightly improved numeric output values.

II.C. Components of an Eye Mounted Display System

Eye mounted Display System. An eye mounted display system (EMDS) 105 usually will include at least three components: the eye mounted display (EMD) itself, an eye tracking component that provides accurate real-time data on the current orientation and direction of motion of the eye, and a head tracking component that provides accurate real-time data on the current orientation and direction of motion of the head (or technically, the headpiece attached to the head) relative to some physical world reference coordinate frame 230. There are some practical applications of EMDs that do not require the head tracking component. However, there are very few applications of an EMD that will work well without the eye tracking component. The eye mounted display system may also include other components, including possibly some or all of the following:

Eye Tracker. Typically, an EMDS 105 will know to high accuracy the orientation of the eye(s) relative to the head at all times. Several types of devices can provide such tracking. For the special case of cornea mounted displays fixed in position relative to the cornea, the problem devolves to the much simpler problem of tracking the orientation (and movement direction and velocity) of the cornea display. Special fiducial marks on the surface of the cornea mounted display can make this a relatively simple problem to solve. Other types of eye mounted displays may be amenable to different solutions to the problem of tracking the orientation of the eye to sufficient accuracy.

To generate the proper image to be displayed by an eye mounted display, the image formation preferably takes into account the current position and/or orientation of the eye relative to the head and/or the outside environment. Technically, eye orientation sensors typically will tell you where the eye was, not where it is now, let alone where it will be by the time the image is displayed to it. Thus it is desirable to track the eye's orientation at a rate several times faster than the display update rate, to allow accurate computation of the recent past rotational direction and velocity of the eye. This can be used as a predictor of where the eye will have rotated to by the time the image is displayed to it.

This same high sample rate time sequence orientation information about the eye can also be used to determine which of several different types of eye motion is in progress: saccades, drifts, micro saccades, tracking motion, vergence motion (by combining the rotation information from the other eye), etc. Tremor motion during drifts is likely fine enough to not be sense-able or to make much difference in the display contents. However, if it can be sensed, it can be used in determining fine orientation of the eye, if needed. While not technically an eye motion, many eye trackers 125 can usually also correctly detect eye blinks. As during saccades, the eye is “blind” during many of these motions, and in these cases no image need be computed or displayed. After any motion that shuts down visual input to the brain ends, there is an approximately 100 millisecond additional period in which visual input is still not processed. This allows EMDS 105 that have their own latency time to determine where the eye is now (e.g., that the motion or blink has finished), start computing the correct image to be displayed, and transfer that image to the EMD and display (emit photons) before the eye starts seeing again.

The eye, as a sphere, has three independent degrees of freedom relative to its socket, requiring its orientation to be described by three independent numbers. In many cases, using an appropriate representation of orientation, the eye only uses two of these degrees of freedom, as described by “Listing's Law” but the law varies with vergence. Also, during pursuit motions, the eye ignores Listing's Law to keep the target centered in sight. Thus in general, an eye tracker 125 preferably would sense all three possible independent dimensions of orientations of the eye, not just two. However, the orientational deviations from Listing's Law are known to be within a specific small range, and an eye tracker system can take advantage of these limits.

The eye motion information is also needed to correctly simulate retinal motion blur, if such blur would have occurred when viewing a physical object under similar circumstances. This computation is effected by the duty cycle of “lag” time of the physical display elements, as well as the current eye motion over the native display “frame” time and head/body motion over the same period. More details on the required computation will be described later.

Most eye mounted display applications will require the displayed image to appear stabilized with respect to the physical space around the user. In such cases, in addition to the rotational position and velocity of the eye relative to the head, the position and orientation of the user's head (and thus body) relative to the physical space around the user should be known, along with computed temporal derivatives of these values to allow prediction. Some types of eye trackers 125 can give both eye and head tracking 120 information, but usually it is simpler and more accurate to separate the two functions: an eye orientation tracker, and a head position and orientation tracker, as described in the next section.

When trying to determine the orientation of the eye within the angle formed by one foveal cone or less, an accuracy of plus or minus one arc minute or less is preferred in each dimension. Eye mounted displays potentially allow new inexpensive accurate techniques to be employed to achieve this accuracy.

Head Tracker. Head trackers 120 usually accurately sense six independent spatial degrees of freedom of the human head relative to the physical space around the user. One common partitioning of these degrees of freedom is three independent dimensions of position and three independent dimensions of orientation. To keep the terminology simple, the discussion that follows will use this common convention, with the understanding that there are many other ways to represent spatial information about the human head, some of which may have advantages over others depending on the specific embodiment of the head tracker 120.

Just as with eye trackers 125, most sensed information about the head usually tells one about the past, and so the same sort of super display frame rate sampling can be employed to compute temporal derivatives of the head tracker 120 data (or other data computed from it), which in turn can be used to predict where the future orientation and position of the head will be, good for the time frame in which the next image frame will be displayed.

By calibrating the positional and orientation offset from the native coordinates of the device attached to the head relative to the center of the two (or one) eye(s) of the user, the combined head tracker 120 and eye tracker 125 information describes in physical space the narrow view frustum for each cone (or rod) of the retina, within a certain degree of error. The frustum can be more simply represented by a vector in the viewing direction of the cone (rod), and a subtended half angle of a conical viewing frustum, describing the cone's (rod's) field of view. This information can be used to form the image presented by the eye mounted display(s).

Most existing head tracking technologies do not directly sense orientations, but use three (or more) separate positional measurements to three (or more) separate points on the headpiece, and then triangulate (or higher order fit) that data to produce the desired orientational information. Even the positional measurements are usually not made directly. Usually the same target on the headpiece is sensed from three (or more) different physical positioned sensors, and this data is triangulated (or higher order fit) to produce the desired positional information. What is actually sensed varies by device. Some sense the distance between two sub-devices, some sense the orientation between two sub-devices, etc. Some devices attempt to sense head orientation directly, but such devices suffer from rapid calibration drift (on the order of tenths of seconds), and typically are re-calibrated by a more traditional six degree of freedom head tracker 120.

Because of the way the final information is put together (a common example is multiple stacked triangulations, not always with very long base lines), the final accuracy of the head position and orientation data will usually be less than the native accuracy of the various sensors used to generate the raw data. How much accuracy is lost (and therefore how much accuracy is left) can be estimated by performing a numerical analysis of the initial raw accuracy as it propagates through to the final results. This can also be checked by measuring the actual information produced by the head tracker 120 in operation against known physical locations and orientations. It is useful to distinguish between relative and absolute (and repeatable) accuracy. Some head trackers 120 may give highly accurate position and orientation data relative to the data it gives for nearby positions and orientations, but the absolute accuracy could be off by a much larger amount.

For eye mounted display applications, the orientational accuracy of a head tracker 120 preferably should be close to the orientational accuracy of the eye tracker 125: approximately one arc minute or less. The positional accuracy of the head tracker preferably will be good enough to not induce shifts in the display image of any more than the angular accuracy. Given that a single foveal cone is on the order of two microns across, for a (virtual) object six feet away, a positional error of not much more than 100 microns is needed to keep the error comparable to a one minute of arc orientational error.

Headpiece. Technically, most head trackers 120 do not track the position of the head, but rather the position of some device firmly fixed to the user's head. So long as this device keeps to the same position and orientation with respect to the head to within specified limits, knowing the position and orientation of the device attached to the head gives accurate position and orientation information about the head itself. While there are several different possible ways to have devices physically attached to the head, for the purposes of exposition and simplicity, the EMDS 105 described in this document will usually assume an embodiment of a single physical device worn on the head of the user, called the headpiece, upon which many different things may be mounted. The headpiece in most cases does not include the two (one) eye mounted display device(s) mounted to the eye(s), or implanted elsewhere within the eye's optical path. Again, this is only one example used for simplicity of exposition. The same results can be achieved by multiple devices not all attached to each other, or in some cases, just marks painted on the user's head, or nothing at all.

The headpiece could take on many forms. It could look like a traditional pair of eye glasses (but without any “glass” in the frames), or something more minimal, or more complex, or just more stylish.

The devices likely to be attached to the headpiece include the following: elements of the head tracking system (active or passive), elements of the eye tracking system, the device that transmits the image data wired or through free space to the EMD proper, the device that receives wired or through free space back channel information from the EMD proper, possibly devices that transmit power wired or through free space to the EMD proper, corded or cordless devices to transmit the image data from other portions of the EMDS 105 to the device that forwards the data to the EMD proper. Devices that could be placed elsewhere, but in many cases might be attached to the headpiece include the following: the computational device that processes raw eye tracking, the computational device that processes raw head tracking data, the computational device that processes eye and head track data into combined positional estimates, orientational estimates, and estimates of their first temporal derivatives. Depending on the larger system design, the image data may have one or more of the following operations performed on it: decryption, decompression, compression, and encryption. Also, as most new digital video standards also carry high quality digital audio data on the same signal, the headpiece could have provisions to output analog or digital forms of this data through an audio output jack. Alternately, the headpiece could have some form of audio output (earbuds, headphones, etc) directly built into it.

Transmission of Signals between Components. An eye mounted display system will include a number of sub-systems, which will communicate with each other. Depending on how the sub-systems are partitioned and constructed, different methods of communicating data between them are appropriate. In many cases free space communication is not necessary, and physical interconnects (electrical, optical, etc.) are sufficient. In general, wherever possible, industry standard physical layers that meet the bandwidth and latency requirements between two sub-systems should be used, and the use of corresponding industry standard protocol layers again where possible. One good example is the use of the 10 mega-bit, or higher, Ethernet standard. In other cases, sub-systems may be located so physically close that direct wiring between them is possible (e.g., on the same PC board).

Finally, when linking one or more components of the EMDS 105 that are not located on the user, e.g., not being worn, to some part that is being worn, it is desirable that a short free space connection be utilized, so that the user does not have to be “tethered.” Current spread-spectrum short distance wireless interconnects utilizing standard Ethernet protocols are one example of existing hardware that meets the un-tethered requirements. In other applications, such as game systems, tethering may be less of a nuisance, worth the cost reduction, and/or tethering of other devices was already required.

Video Input Raster. The physical electrical (or optical or other) transport level of the video to the EMDS 105 may be any of many different standard or proprietary video formats. The most common consumer digital video formats today are from the related family of DVI-I, DVI-D, HDMI, and soon UDI and the new VESA standard. HDMI and UDI also contain digital audio data, which an EMDS with headphones, earbuds, or other audio output may wish to use. There are also a number of industrial digital video formats, including DI and SDI. The older analog video formats include: RGB, YUV, VGA, S-video, NTSC, RS-170, etc. Devices are commonly available to convert the older analog formats into the newer digital ones. So while a particular EMDS product may have additional circuitry for performing some or all of these conversions for the user, for the purposes of this discussion we will concentrate on what happens after the video raster has been converted to, and presented to the EMDS, as an un-encrypted digital pixel stream. Specifically conventional issues such as de-interlacing, 2-3 pull-down reversal, and some forms of video re-sizing and video scaling will also be assumed to have been performed prior to presentation to the EMDS, or in additional EMDS pre-processing circuitry that will not be discussed further here.

Different video formats employ different color spaces and representations. A given EMDS 105 component may also employ its own specific, and thus not necessarily standard, color space and format. So in addition to any “standard” color space conversions that may have been applied in earlier stages (including brightness, contrast, color temperature, etc.), an EMDS will usually have to perform an additional color space transform to its native space. In many cases this transform can simply be folded into a combination transform that already had to exist for conversion of video input from various standard color spaces. Specifically, because of the nature of the computations that will be performed on the input video data, in the preferred environment the internal color space for most of the processing will be a linear color space. Any non-linearities in the actual pixel display elements are converted after most of the rest of the processing has been performed. Now, on the one hand, converting to a linear color space requires more bits of representation of pixel color components than non-linear color spaces. On the other hand, once inside the EMDS, we know the maximum number of linear bits that each pixel of the EMD is capable of displaying, and what, if any, dithering is going on. Thus the internal linear color space representation of pixel color components can be safely truncated at some known maximum.

Eye Tracking, Dual Eye Support. In addition to the head tracking component, an EMDS 105 typically also includes an eye tracking component. Note than in some cases, such as a cornea mounted display (CMD), the “eye” tracker 125 may not need to track the eye directly, but can instead track something directly physically attached to the eye (e.g., the CMD device). Also, while we will focus on the processing needed to provide data to one eye's EMD, an EMDS will usually support parallel computation of slightly different data for the EMD in each of the two eyes supported. Such stereo display support is important even when viewing mono video sources. Among many other advantages, this will keep eye fatigue and possible nausea to a minimum. While it is the goal of one embodiment that a single scaler component (described below) will be able to process and generate output for both eyes in the most complex input case, so long as provisions are made to deliver input video data to two scaler components in parallel, each handling a single eye each, a doubling of the maximum processing obtainable by a single scaler component is easily achieved (at the price of approximately doubling the cost of the scaler element).

Scaler Element, Scaler Component, Scaler Black-Box. In the logical partitioning of an eye mounted display into four elements, presented in FIG. 1, one of the logical elements was named the scaler 115. Computations related to the conversion of normal raster video data to the special display needs of an EMD are performed by this unit. Physically, the scaler element might be physically implemented as a single integrated circuit chip, perhaps with some DRAM attached, but the scaler element might be implemented as several chips, as eluded to in FIG. 2, in the multiple references 202 through 210, or as portion of a larger chip, as will be discussed later. So without narrowing the scope of this disclosure, in many examples a scaler component will be one-to-one with a physical integrated circuit chip, plus some attached DRAM. Because scaler components can be daisy-chained together, in some examples a collection of scaler components may be referred to as a “scaler black box,” where the logical element scaler may consist of more than one such black box.

Scaler Component Technical Details. Generally the input to an EMDS 105 is some form of rectangular, scan line by scan line sequence of pixel data, as defined above as the Video Input Raster. However, the type and format of data that the EMD proper consumes can be quite a bit different. In some embodiments, the EMD consumes a sequence of pseudo cone pixel data, usually interleaved so that multiple femto projectors can be displaying their native format of photon data. While nearly all existing Video Input Rasters (not compressed video data) are uniform in pixel density (though not always color density), pseudo cone pixels most certainly are not. Converting from the standard input formats to the desired output format is the job of one or more scaler components. These components dynamically re-sample and filter the original video data into re-scaled pixels that match the requirement for each output pseudo pixel. Indeed, in some embodiments, a portion of the scaler element internal data buffers is set aside as storage for a target descriptor for each pseudo cone pixel to be generated per frame.

How individual components and collections of components are assembled to form a scaler element can be similar to what occurs many times on the other side of the video interface: video cards. Many modern PC video cards have the option of driving two displays at the same time through two separate connectors on the same single card. However, there may be a maximum number of pixels for dual displays that is less per display than what the card can do when driving only a single display. To get higher performance, a user may prefer that a single graphics card drive only a single display, or as in several PC gaming cards now, two or even four graphics cards can drive just a single display, with not quite linear increases in delivered graphics performance. The situations for components and collections of components in the scaler element can have similar dependencies.

Let us define the smallest unit capable of performing the computation of a scaler element within a defined set of constraints a scaler component. In many, but not all cases, this may take the form of a single ASIC with other support chips attached, such as DRAM. The scaler element of an EMDS 105 is defined as the entire collection of one or more scaler components that perform all the scaler computations for the EMDS. How many scaler components will be needed to perform the scaler function for an EMDS will depend on the number of video inputs, the size in pixels and pixel data rate of each video stream, the form of scaler desired (e.g. projection onto a flat virtual screen vs. projection onto a cylindrical virtual screen), type of stereo processing desired, details of the EMDs being used, among other factors. In certain special cases no stand-alone scaler element is required at all, either because the function has been embedded into another device (such as a cell phone), or the interfacing device is capable of generating correct pseudo cone pixel data streams, such as a “pseudo cone pixel aware 3D graphics rendering engine.”

From a user point of view, there will be one or more types of physical scaler black boxes available, each with one or more video inputs in one or more video formats. Multiple such units can be daisy-chained together, before connecting to the free-space or physical cable connection to the headpiece. These “black boxes” will be differentiated in the number and type of video inputs on the box, and the limits on the scaler computations that they can perform, as well as the physical power that they require. Even for a given unit, the amount of physical power that they consume may be variable, depending on the amount of work they are required to perform. Thus a box that needs to be plugged into a wall when working with a complex deskside computer system may only need a battery or power from a USB port when being used with a mobile laptop computer. To support such functionality, the ASIC (if that is the technology deployed) can have built in the capability to turn off sections of the internal processors when they are not needed, as well as slow down the clock to the powered computations. In this way, two expensive ASICS do not have to be constructed. One chip can perform in each special environment.

Scaler Component Architecture. There are many possible internal architectures for the scaler component. One approach is to use a custom microcodable VLIW SIMD fixed point vector processor. Power can be saved by powering off individual ones of the MD units, and/or lowering the clock frequency to the processor. The microcode is not fixed, but is downloaded at system initialization time. In this way additional features can be added, or support of newer model EMDs is possible.

Stereo Support. While the output display is stereo, for the maximum comfort of the viewer, in most of the cases described here the input video is mono, and the physical display device being emulated is flat. However, with little additional hardware, the systems described here can also support field sequential stereo or separate left and right eye video streams.

Rod Vision. While much of the discussion that follows will be cast in terms of controlling light to individual cones of the retina (or in the periphery, specific neighboring groups of cones), the same technology will also deliver photons to the more numerous rods of the eye. The techniques described below in terms of cones equally apply to rods, only so long as lower overall light intensities are involved. A specific example might be an eye mounted display that is meant to be used with the user's night vision. Here the display intensity would be kept low enough to only engage the scotopic rod vision, and would produce a black and white display. This in fact could just be a “night vision” intensity setting of an eye mounted display that can also produce brighter images for photopic “daylight” display. Even though there are several times more rods than cones (80 to 100 million rods vs. approximately 5 million cones), the rods tend to group together as larger effective pixel units, and the spatial frequency resolution of scotopic vision is considerably less that photopic vision. Thus, any eye mounted display that produces anywhere near close to enough spatial resolution for photopic (cone) vision, can also produce more than enough spatial resolution for scotopic (rod) vision.

Safety. EMDs can be see-through, partially see-through, or opaque. For safety reasons, in general and consumer applications, it is preferable that the eye mounted displays be see-through, so that normal vision is not seriously affected by the eye mounted display. If a truly immersive application is desired, one can put on black out shades. The overall range of brightness of display of the eye mounted display can also be an issue. With a see-through design, the eye mounted display has to compete in brightness (photon count) with the ordinary external world. In a dimly lit office or home environment, this is not a hard goal. In direct sunlight, eye mounted display intensities of 10,000 times greater would be needed. This is by no means technically impossible, but a competing safety goal of making it impossible for the eye mounted display to ever cause permanent retinal damage may require an artificially limited maximum brightness of an eye mounted display. Such a display can still be used quite easily in sunlight, for example by wearing fairly dark sunglasses, or, more generally, programmable density filters to the external world, similar to current variable sunglasses or welding mask window technology. This cuts the brightness of the sunlit scene considerably, while not affecting the eye mounted display intensity, because the eye mounted display is “behind” the sunglasses.

See-Through Constraints. Some EMD designs inherently allow for see-through of normal (standard contact lens corrected, if necessary) vision of the real-world. When the EMDS 105 is off (or showing just black), the EMD will function purely as a slightly darkening contact lens. Other EMD designs only work as non-see-through. In this instance, the effect is similar to wearing a non-see-through HMD. As the (variable density) see-through design is the more general, and can always emulate non-see through designs by the simple expedient of having the EMDS wearer don a pair of total blackout glasses or goggles, most of the discussion here will be of the see-through design.

Just because a design is see-through does not automatically mean that it is simple to simultaneously operate in the existing physical world (say a business office) as well as seeing one or more virtual displays generated by an EMDS 105. As discussed elsewhere, a given EMD design may not be bright enough to compete directly with the brightness of even a normal office environment. One possible compromise is to darken the variable density shade in the headpiece to view mostly the virtual displays, and then un-darken them when needing to interact with the more brightly lit physical world. The switching from one to the other can be controlled by the head and eye tracker 125, if necessary, as they know when one is looking at the virtual screens versus the physical world. Thus the switching is seamless. An additional enhancement to allow for virtual displays to be only as bright as the (partially shaded) physical world is to have a region of very dark material (such as black felt) attached to locations in the physical world corresponding to where the virtual displays are placed. Thus when looking at the virtual displays there is no competing light from the physical world, and when looking at the physical world there is no competing light from the virtual world.

### III. Underlying Concepts

III.A. Formation of Wavefronts of Light

The following discussions use the wavefront interpretation of light. Specifically, most natural objects (and most traditional displays), from a light propagation point of view, consist of physical surfaces where at large numbers of different positions on the physical surface point sources of light exist generating spherical wavefronts of light. The optical frequencies (i.e., wavelengths) of this reflected light correspond to the optical frequency of illumination light hitting the physical surface in a region containing the point source. This description is a simplified model sufficient to illustrate the points to be made. More detailed models can include additional effects such as subsurface scattering, polarization, frequency shifting, etc.

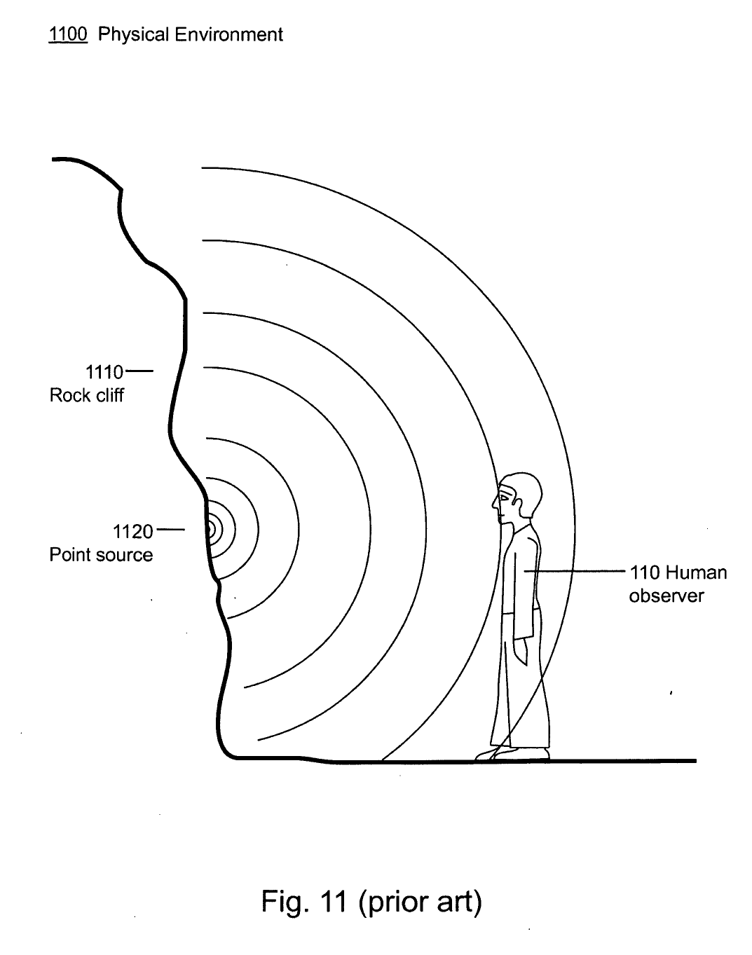

FIG. 11 shows an example two-dimensional cross section of a surface, such as the face of a rock cliff wall 1110, with only one point source of reflected/scattered light 1120 and its expanding wavefronts drawn, along with a human observer 110. In the natural and built environment, most such point sources are not self-emissive, but reflections of a small portion of a larger illumination source, such as the sun, moon, fires, artificial lighting, etc. There are only a few other natural self-emissive light sources, such as bioluminescence. The expanding wavefronts of light, such as from point source 1120, are what the human eye is designed to convert into images on the surface of the retina, as will be described later. But first, a description of how existing display technologies form similar sets of wavefronts of light will be considered.

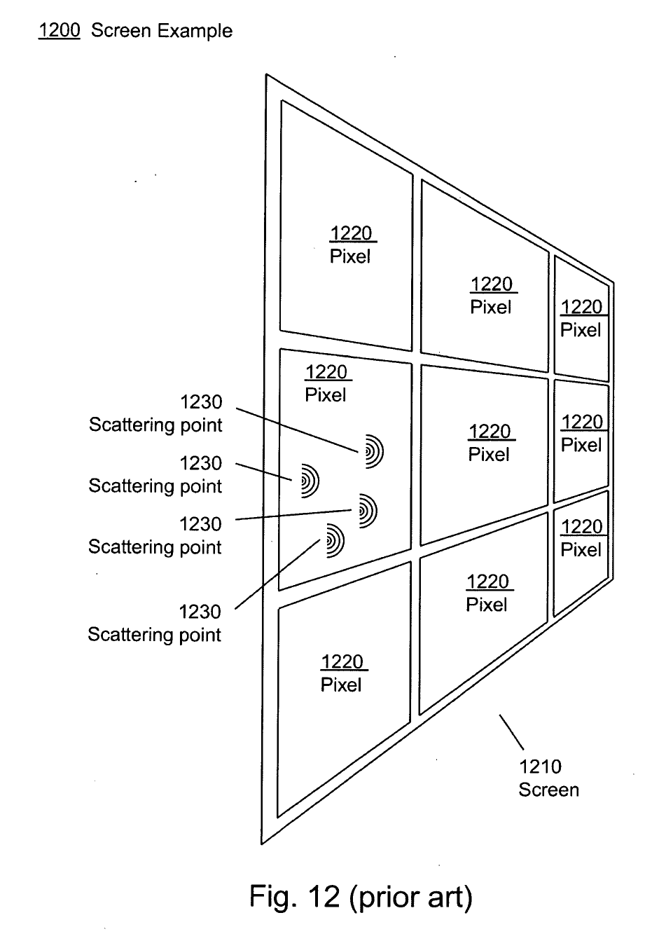

In contrast to the natural environment, most direct view display technologies are self-emissive, including direct view CRTs, most LCDs, plasma, LEDs, OLEDs, etc. The few exceptions include reflective displays that emit no light themselves, but selectively reflect external illumination sources. Projection displays are a specialized type of illumination sources, where at an external in-focus image plane (i.e., the screen), different small areas of the screen (individual pixels 1220, or similar objects) are each illuminated by an independently controllable intensity (gross number of photons per time period) and one or more of specific spectral profiles (colors). This is achieved by the projector emitting collapsing spherical wavefronts in a different propagation direction per “pixel” (or similar object). The optics are set up such that at a specific distance from the projector, all of these contracting wavefronts have contracted to very close to their minimum size, preferably each non-overlapping each other, except for multiple spectral contributions (for example, red, green, and blue pixel components all on collapsing to the same small area) forming a two dimensional array of these concentrated wavefronts. Almost all the probability of each original truncated spherical wavefront emitted from the projector has been concentrated into these individual small areas, concentrating the probability of the wavefront eventually collapsing into a photon to each individual small area. Only some wavefronts collapse into photons at the screen; these are absorbed by atoms in the screen, and are generally converted to heat. But in most cases the contracting wavefront is reflected or scattered (sometimes several times) by atoms in the screen, thus changing the incoming collapsing wavefront into multiple new point sources of expanding spherical waves from different points 1230 within the macroscopically small area, as shown in FIG. 12. This collection of expanding wavefronts from the screen surface approximate the collection of expanding wavefronts produced in natural conditions, and as will be described in a later sections, allow the natural function of the human eye to perceive these artificially generated collections of expanding wavefronts as images.

III.B. Anatomy of the Human Eye

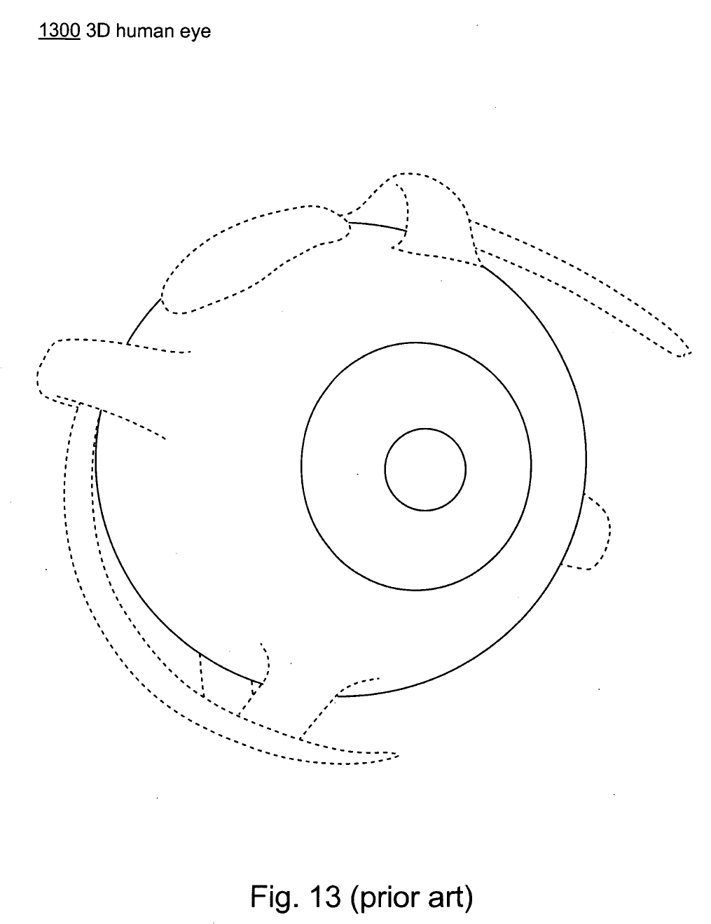

The human eye is a complex three dimensional object. Any two dimensional drawing of it necessarily is a compromise that simplifies the true nature of the eye. Thus FIG. 13 is included. The image is a perspective rendering of the exterior of the human eye, but the reference 1300 refers to the true three dimensional eye. In this way, when various simplifications of the eye are drawn, reference 1300 can be referred to in describing what simplification was performed. For additional information, see for example, The Human Eye, Structure and Function, Clyde W. Oyster, Sinauer Associates, Inc. 1999; The First Steps in Seeing, R. W. Rodieck, Sinauer Associates, Inc. 1998; Optics of the Human Eye, David A. Atchison and George Smith, Butterworth-Heinemann 2000; and Seeing, Karen K. De Valois, Ed., Academic Press 2000.

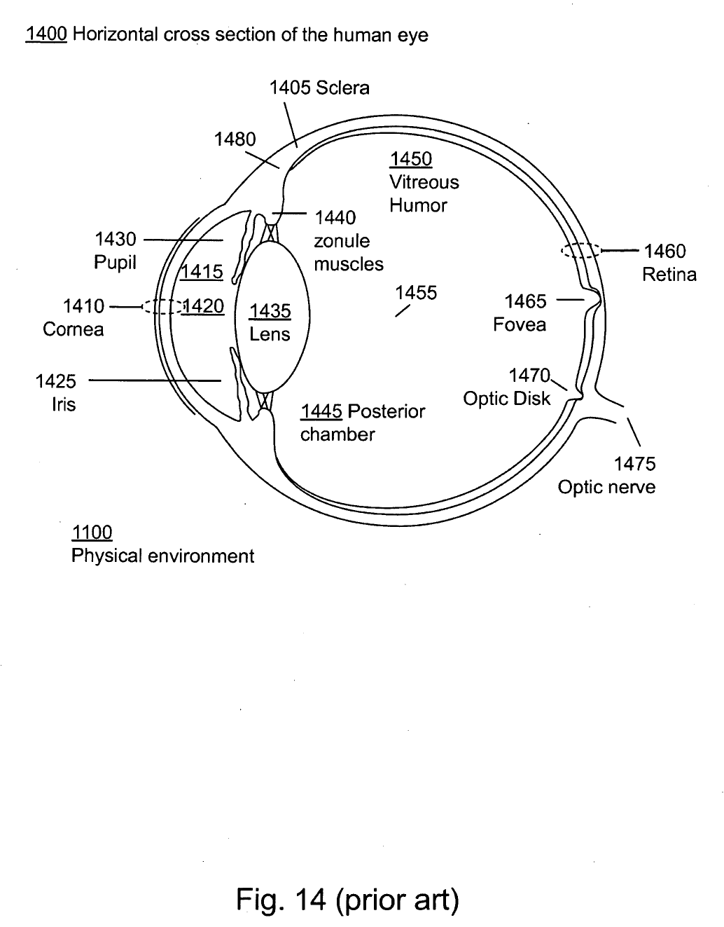

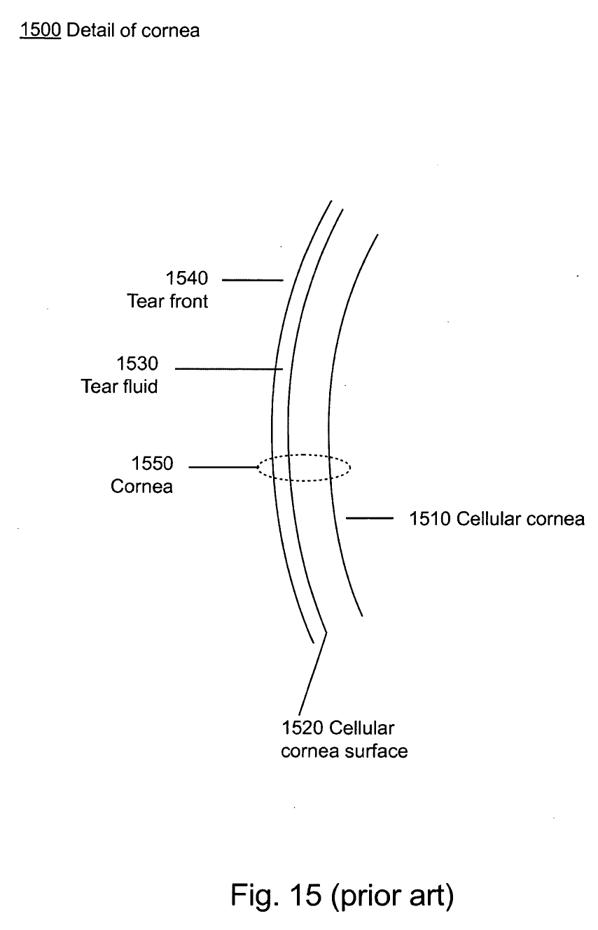

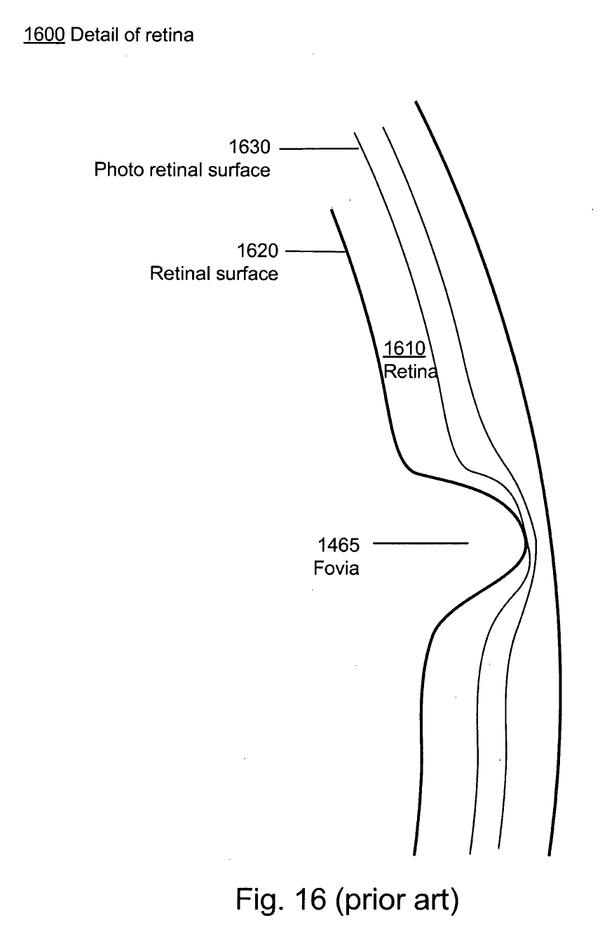

FIG. 14 shows a two dimensional horizontal cross section 1400 through the three dimensional human eye 1300, and FIGS. 15 and 16 show zooms into portions of cross section 1400. Cross section 1400 shows many of the anatomical and optical features of the human eye 1300 that are relevant to displays. Note that because the centers of the fovea and the optic nerve 1475 do not lie on exactly the same horizontal plane (more on this in a later section), the two dimensional horizontal cross section 1400 is a simplification of the real anatomy. However, this simplification is standard practice in most of the literature and so the slight inaccuracy usually does not have to be explicitly called out. It is mentioned here because of the tight correspondence between an eye mounted display and the real human eye.

To simplify this description, optical indices of refraction of various gases, liquids, and solids will be stated for a single frequency (generally near the green visible optical frequency) rather than more correctly a specific function of optical frequency. When relevant, the more complex model will be used in later sections.

The outer shell of the eye 1300 is an opaque white surface called the sclera 1405; only at a small portion in the front of the eye is the sclera 1405 replaced by the clear cellular cornea 1510.

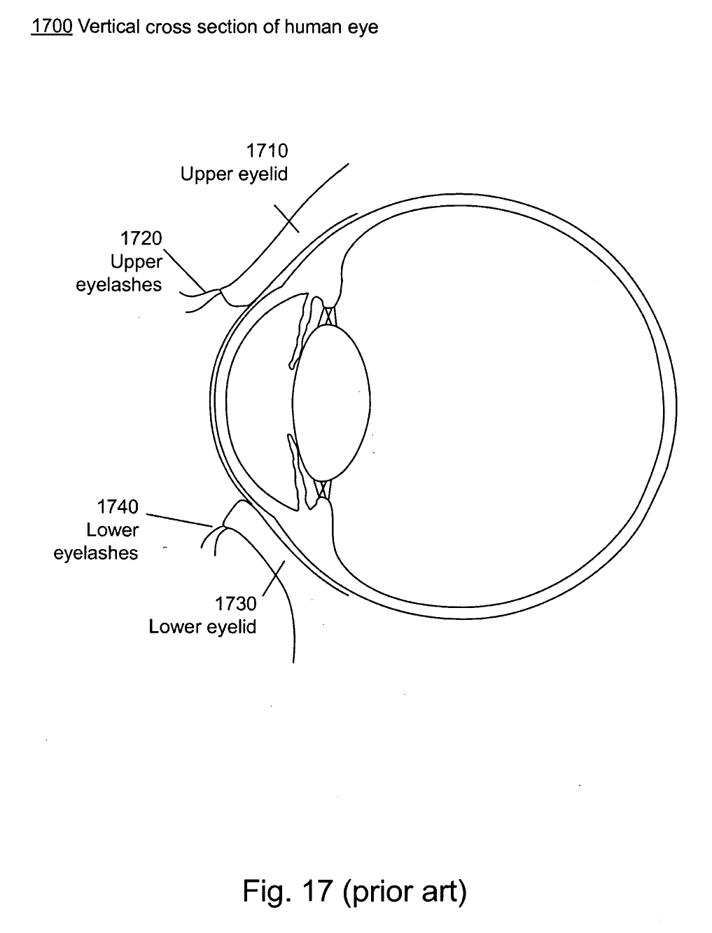

FIG. 17 shows a two dimensional vertical cross section through the three dimensional human eye 1300. The upper eye-lid 1710 and the hairs attached to it, the upper eyelashes 1720, along with the lower eye-lid 1730 and lower eye-lashes 1740, cover the entire eye during eye blinks, and redistribute the tear fluid 1530 over the cellular cornea surface 1520. Not always noticed is that when one looks down, the upper eye-lid 1710 moves down to cover the exposed sclera 1405 almost down to the cellular cornea 1510, colloquially the eyes are “hooded.” This can be important when considering how best to place external sensors to track eye movements.

FIG. 15 shows a zoom 1500 into a small section of the cornea. Here it can be seen that the cornea 1410 is actually made up of at least two layers: the cellular cornea 1510, and the tear fluid 1530. The cellular cornea 1510 actually is it self made of several more layers as documented in the literature, but they do not need to be split out for the purposes of this invention. The cellular cornea 1510 is a fairly clear cell tissue volume whose shape allows it to perform the function of a lens in an optical system. Its shape is approximately that of a section of an ellipsoid. In many cases a more complex mathematical model of the shape is needed, and sometimes may be specific to a particular eye of a particular individual. The thickness near the center of the cellular cornea 1510 is nominally 0.58 millimeters. The tissue at the front surface of the cellular cornea 1510 is called the cellular corneal surface 1520. It is not optically smooth. A layer of tear fluid 1530 fills in and covers these imperfections in the cellular corneal surface 1520. Thus this tear fluid layer 1530 presents an optically smooth front surface to the physical environment 1100. The combination of the cellular cornea 1510 and the tear fluid layer 1530 forms the physical and optical element called the cornea 1410. While the physical environment 1100 could be water or other liquids, gasses, or solids, for the purposes of this disclosure it will be assumed that the physical environment 1100 is comprised of normal atmosphere at sea level pressures, so another name for 1100 is “air.” In some cases, the lower atmospheric pressure at significantly higher than sea level altitudes should be taken into account.

The optical index of refraction of the cornea 1410 (at the nominal wavelength) is approximately 1.376, significantly different from that of the air 1100 at an optical index of 1.01, causing a significant change in the shape of the light wavefronts as they pass from the physical environment 1100 through the cornea 1410. Viewing the human eye as an optical system, the cornea 1410 provides nearly two-thirds of the wavefront shape changing, or “optical power” of the system. Momentarily switching to the ray model of light propagation, the cornea 1410 will cause a significant bending of light rays as they pass through.

Behind the cornea 1410 lies the anterior chamber 1415, whose borders are defined by the surrounding anatomical tissues. This chamber is filled with a fluid: the aqueous humor 1420. The optical index of refraction of the aqueous humor fluid 1420 is very similar to that of the cornea 1410, so there is very little change in the shape of the light wavefronts as they pass through the boundary of these two elements.

The next anatomical feature that can include or exclude portions of wavefronts of light from perpetrating deeper into the eye is the iris 1425. The hole in the iris is the physical pupil 1430. The size of this hole can be changed by the sphincter and dilator muscles in the iris 1425. Such changes are described as the iris 1425 dilating. The shape of the physical pupil 1430 is slightly elliptical rather than a perfect circle. The center of the physical pupil 1430 usually is offset from the optical center of the cornea 1410. The center may even change at different dilations of the iris 1425.

The iris 1425 lies on top of the lens 1435. This lens 1435 has a variable optical index of refraction, with higher indices towards its center. The optical power, or amount of ability to change the shape of wavefronts of light passing through the lens 1435, is not fixed. The zonules muscles 1440 can cause the lens to flatten and thus have less optical power, or to loosen causing the lens to bulge and thus have greater optical power. This is how the human eye accommodates to focusing on objects at different distances away. In wavefront terms, point source objects further away have larger radius to their spherical wavefronts, and thus need less modification in order to come into focus in the eye. The lens 1435 provides the remainder of the modifications to the optical wavefronts passing through the eye. Its variable shape means that it has a varying optical power. Because the iris 1425 lies on top of the lens 1435, when the lens 1425 changes focus by expanding or contracting, the position of the iris 1425 and thus also the physical pupil 1430 will move towards or away from the cornea 1410.

This particular feature of the human eye is slowly lost in middle age. By the late forties generally the lens 1435 no longer has the ability to change in shape, and thus the human eye no longer has the ability to change its depth of focus. This is called presbyopia. Present solutions to this are separate reading from distant glasses, or bifocals, trifocals, etc. In some cases, replacing the lens 1435 with a man made lens appears to restore much of the focus range of the younger eye. However, as will be discussed later, there are other ways to address the issue.

Behind the lens 1435 lies the posterior chamber 1445, whose borders are defined by the surrounding anatomical tissues. This chamber is filled with a gel: the vitreous humor 1450. In recent years it has been found that vitreous humor 1450 is comprised not just of a simple gel, but also contains many microscopic support structures, such as cytoskeletons. The optical index of refraction of the rear of the lens 1435 and the vitreous humor 1450 gel are different. This difference is included in the modifications to the shape of input wavefronts of light to the lens 1435 to the shape of the output wavefronts of light.

A thin set of layers of neural cells lie behind most of the posterior chamber 1445. These layers collectively are called the retina 1460. The retina 1460 contains the photosensitive cells that actually capture the light impinging on the retina. The capture of photons are then converted into neural signals. The final nerve signals are sent out from the rest of the eye to the brain via the optic nerve 1475.

FIG. 16 shows a zoom 1600 into a small section of the retina 1460 that contains the fovea 1465. The retina 1460 is the inside surface lining of the eye, comprised of various thin layers of neural cells that together form a truncated spherical shell of such cells. The retina 1460 includes all these layers. The edge of the spherical truncation that forms the outer extent of the retina within the eye is an edge called the ora serrata 1480. The anterior surface of the shell is bounded by the transition from the vitreous humor 1450 to the retina. The rear of this thin shell bounded by the posterior surface of the pigment epithelium. The front surface of the shell is naturally defined as the retinal surface 1620. However, when treating the retina as a photo sensitive surface, the same term “retinal surface” commonly refers to a different surface: a sub-layer within the particular layer within the thin neural layers where photons are actually captured. To disambiguate these terms, the photosensitive layer will be referred to in this document as the photosensitive retinal surface 1630. The photosensitive retinal surface 1630 lies within a layer included cells specifically set up to funnel and capture light.

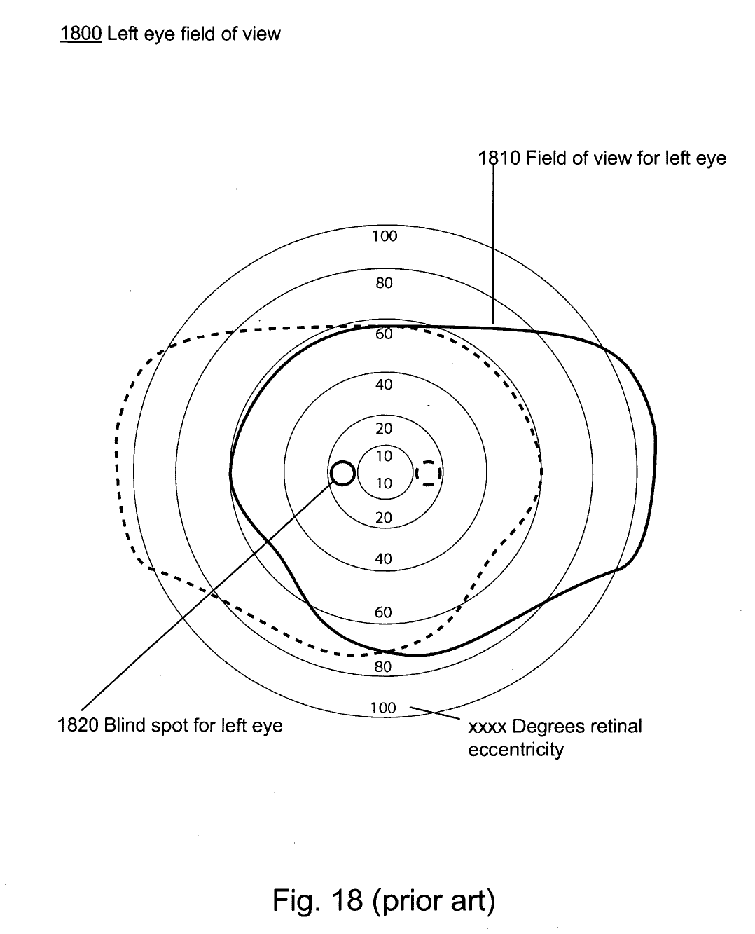

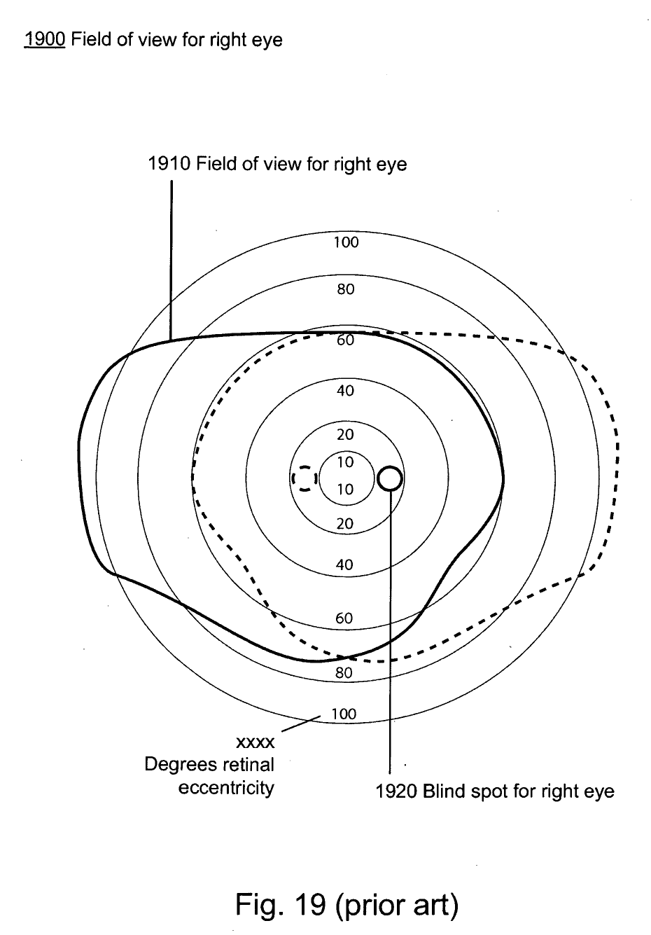

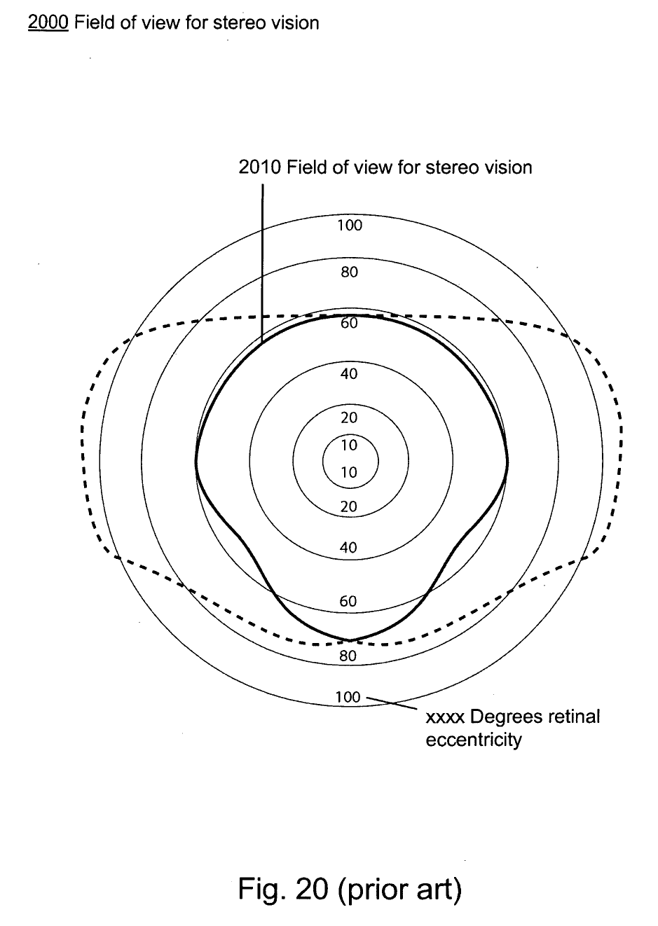

FIG. 18, reference 1800, is a polar plot showing horizontal and vertical limits in degrees of what the left eye can see. The solid line 1810 is the limit of the vision of the left eye. The left eye's blind spot is 1820. The dashed line is the limit of the right eye for comparison. FIG. 19, reference 1900, is the same but for the right eye. The solid line 1910 delimits what the right eye can see and the right eye's blind spot is 1920. The dashed line is the limit of the left eye for comparison. In FIG. 20, reference 2000, the solid line 2010 shows the area of stereo overlap, i.e., the portion of visual space visible to both the left and right eyes. Note that viable displays do not need to cover these visual areas entirely. Many eye glasses and contact lenses artificially narrow the field of view available without notice by the human 110.

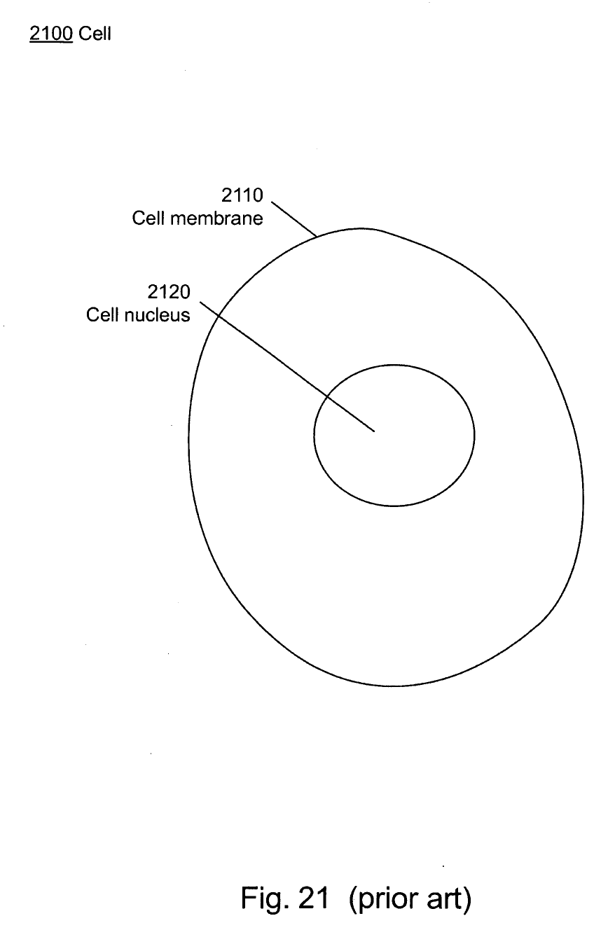

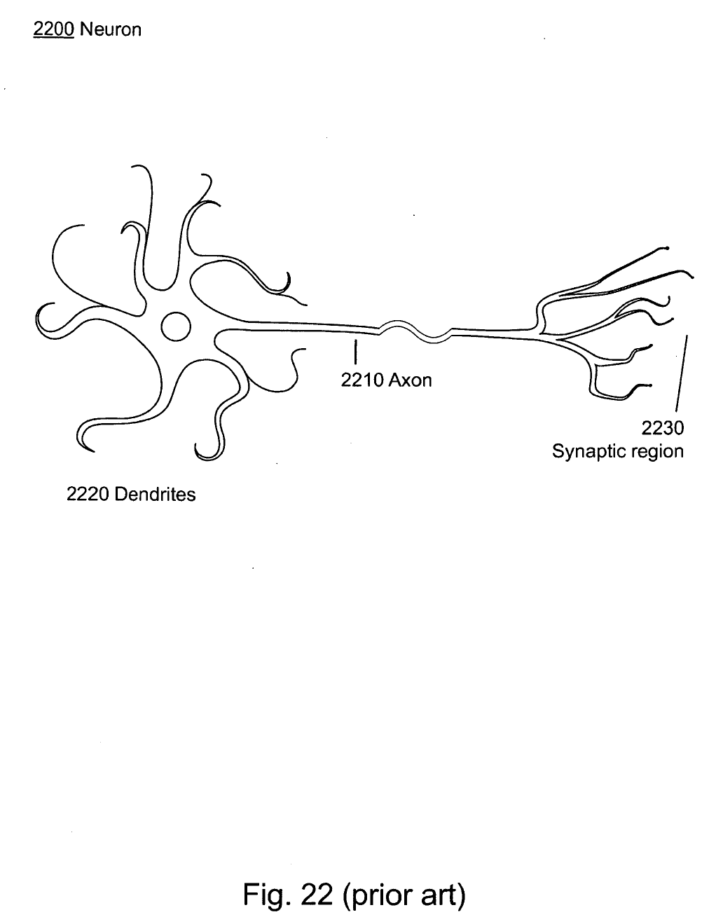

For completeness, the hierarchy of cells that include specific variations of photoreceptor cells will be presented. FIG. 21 is an idealized drawing of a cross section of a single human biological cell 2100, the outer membrane 2110 and the nucleus 2120 that most such cells have. A more specialized human cell is shown in FIG. 22, which is an idealized drawing of a cross section of a single human neuron cell 2200. The specializations of such cells are the synapse region 2230 which are the inputs to the neuron cell, the dendrites 2220 which are the outputs of the neuron cell, and the axon 2210 connecting these two regions, that most neuron cells have.

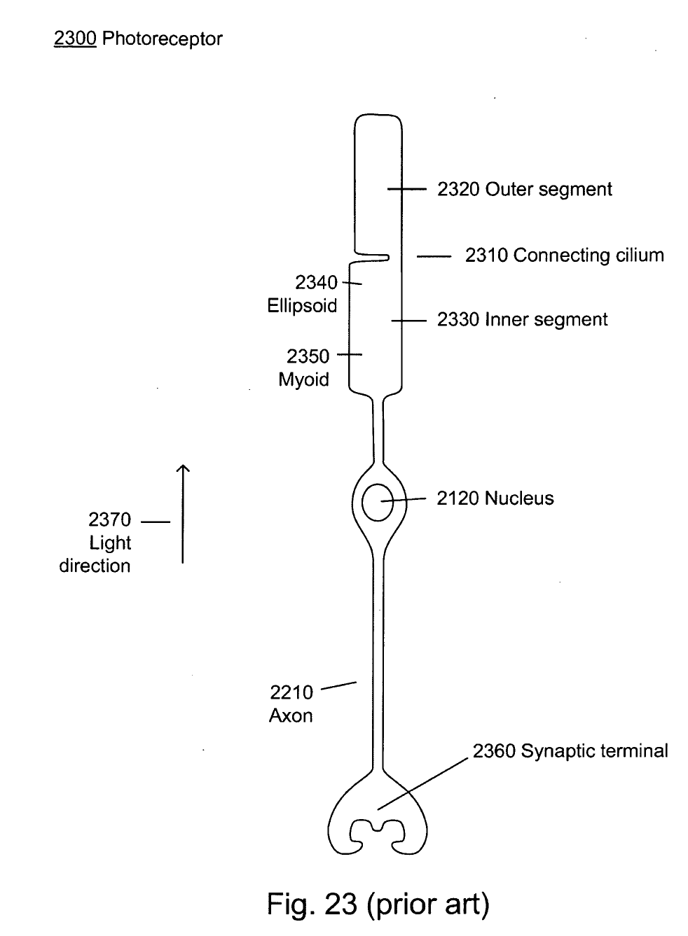

Human photoreceptor cells 2300 are a specialized type of neuron cell. FIG. 23 is an idealized drawing of a cross section of a single human photoreceptor neuron cell 2300. These cells have specialized cilia, the outer segment 2320, where pre-captured photons are converted to biological activity. This region replaces the generic never cell synapse region 2230 with biological structures that gather signals from light, rather than dendrites 2220 of other nerve cells. This outer segment 2320 is behind and attached to the inner segment 2330 by the connecting cilium 2310. The inner segment 2330 is comprised of two portions: the posterior ellipsoid 2340 region, where photons are imaged into the outer segment 2320, and the anterior myoid 2350 region. Element 2370 shows the direction of travel of light through such cells. The human photoreceptor neuron cells 2300 are near the posterior of the retina while outside light enters from the anterior, as shown by reference 2370. The light must first fall through (nearly transparent) other portions of the retina (not shown) before reaching the human photoreceptor neuron cells 2300 at almost the last layer of the retina.

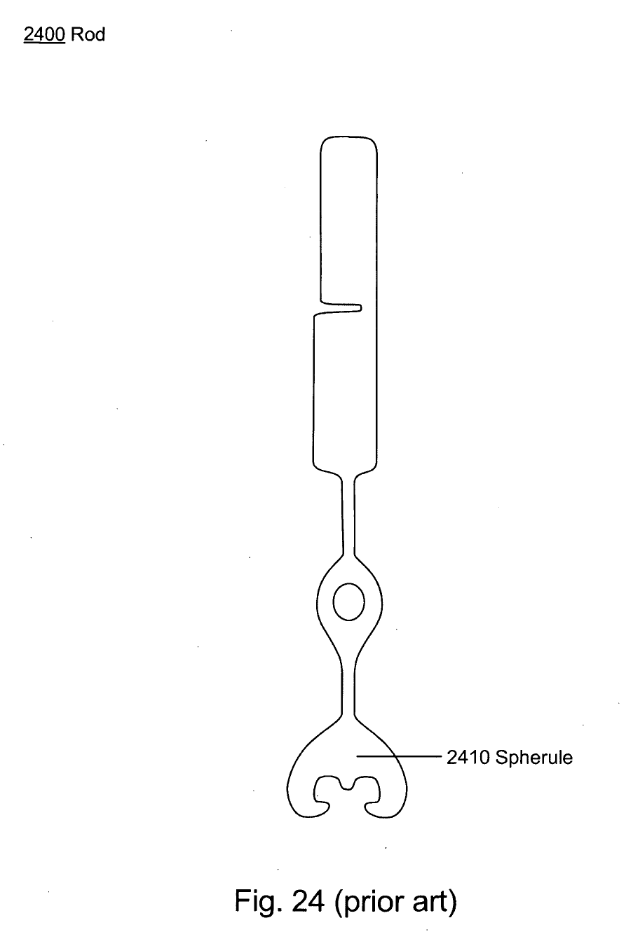

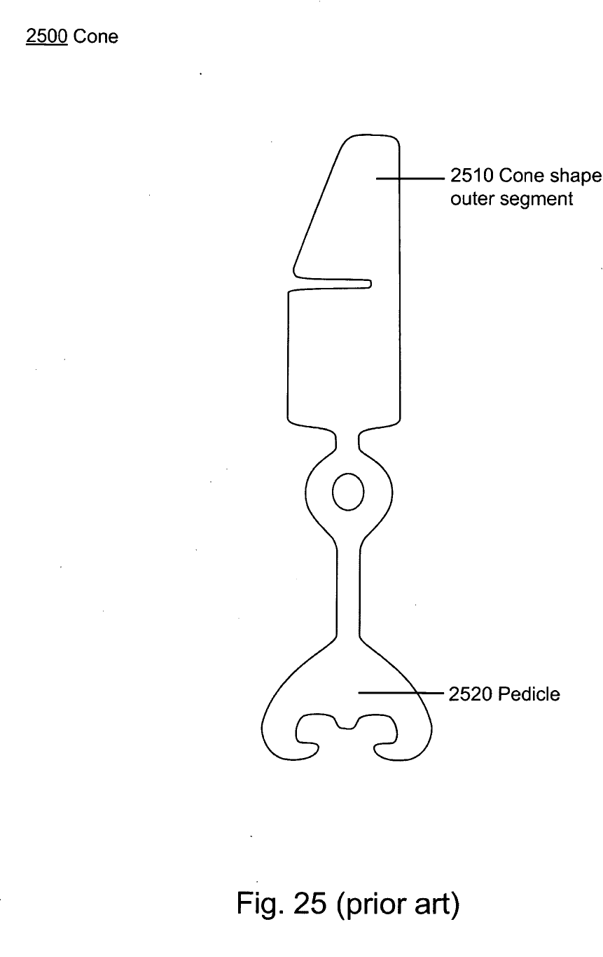

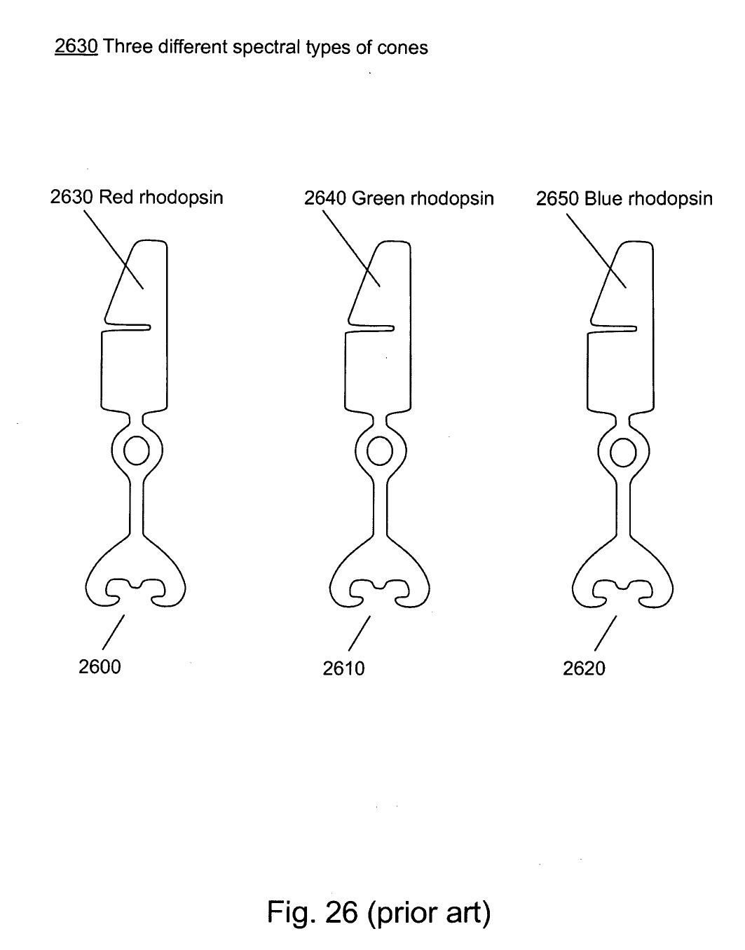

Humans have two types of such photoreceptor neuron cells: the rod cells 2400 (black and white, and generally night vision) as shown in FIG. 24, and the cone cells 2500 (color and generally day vision) with typically cone shaped outer segments 2510 as shown in FIG. 25. The human photoreceptor neuron cone cells 2500 have three functionally different types primarily by the specific photopigment present in the outer segment. The photopigment determines the relative sensitivities of portions of the visible light spectrum that the cone responds to. This is shown in FIG. 26. Human photoreceptor neuron red cone cells 2600, green cone cells 2610, and blue cone cells 2620 contain red 2630, green 2640, and blue 2650 visual pigment molecules, respectively. There is also some minor shape difference between cones with different spectral sensitivity, specifically the blue, but this shape difference usually is not important for the purposes of this application.

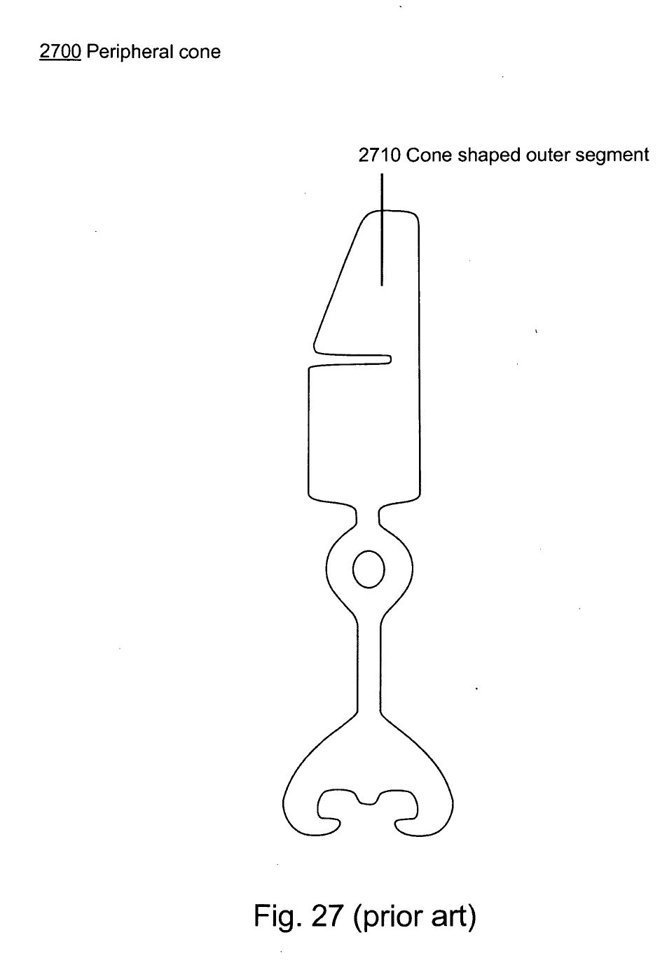

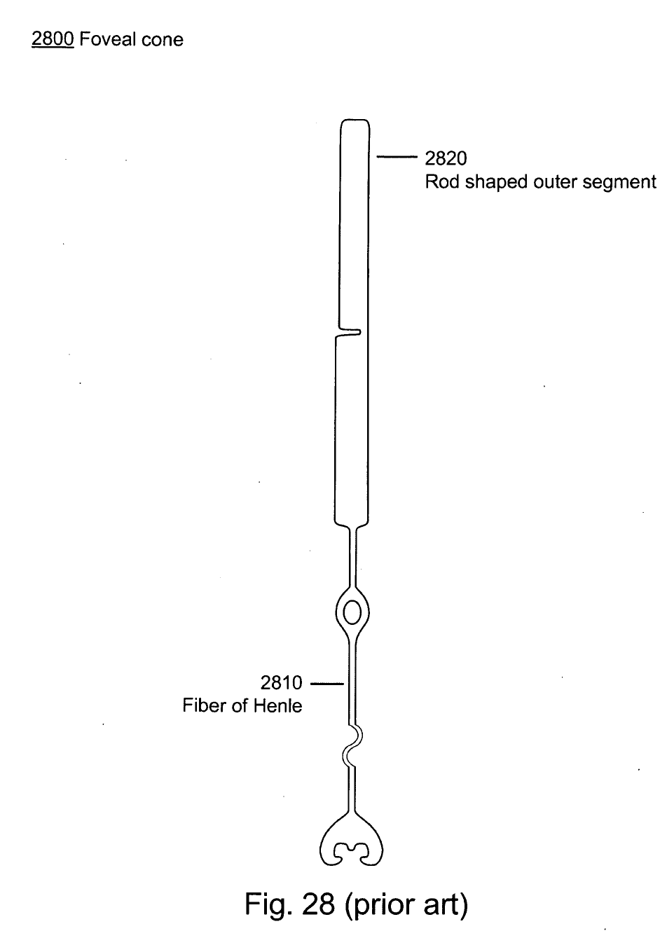

However, a shape difference common to all cone cell type depending on how close to the packed center of the retina they are can be important. Cone cells in most of the retina outside the fovea have a shape that is short, wide, and with cone shaped outer segments, as was shown as reference cone shaped outer segment 2510 in FIG. 25. But inside the tightly packed fovea, cone cells overall are narrower, more elongated, and the outer segments lose their cone shape. FIG. 28 shows a cross section of such a foveal cone cell 2800 roughly to scale with the peripheral cone cell 2700 in FIG. 27. Many intermediate and variation shapes exist. These differences in area of light capture are important when the resolution limits of different portions of the retina are considered. Specifically, while most of the human retina is “inside out,” in that all the neural processing circuitry lies in front of the rods and cones, in the fovea all these processing cells have been pushed away from the center leaving the light path to the foveal cones unblocked. The only things in front of the fovea cones are the cone cell body, displaced anterior enough to be out of the cone's outer segment ellipsoid focal plane, and a greatly lengthened axon referred to as a fiber of Henle 2810 used to move all other neural processing circuitry away from the fovea. Both the cell body and fiber of Henle are nearly transparent. Also, no blood vessels are present in this foveal area.

There are many more layers within the retina where various forms of information processing is performed on the outputs of the rods cells 2400 and cone cells 2500 before the final results of the computation performed by the retina 1460 itself is sent out via the optic nerve 1475.

Since the retina 1460 (and the various outer surfaces that support it) employs a nearly spherical shape, this affords a very wide angle field of view optical system.

The size and spacing of the photoreceptors, rod cells 2400, and cone cells 2500, is far from constant in different portions of the retina 1460. The more accurate anatomical definition of the fovea 1465 is as a region of the retina 1460 located roughly 2 degrees below and 15 degrees temporal from the center of the optic disc 1470. The fovea 1465 subtends approximately two degrees of external visual angle. The highest packing density of cones (and thus narrowest cone widths) occurs at the center of the fovea 1465, and falls off in density by a function mainly of retinal eccentricity but also partially of retinal co-latitude all the way out to the ora serrata 1480, though the fall-off in density slows down about half way to this limit. This density function is described in detail in Curcio, C.; Sloan, K.; Kalina, R.; and Hendrickson, A.; “Human Photoreceptor Topography,” J. Comparative Neurology 292, 497-523 (1990), and modeled cone by cone in U.S. patent application Ser. No. 11/341,091, “Photon-Based Modeling of the Human Eye and Visual Perception,” filed Jan. 26, 2006 by Michael F. Deering; both of which are incorporated herein by reference.

The density of the photoreceptors, rod cells 2400, or cone cells 2500, within a particular region of the retina 1460, is measured in rods or cones per square millimeter. For regions specified within the more central portions of the fovea 1465, the (head on) size of the cone cells 2500 can be computed by taking the inverse of the region's density, along with additional conversion factors assuming a tight nearly hexagonal packing of cone cells 2500. Outside the central portions of the fovea 1465, the (head on) size of rod cells 2400 or cone cells 2500 has to be more directly measured, though models (created by fitting data) of size and spacing change at different eccentricities on the retina 1460 can give good estimates.

III.C. Retinal Receptive Fields

The additional layers of neurons between the output of the photoreceptor cones 2500, and output of the eye, the optic nerve 1475, perform a plethora of different processing computations on the cone output data, and the purpose of many are still not fully understood. For the purposes of this disclosure, a simplified model of most of the data output from the eye, cone retinal receptive fields 2900, is sufficient. Accurate models of cone retinal receptive fields 2900 are important to eye mounted displays in two ways. First, they change in size and their size as determined by both retinal eccentricity and co-latitude establishes the maximum resolution in a particular sub-region of the retina that the eye mounted display needs to generate for that sub-region if maximum resolution is to be achieved. Second, an eye mounted display does not have to precisely duplicate the illumination pattern on the retina as what natural world produces for a similar visual scene. The more important goal is through illumination of the retina to cause the retinal circuitry to as closely as possible replicate the computed output signal generated by the cone retinal receptive fields 2900.

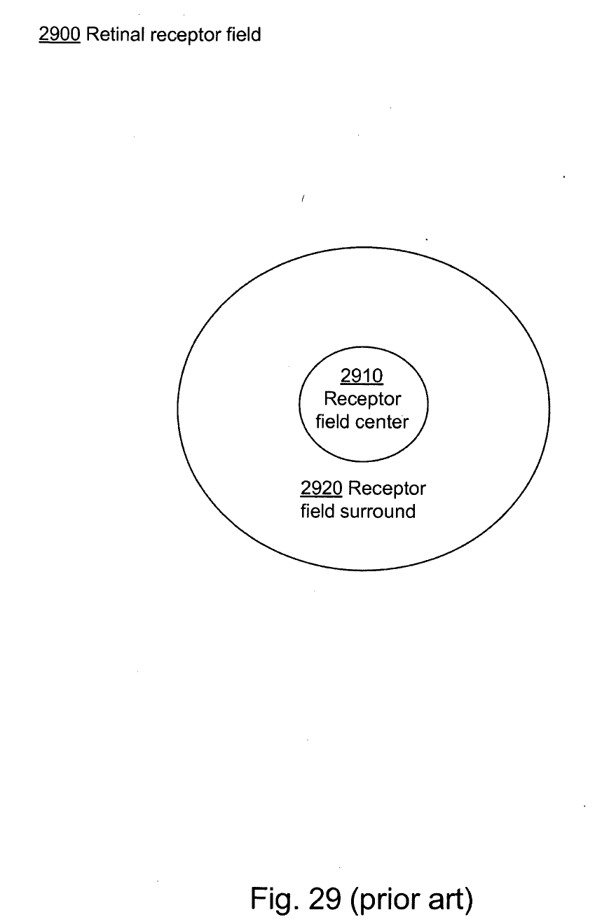

An abstract model of a retinal receptive field 2900 is shown in FIG. 29. There are two different retinal receptive field sub-fields: the retinal receptive field center 2910 which is the area bounded by the smaller circle, and the retinal receptive field surround 2920 which is the area bounded by the larger circle. Both retinal receptor field sub-fields are circularly symmetric and share a common center. Thus, the retinal receptive field surround 2920 completely overlaps the retinal receptive field center 2910. In general, the diameter of the retinal receptive field surround 2920 is two to three times the diameter of the retinal receptive field center 2910. The (simplified) computation that retinal neurons perform on these two sub-fields is a weighted summation of the differential relative amount of light falling within the retinal receptive field center 2910 and the light falling on the retinal receptive field surround 2920.

A commonly used simplified weighting function for the retinal receptive field center 2910 is a Gaussian centered on the field that has its zero at the outer edge of the center field; and for retinal receptive field surround 2920 a larger Gaussian also centered on the field, but with its zero at the outer edge of the center surround. These two Gaussians have opposite signs. The overall (absolute value) volume under the retinal receptive field center 2910 is similar (to a factor of two or so) of the overall volume under the retinal receptive field surround 2920. Because one of the Gaussians always has positive weights and the other always has negative weights, the computation is referred to as a difference of Gaussians, or DOG function. More accurate weighting functions exist in which each individual photoreceptor contributing to retinal receptive field sub-fields 2910 and 2920 is an individual Gaussian. This is known as Difference Of Offset Gaussians, or DOOG function. However it is known that even an individual Gaussian is a simplification. More accurate photoreceptor PST functions can be computed as in U.S. patent application Ser. No. 11/341,091, “Photon-Based Modeling of the Human Eye and Visual Perception,” filed Jan. 26, 2006 by Michael F. Deering.

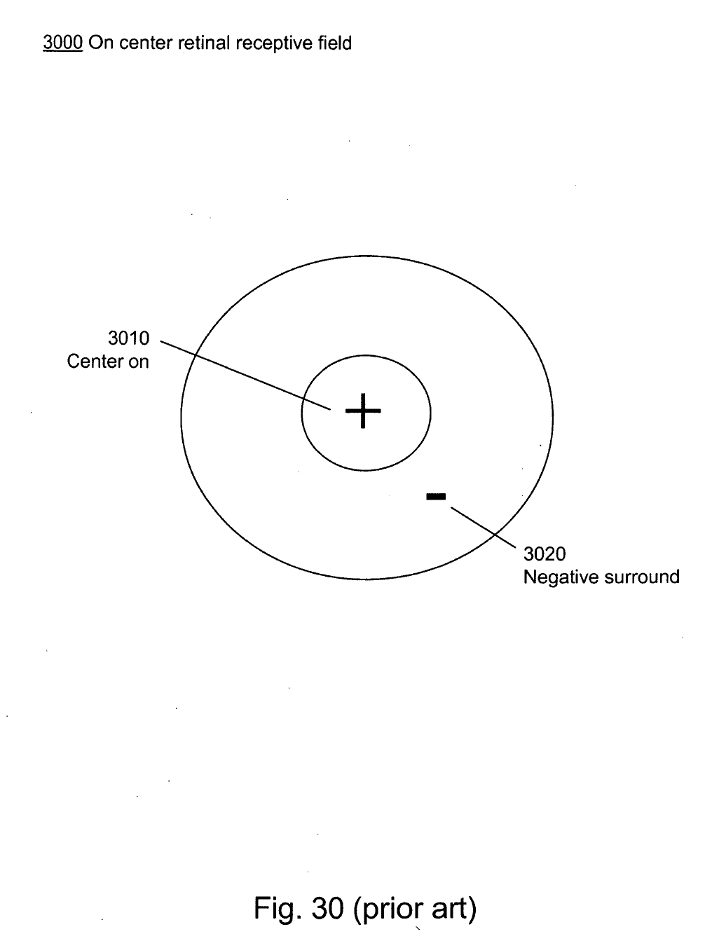

Because the neurons cannot easily represent both positive and negative values, there are two different types of retinal receptor fields 2900 (each with its own dedicated computational neural circuits) approximately associated with every retinal receptive field location. A “center-on” retinal receptive field 3000 is one that will only generate a response if there is enough upward change in light falling on the retinal receptive field center 2910 to cause the individual cones to fire, and if a weighted amount of light falling on the retinal receptive field center 2910 is significantly greater than the weighted amount of light falling on the retinal receptive field surround 2920. This is schematically represented in FIG. 30, where the positive weight nature of the retinal receptive field center 2910 is denoted by a plus sign; and minus sign(s) are within the (non-overlapped) retinal receptive field surround 2920.

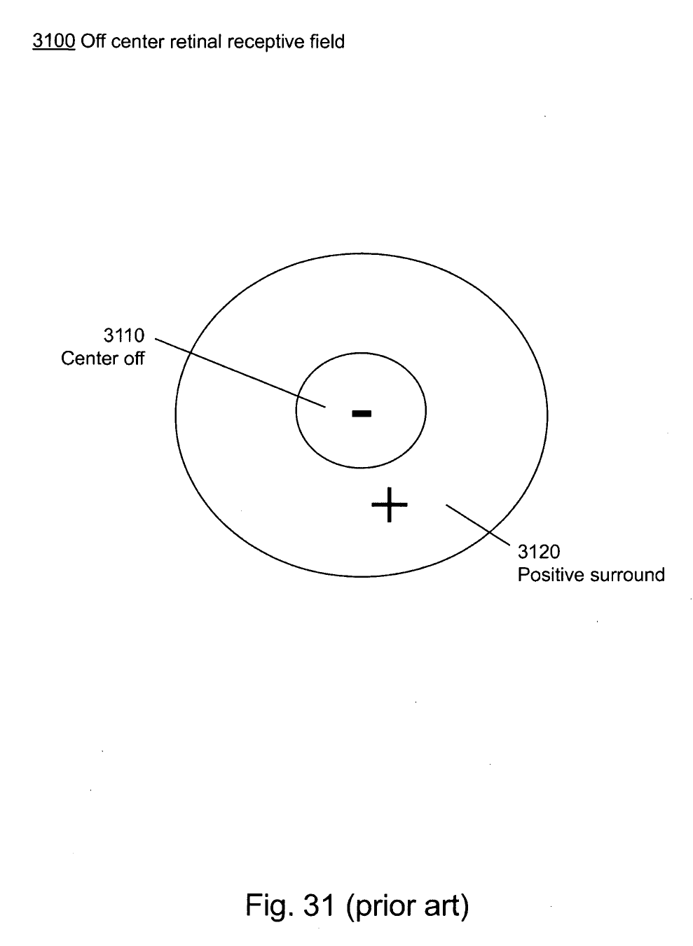

The inverse case is the “center-off” retinal receptive field 3100 that responds to the relative amount of light on the two retinal receptive sub-fields 2910 and 2920 in an inverse way. This is schematically represented in FIG. 31, where the locations of the plus and minus signs have been reversed. Here the center must have enough downward change in light for the central cones to fire. Note that the hidden pluses and minuses of the surround exist under the center field but by convention they are not shown on this type of diagram. It is often common practice to show only the sign of the center field. The extra signs of the surround shown in the figures are present to reinforce the point that all surrounds are made up of multiple cone cells, even in the fovea; while the single sign in the center reinforces the point that the center can be as small as to be made up of just a single cone cell in the fovea region, even though it will consist of multiple cone cells outside the region of the fovea.

Thus on average every retinal receptive field location has two output neurons that leave the eye via the optic nerve 1475 for more processing elsewhere in the brain (mainly within the visual cortex).

Another important point for most particular classes of retinal fields is that for the most part, the retinal receptive field centers 2910 form a complete tile of the retinal surface for each sign. For a given sign, no two different retinal receptive field centers 2910 overlap another. Generally there are no photoreceptors that do not belong to one (and only one) retinal receptive field center 2910 of each sign.

These properties allow eye mounted displays to simplify how they target light at the photosensitive retinal surface 1630 Each collection of photosensitive cells that form a retinal receptive field center 2910 for some retinal receptive field 2900 can be thought of as individual light consuming “pixel,” just as individual light sensitive photo junction areas in a CCD or CMOS digital camera chip.

The human eye still differs from current camera technology in several ways. One difference is that the eye's “pixels” vary vastly in area in different portions of the eye. Eye mounted displays can take advantage of this property, reducing the number of “physical pixels” that the EMD has to produce to a small fraction of that required by most conventional display technologies to form an equitant high resolution image to the viewer of the display.

Three mechanisms cause the retinal receptive field center 2910 (eye pixels) to vary in area. First, as discussed before, the head-on area of cone cells 2500 is the smallest at the very center of the fovea 1465. At one degree of visual eccentricity away (the edge of the fovea 1465), the area of cone cells 2500 may have doubled or tripled. The area of the cone cells 2500 continues to increase with greater visual eccentricity (with some additional variation in visual co-latitude) all the way out to the ora serrata 1480 (though the rate of growth greatly slows at about half way to this edge). The area between cone cells 2500, which hardly exists in the packed center of the fovea 1465, also grows with greater visual eccentricity as smaller rod cells 2400 start intermingling between the cone cells 2500. The other cause of increase in retinal receptive field centers 2910 area are due to the change in nature of the retinal receptive field centers 2910 from being just a single cone cell 2500 at the center of the fovea 1465, to the retinal receptive field centers 2910 being formed by larger and larger groupings of cone cells 2500 at increasing eccentricity.

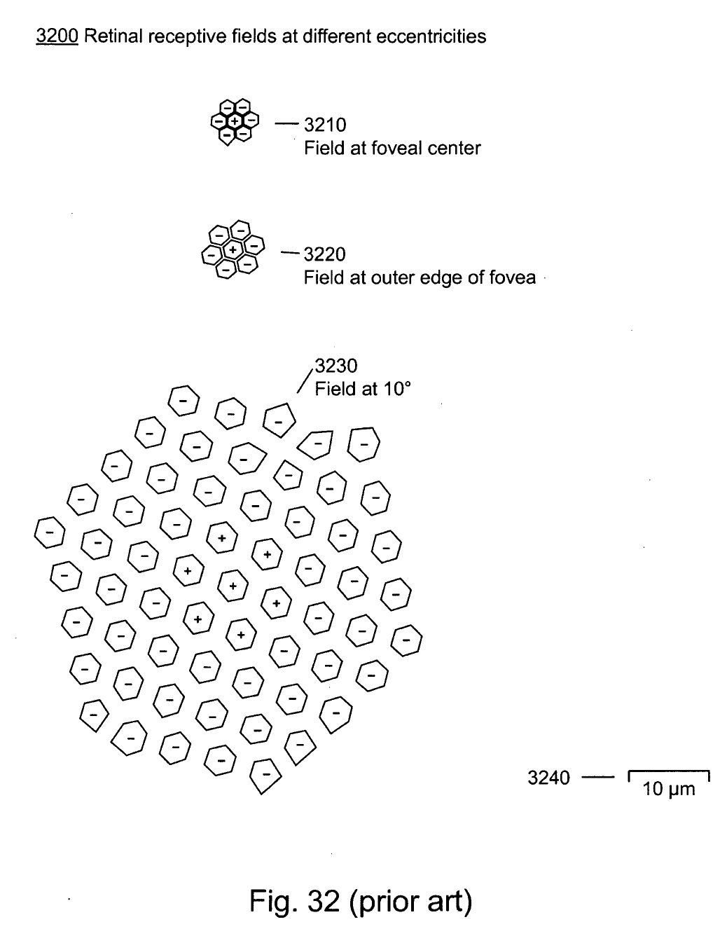

All three of these effects are shown in FIG. 32, reference 3200. Reference 3210 shows how retinal receptive fields are formed from cone cells 3210 at 0° of retinal eccentricity (the center of the fovea). Reference 3220 shows how retinal receptive fields are formed at 0.9° (outer edge of fovea, and edge of the region where the center is a single cone). Reference 3230 shows at 9° (example of center being comprised of multiple cones). All three fields are drawn using the same physical scale, with element 3240 showing ten microns for reference. These are all “center on” fields. The symmetrical “center off” fields exist at the same location (generally) using the same cones, but with inverted signals before summation and thresholding before transmission out of the optic nerve.

Because the optics of the eye degrade at larger and larger visual eccentricity, the actual area of a cone cell 2500 is not so important. What is important is the density of cone cells 2500 at a particular visual eccentricity (and co-latitude). Conventionally this density is measured in units of number of cone cells 2500 per square millimeter (with the eye radius normalization convention discussed earlier).

Thus if a designer of an EMD wants to know what size “eye pixel” would give the best resolution in a specific region of the retina 1460, he can look up the retinal cone density for that region, invert the density to estimate the average area of a cone cell 2500 and its share of the area between cone cells 2500 within that region, and then multiply that area times the number of cone cells 2500 that comprise the retinal receptive field centers 2910 within that region. He can convert between retinal area and visual angle as needed for other uses. These location specific cone cell 2500 density numbers are available from a number of sources in the literature. For example, see Curcio, C.; Sloan, K.; Kalina, R.; and Hendrickson, A.; “Human Photoreceptor Topography,” J. Comparative Neurology 292, 497-523 (1990); Tyler, C., “Analysis of Human Receptor Density,” in Basic and Clinical Applications of Vision Science, Ed. V. Kluwer Academic Publishers, 63-71 (1997); and as in U.S. patent application Ser. No. 11/341,091, “Photon-Based Modeling of the Human Eye and Visual Perception,” filed Jan. 26, 2006 by Michael F. Deering; all of which are incorporated by reference herein. The number of cone cells 2500 that are grouped together in the retinal receptive field centers 2910 for the can be estimated from spatial frequency studies of the region in question.

The size of the receptive field components at greater eccentricities grow in size even faster than the distance between cones grows. This explains why although the human eye 1300 contains more than five million cone cells 2500, it only contains 800,000 retinal receptor fields 2900 and as half of those are duals of each other. Thus, there are only 400,000 unique retinal receptive field locations for the entire retina 1460. This spatial variable resolution by eccentricities has been confirmed by many different experiments, including physiological experiments (eye tests at different eccentricities). Thus an eye mounted display need only control light aimed at these 400,000 unique retinal receptive field centers 2910, which becomes a progressively easier job outside the fovea, as the size of the receptive field centers become fairly large.

It can be noted that the 800,000 unique retinal receptive fields 2500 per eye is supported by the fact that the optic nerve 1475 (leaving the back of the eye into the rest of the brain) is comprised of only one million neural fibers and at least 200,000 of them are doing other things than transmitting retinal receptive fields 2900 results. It can also be noted that the number of display pixels needed to form the highest natural resolution image on the retina (and thus the cones) is not necessarily one-to-one. Better to perfect coupling between the display and the unique retinal receptive field centers 2910 can require that the display pixel count is larger by a small multiple. However there is a diminishing return in perceivable quality to the human viewer with increased pixel density too much past the retinal receptive field centers density. Other factors, such as optical blur and chromatic aberration of the eye's optical elements, coupled with diffraction effects sets the limits in display pixel density. For simplicity, most of this document assumes a particular sub-set of EMDs in which the two densities are the same but this is not intended to limit the scope of this work.

The retinal receptive fields 2900 have no directional bias. They respond the same to the same stimuli moving across the field at the same speed no matter which direction of motion the stimuli take. Note that there is another class of retinal receptive fields that are sensitive to moving edges but the outputs of these fields seem to play a more important role in local eye movement coordination than in the processing performed in the visual cortex. There is a temporal bias. Signals from the retinal receptive field centers 2910 arrive at the neural difference circuits slightly before the signals from the retinal receptive field surrounds 2920. This allows retinal receptive fields 2900 neural outputs not only to indicate a contrast difference between center and surround but to also indicate changes in the absolute amount of light and contrast difference between the center and the surround.

It is important to understand what signals retinal receptor fields generate given various inputs. It is the job of an eye mounted display to induce similar outputs when displaying similar data. One important reason why this is needed is that by its very nature, pixels on an eye mounted display do not slide across different cones when the eye rotates due to drifts. So an understanding of the retinal receptive field signals generated due to drifts and micro saccades in the natural environment allows an eye mounted display system to compute and display changing pixel values that will induce as close as possible the same outputs of the retinal receptive fields. While cones are by nature color sensitive, the highest resolution is not, and so to simplify the description we will discuss the external physical environment and neural processing purely in the luminance domain, e.g., black and white and grays.

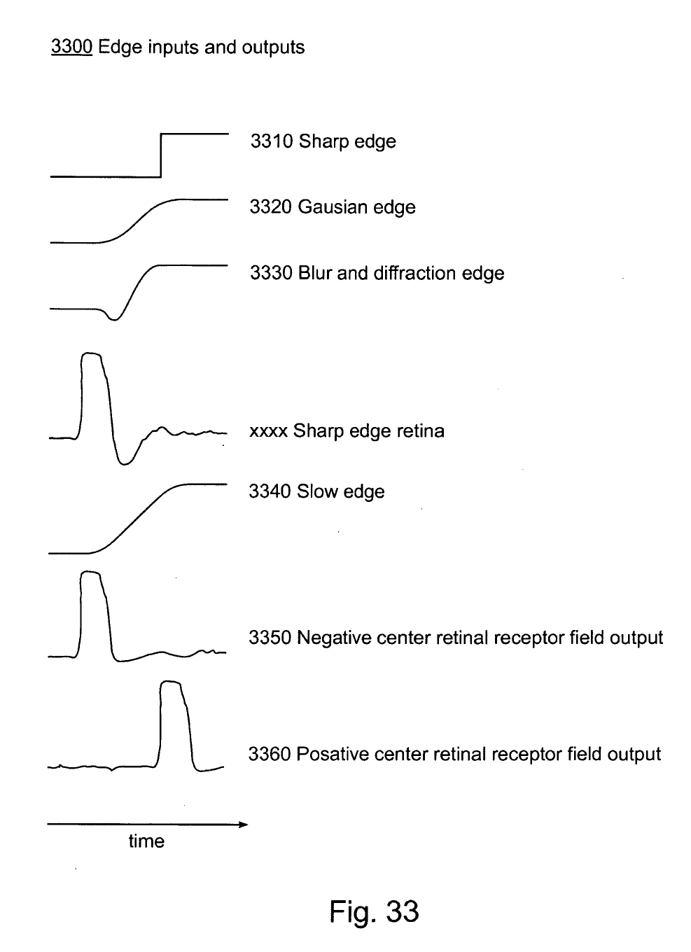

FIG. 33 reference 3300 shows several one dimensional edge inputs, retinal inputs, and retinal receptor outputs. Reference 3310 shows a one dimensional cross section of an infinitely sharp step edge. An approximation to such an edge might occur in nature at the edge of a tree trunk lit by bright sunlight, but in front of dark foliage in shadow. We assume that the relation between the human observer and the tree trunk is such that the tree trunk is much wider than any retinal receptive field, and that the human observer is focusing his retina on the region of the trunk/dark foliage edge. While at high enough magnification even this tree trunk edge will be revealed to be fuzzy due to diffraction effects, for a normal human observer, the trunk edge will be infinitely sharp for all intents and purposes. As this natural scene image passes through the optical elements of the human eye, the modulation transfer function (MTF) of the eye will cut off the higher frequencies of the sharp edge, rounding it down until it looks like there is a half of a Gaussian (approximately the same shape as a quarter sine wave) as seen in reference 3320, rather than a sharp edge. The angular size of this “grey” region between dark and light is determined by the eye's natural optical blur at a given pupil size, even at best focus. For near minimum pupil size (least optical blur), for cones in the central fovea, diffraction effects combine with the blur. While the results will vary due to a large number of other factors, reference 3330 shows what a combined blur and diffraction edge might look like some of the time: not necessarily just a simple rising edge.

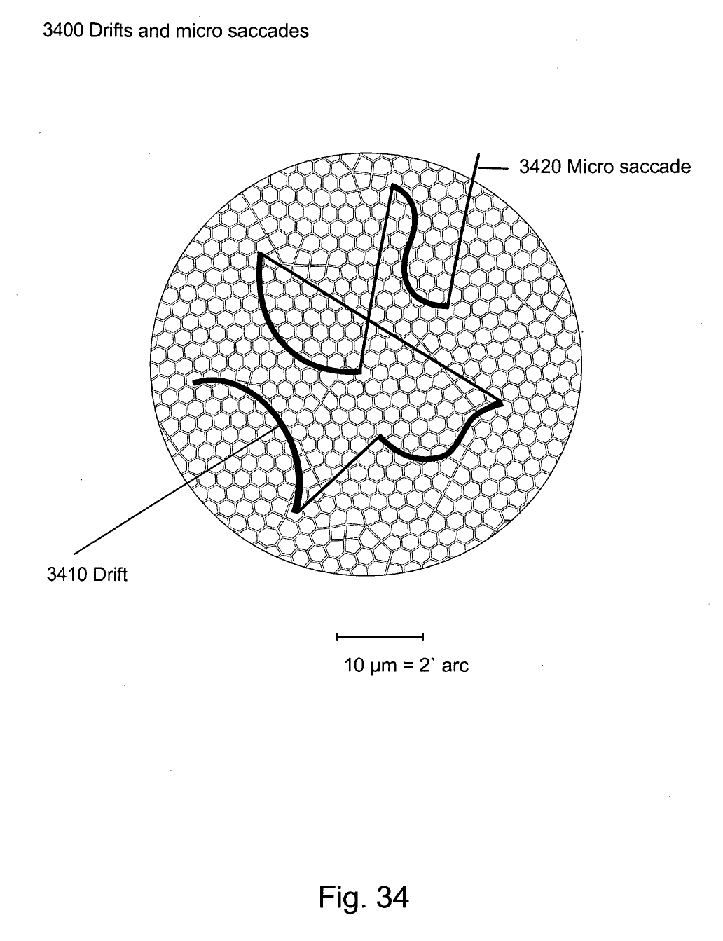

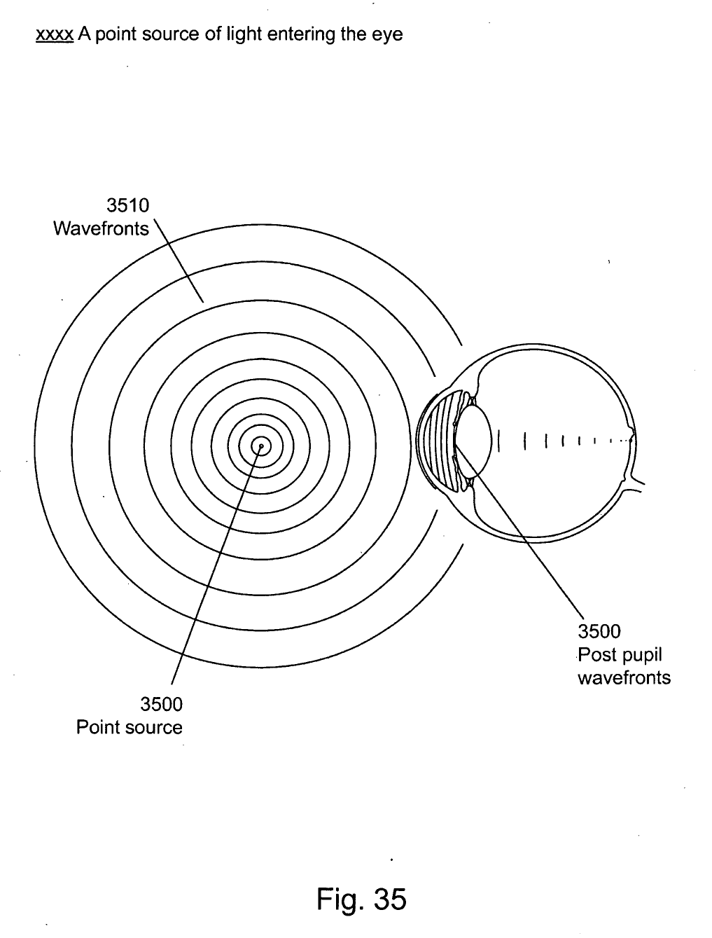

When the human and/or the object being looked at are moving, the human body, head, and eyes are usually rotating so as to produce as stable an image of the object as possible on the retinas (left and right eyes). These movements preferably are taken into account by an EMDS 105, but their primary effect is to cancel out, so that the major movements of the object across the retina are the drifts and micro saccades. So for a slight simplification in the discussion that follows, we will assume that both the human observer and the object(s) being looked at are not moving. Thus the only movements will be caused by drifts and micro saccades. Ordinary saccades need not be considered other than in resetting the orientation of the eye, because the visual system shuts down during such events and does not start “seeing” things again until more than a tenth of a second later. So our eye movements will consist of a number of drifts at various angles and speeds coupled by micro saccades within a small region, punctuated by starting the whole process all over again in a different small region after a full saccade has taken place. FIG. 34 shows such a series of drifts 3410 and micro saccades 3420 between two major saccades. Notice that the drifts are not perfectly straight lines, which makes accurately tracking them at high tracking frequencies (close to 300 Hz or more) all the more important.

One question to ask is what happens to the output of a cone cell as it is moved across this dark to light edge? Cone cells respond mainly to changes in retinal illumination striking them. So as long as a cone cell is looking at the dark foliage, the output will be low. But as an eye rotational drift moves a cone cell across the edge, the cone cell's input captures the edge going approximately from black to white. The cone will see a change in a relatively short time. This will generate the output seen in FIG. 33 reference 3340. Note that the edge will generate only one burst of activity per cone. Once the cone is just seeing the (assumed constant brightness) tree trunk, the cone will lapse back into low or no output mode. Actually, cones are more negatively charged the darker it is, and generation of neurotransmitters at synaptic pedicles is at its peak in dark. However to simplify the discussion we will use the inverting convention that more light means more output.

So then what happens when a retinal receptive field slides across this edge at some angle, due to intentional drifts of the eye? Imagine a center-off field sliding from left to right. As the right hand edge of the positive surround field starts climbing up the hill of the sloped edge, the rightmost surround cones will generate a burst of activity. This will cause an increase in the output of the positive surround, as now several cones will be getting more light than the rest. However, at the same time, the negative center of the field will shift from seeing dark foliage to light tree trunk, generating a large weighted burst, and so after applying the weighting functions, the difference output of the off-center receptive field will generate a burst of activity that will be sent up the optic nerve through the LGN to the early visual cortex in the brain. Once the negative center cone has passed into the light, the differences between the center and surround output will be much lower, and the retinal receptive field will go quiescent.

Note that a center-off retinal receptive field will start firing at the leading edge of a visual feature. For example, in our tree trunk case, the center of the center-off retinal receptive fields will mark the region just as it starts becoming light. As we will see next, a center-on retinal receptive field will mark the opposite case, e.g. the region just before or as becomes full light. Both of these assume a drift that passes the retinal receptive fields over the edge between a limited range of speeds. If too slow, nothing will feel like firing. If too fast, an output might not occur. Note that the “speed” that a retinal receptive field is passing over a particularly oriented edge in a natural scene image on the retina is not determined just by the speed of the drift, but also its direction. If the direction of the drift is close to the same direction as the edge, no inputs will change, and no retinal receptive fields will fire. If the drift is a high speed drift with a direction roughly at right angles to the edge, the fastest traverse will occur, which might be too fast for a given retinal receptive fields to fire, or just right.

Now let us examine the same case but looking at a center-on retinal receptive field. Here the field will start firing at the end of the edge, generally one cone (in this example) to the right of cone where the off-center fired. If the edge was too soft, as seen in element 3340, e.g. as might be caused at a different times the day when the sun is positioned to the right of the tree (from our same view), away from the edge of the tree trunk, the ramp from the darkest to the lightest region will no longer come in as a square step up, but as an extended quarter sine wave. Now the firing of the off-center and on-center retinal receptive fields can become separated by one to several cones. This can be seen by lining up in time the retinal illumination input, element 3340, to element 3350, which shows the output of the center-off retinal receptor field, and element 3360, which shows the output of the center-on receptor field. This change in output patterns due to lower visual frequency light inputs coming into the retina can be important in understanding how the early visual cortex finds patterns. This can be important to EMDs to simulate portions of this blur because, if the “pixels” in the EMD perfectly track the retinal movement, then the natural blurring will be eliminated. It should also be noted here that additional much lower visual frequency retinal receptive fields 2900 also tile the retina, and allow lower frequency objects to be encoded.

Major saccades tend to be separated by between 190 milliseconds and 800 milliseconds, and locked to the alpha wave “clock” of the brain. Between major saccades there usually are a number of 50+ millisecond drifts of different speeds and orientations coupled by very fast micro saccades within a local region. The number of drifts that occur depends on how much time is available between major saccades. FIG. 34, reference 3400 shows a series of drifts (3410) and micro saccades (3420) between two major saccades.

Why does the visual system perform these drifts, at differently sampled local origins, directions, and speeds? The apparent reason is that it allows the visual system to sample the same natural scene image data in several different ways, and even with lossy biological sensors and processing, determine quite accurate information about the natural scene image being viewed. No matter what the orientation of a particular edge in the image, drifting at two or three different directions will guarantee that some retinal receptive fields will traverse the edge at a high enough angle to produce an output if an edge is present. Furthermore, the different relative speeds that the edge moves will be distributed too, greatly raising the odds that the edge will traverse a retinal receptive field within its motion window. This becomes more important when one removes the simplification that the object and the human are not also moving. If the edge is an extended edge (as our vertical tree trunk is), on a particular drift a particular retinal receptive field may be placed wrongly to capture the edge. But with multiple drifts, such “missing pieces” of a real edge can usually be found. Thus in many ways, the eye is “over-sampling”the natural input image by making the assumption that the image is not changing much between minor saccades. In the image processing literature, such processing is similar to what is call “super-resolution (for both still and moving images).

The retinal receptive field processing during these drifts is not just happening at the center of the fovea, but over the entire visual field at the same time. Faster drifts are necessary for larger more peripheral retinal receptive fields to meet their minimum edge movement rates. The micro saccades themselves (very fast movement between local points) might be needed to drive fast enough retinal image movement for the largest of the peripheral retinal receptive fields to “see” anything, at least in our fixed observer and object case.

Now that a model of how natural images imaged onto the retinal surface will result in 400,000 variable sized retinal receptive field outputs has been described, we can address what an EMDS 105 can do to emulate some of these effects. One task is to accurately and rapidly detect the eye orientation at the end of all micro saccades, and then detect the direction and velocity of the following drifts. Given this information, the computation performed by the re-scaling sub-system on the video input frames has to elongate its footprint in the direction of and appropriately proportional to the velocity of the current drift.

This is computationally possible because the footprint generation and processing circuitry is designed to accept a drift direction and velocity as one of its per frame inputs. It is possible for this computation to keep up with and fool the eye because the computation performed by the re-scaling sub-system occurs several times faster than the cone light integration time. This means that the amount of blur per re-scaled frame is not the total amount of blur that the drift will generate but blur based upon the amount of drift that will occur during the current frame of display. The display frame rates could be as low as 60 Hz, but may deliver higher quality results at multiples of this rate, e.g. 120 Hz, 180 Hz or higher. There also is a difference between a mostly static workstation mainly displaying text, and a HDTV display displaying an action movie with lots of dynamic movement. In theory the same re-sampling can be applied to both but in practice a dynamic computation based on the changes between frames may be able to “tune” the operation performed by the re-scaling sub-system to the current content type.

While this discussion of the human visual system has stopped at the neural circuitry that produces outputs from the eye (e.g., on the optic nerve), much is also known about what the early visual cortex, what many researchers currently call regions V1, V2, V3d, and MT (although other researchers use a number of slight variations of region names, boundaries, and functionality). Understanding of these visual cortex models can allow an EMDS 105 to further improve quality, but as all these cells are processing the outputs of retinal receptive fields, building an EMDS to get the right data coming out of the retinal receptive fields will get most of the job done. The application of knowledge of the visual cortex's simple, complex, and hyper complex cells to the tuning of an EMDS follows similar to what has been described above.

III.D. Formation of Images on the Photosensitive Retinal Surface from Collections of Incoming Expanding Spherical Wavefronts of Light

FIG. 35 shows multiple wavefronts 3510 emitted by the point source 3500. While the wavefronts are initially spherical, in FIG. 35 the wavefronts 3510 are eventually truncated to show only those portions that will pass near the human eye 1300. As can be seen in FIG. 35, only those portions of the wavefronts 3510 that intersect with the cornea 1410 will enter the eye 1300 (ignoring reflections off the cheeks, etc.). As the wavefronts 3510 pass through the cornea 1410, their shape will be changed. The exact nature of the change in wavefronts 3510 shape is a function of corneal 1410 shape, the shape of the wavefronts 3510 as they encounters the cornea 1410 (usually portions of spherical wavefronts of a given radius), and the specific optical frequency of the emitted wavefront 3510. This function can be simulated by computer programs. See, for example, U.S. patent application Ser. No. 11/341,091, “Photon-Based Modeling of the Human Eye and Visual Perception,” filed Jan. 26, 2006 by Michael F. Deering, which is incorporated herein by reference.

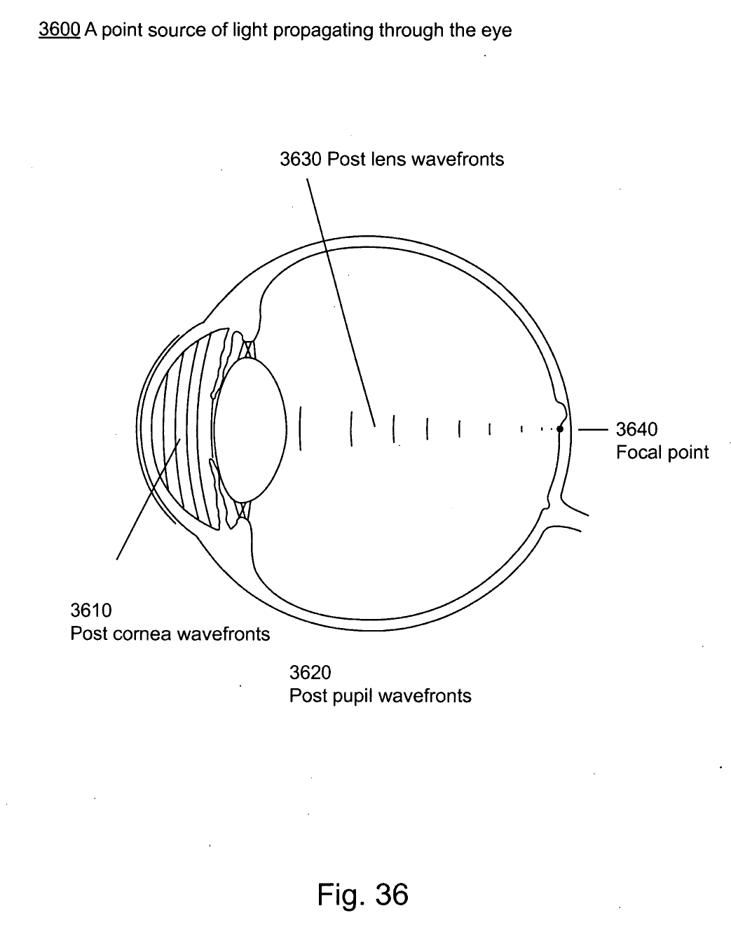

In general, though, the wavefront modification caused by the cornea 1410 is to change the wavefronts 3510 from expanding wavefronts to contracting wavefronts. As seen in more detail in FIG. 36, the modified wavefronts are post corneal wavefronts 3610. These wavefronts propagate through the aqueous humor 1420 until they encounter the (variable size and distance) iris 1425. Only those portions of the wavefronts 406 that intersect with the hole in the iris 1425 will pass through the pupil 1430 and enter the lens 1435. These wavefronts are the post pupil wavefronts 3620, which are a truncation of the post corneal wavefronts 3610. The lens 1435 will perform additional modifications to the wavefront 3620 to produce the post lens wavefronts 3630. The wavefront shape change performed by the lens 1435 is again a function of present shape of the variable shape lens 1435, the incoming post pupil wavefronts 3620 shape, and the specific optical frequency of the point source 3500. This function can also be simulated by computer programs. See U.S. patent application Ser. No. 11/341,091, cited above. In general, though, the wavefront modifications caused by the lens 1435 are to further reduce the radius of contraction and direction of propagation of the post corneal wavefronts 3610. These wavefronts 3610 propagate through the vitreous humor 1450 until they encounter the photosensitive retinal surface 1630.

Formally, the result is a probability distribution on the retina that is the point spread function of the image of the point source 3500 on the photosensitive retinal surface 1630. While the tail of these functions can extend quite far, normally only a sub-portion of the retina that contains a large majority (say 95%) of the probabilities is identified as the illuminated photosensitive retinal surface portion 1630 (for optical frequency of the point source 3500). If the distance from the point source 3500 to the eye 1300 at the optical frequency of point source 3500 is “in focus” at the photosensitive retinal surface 1630, then the portion of the probability of any point on the wavefront 2330 collapsing to a photon will be focused on a particular small portion of the photosensitive retinal surface 1630.

In the fovea 1465, the point spread function of the focused wavefront on a particular point on the photosensitive retinal surface 1630 will be determined by a combination of the quality of the cornea 1410 and the lens 1435 as optical elements, and the diffraction effects generated by the size of the pupil 1430. Within the region of the fovea, this point spread function can have the majority of its probability contained within an area not much larger than a single thin foveal cone, but the higher the retinal eccentricity the larger the point spread function will get, due mostly to the imperfect nature of the human eye's optical elements.

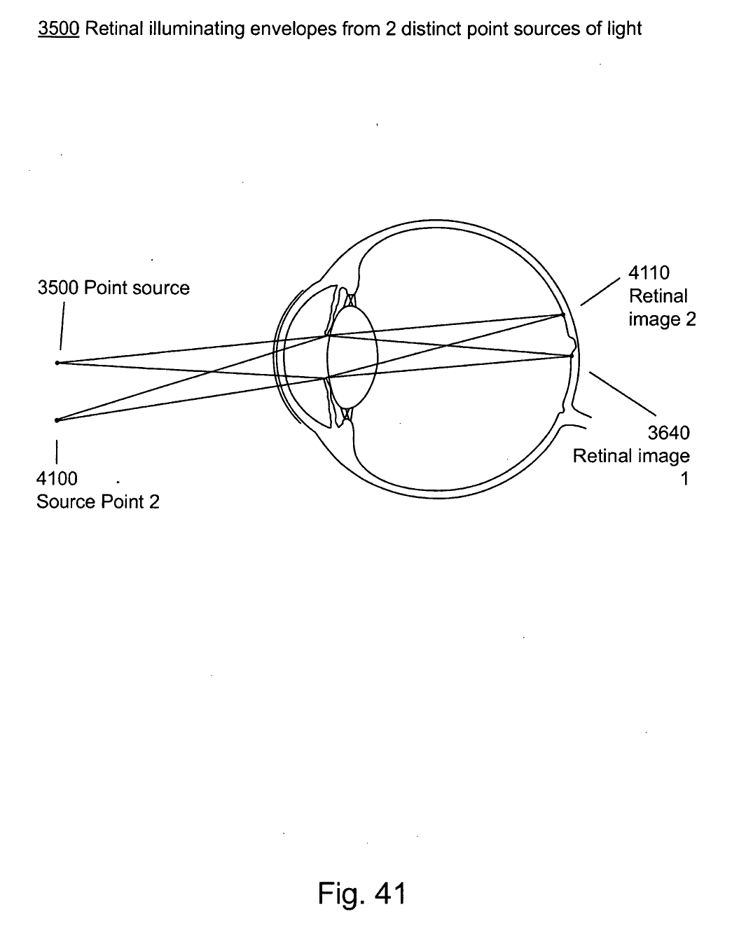

Considering together all the operations of FIG. 35, it can be seen that two different point sources of light, positioned at different angles in space, will concentrate different photon collapse probabilities to specific different illuminated photosensitive retinal surface portions 1630. As seen in FIG. 41, the first point source 3500 will be imaged on the retina at the retinal image point 3640 the second point source 4100 will be imaged on the retina at the retinal image point 4110. By adding more and more angularly separated points, one can see how the human eye 1300 produces an (inverted) projected two dimensional image of the three dimensional environment around it onto the (approximately spherical) photosensitive retinal surface 1630.

IV. Eye mounted Displays and Eye mounted Display Systems

IV.A. Optical Basis for Eye mounted Displays

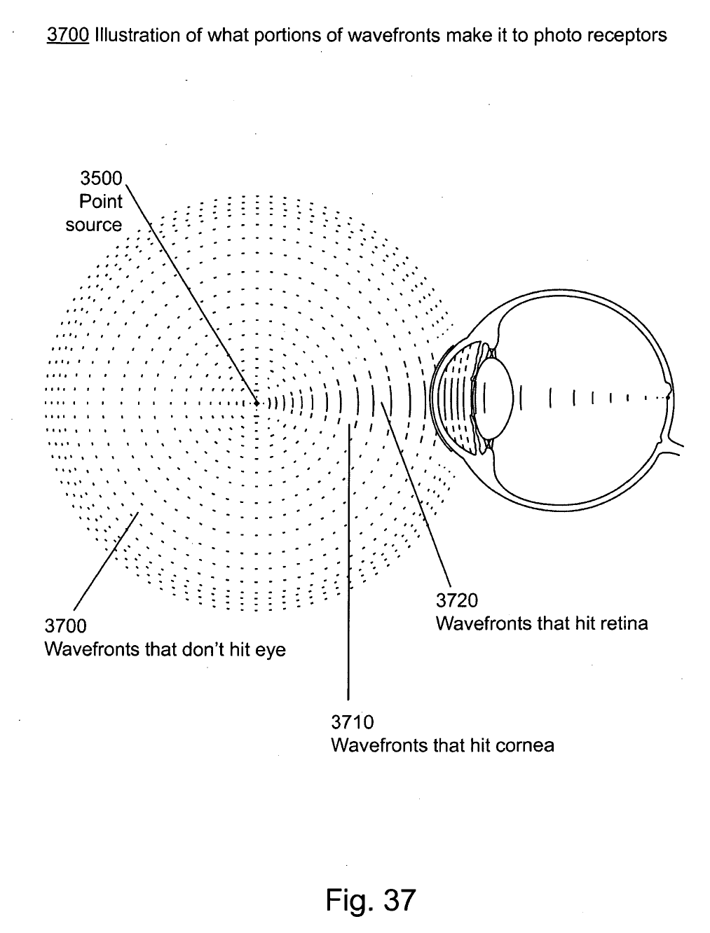

FIGS. 35 through 48 illustrate optical properties of the human eye that will be later used to enable the construction of eye mounted displays. FIG. 35 was described above. FIGS. 37 through 40 are modifications of FIG. 35. In FIG. 37, the portions of the wavefront 3510 that will not encounter the cornea 1410 are drawn as dotted lines 3700; the portions of the wavefront 3510 that will have their shape modified by the cornea to the wave front 3610 but will not encounter the pupil 1430 are drawn as dashed lines 3710; and the portions of the wavefronts 3510, 3610, 3620 and 3630 that will make it all the way to the photosensitive retinal surface 1630 and produce illumination on the photosensitive retinal surface portion 1630 are drawn as solid lines 3720.

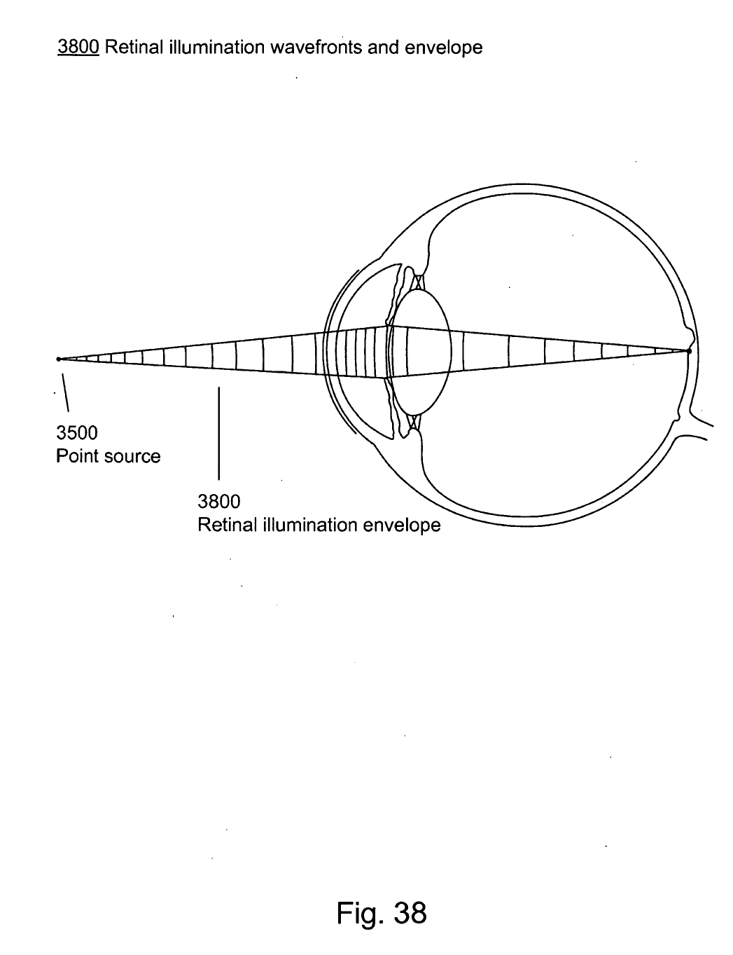

In FIG. 38, only the portions of the wavefront that will make it to the photosensitive retinal surface 645 (the solid portions of FIG. 37) and produce illumination on the photosensitive retinal surface portion 1630 are shown, along with a thicker line outline showing the (one dimensional cross section of the) envelope of this truncated wavefront. The fully three dimensional envelope is the optical aperture of a retinal area 3800, which looks like a three dimensional ellipsoidal cone with some bends in it. In FIG. 38, only the two dimensional cross section of this three dimensional object is shown. Both are identified as reference 3800.

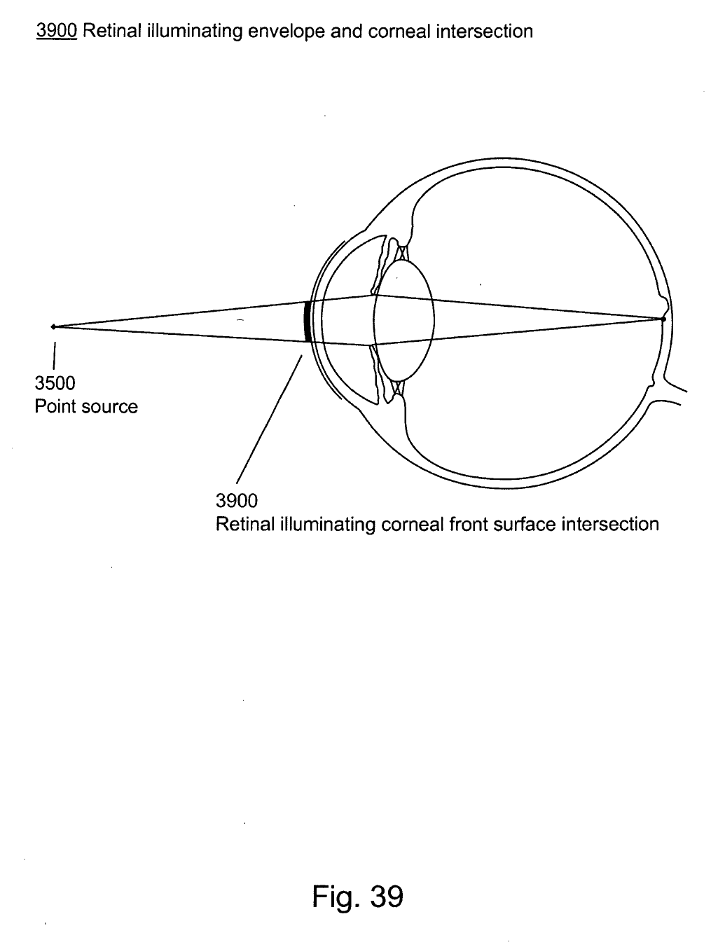

In FIG. 39, the portions of circular arcs representing the wavefront at different locations are no longer drawn, leaving only the (two dimensional cross-section) optical aperture of a retinal illumination envelope 3800 to show the boundaries of the wavefront that will make it to a retina area 1630 and produce illumination on the photosensitive retinal surface portion 1630. The portion of the front surface of the cornea 1410 that is within the optical aperture of the illuminated photosensitive retinal surface portion 1630 is indicated by drawing that portion of the front surface of the cornea 1410 as a thicker line 3900 than the rest of the front surface of the cornea 1410. The retinal illuminating corneal sub-surface 3900 is formed by the intersection of the optical aperture of the illuminated photosensitive retinal surface portion 1630 with the surface of the cornea 1410. The prefix “sub” in “corneal sub-surface” refers to the fact that this area is a subset of the full corneal surface and does not imply that this is necessarily below the corneal surface. In general, its edge shape resembles an ellipse cut out of the roughly parabolic surface of the cornea 1410. The two dimensional cross section of this sub-surface is reference 3900 in FIG. 39.

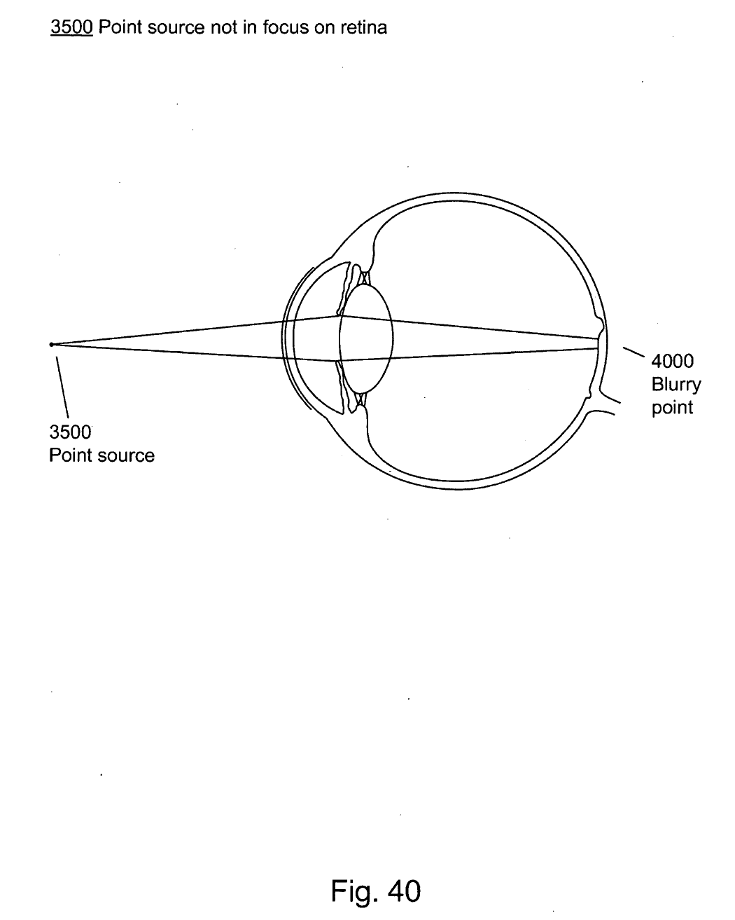

FIG. 40 is a modification of FIG. 39, in which the point source of light 3500 is not in focus on the surface of the photosensitive retinal surface 1630, producing a larger illuminated photosensitive retinal surface portion 1630 and thus a blurrier point spread function 4000 on the photosensitive retinal surface 1630. The size of the blur 4000 is exaggerated from typical cases so as to show up at the resolution of FIG. 40.

FIG. 41 is a modification of FIG. 39, in which a second point source of light 4100 and the envelope that is the portion of its emitted wavefront that is destine to make it to the surface of the retina at location 4110 are shown together with the first point source 3500 and its associated envelope.

The preceding Figures illustrate in two dimensions an important aspect of EMDs. Conventional displays generate wavefronts of light that cover at least the entire cornea and nearly always much more. However, it has been shown that to illuminate a particular small portion of the photosensitive retinal surface 1630, one does not need to generate relatively large area wavefronts of light, as is done in conventional displays, where the wavefront area has been at a minimum the size of the eye 1300, or much larger. Instead, it has been shown here that for a display positioned outside the cornea 1410, one need only generate wavefronts that cover the respective retinal illuminating corneal sub-surface, whose area is considerably smaller than the entire corneal 1410 area. That is, the pupil 1430 acts as an aperture. The projection of a particular photosensitive retinal surface portion 2860 through the pupil 1430 onto the cornea 1410 defines (at least to first order) an area on the cornea that will be referred to as the retinal illuminating corneal sub-surface, or simply the corneal aperture, for that particular portion 1630 of the retina. This effectively is the projection of the optical aperture onto the cornea 1410. Wavefront portions (of the correct wavefront shape) that fall within the corneal aperture will propagate on to the corresponding photosensitive retinal surface portion 1630. Wavefront portions that fall outside of the corneal aperture will be blocked, for example by opaque portions of the iris 1425.

Note that any wavefront that is smaller than but still within this retinal illuminating corneal sub-surface (and with the correct wavefront shape) will also illuminate the same photosensitive retinal surface portion 1630. This situation will be referred to as an underfilled corneal aperture. Note that the pupil will also be underfilled in this case. One drawback of wavefront portions that do not fill the corneal sub-surface is that the diffraction effects are larger, but outside the fovea region this is rarely the resolution limiting effect.

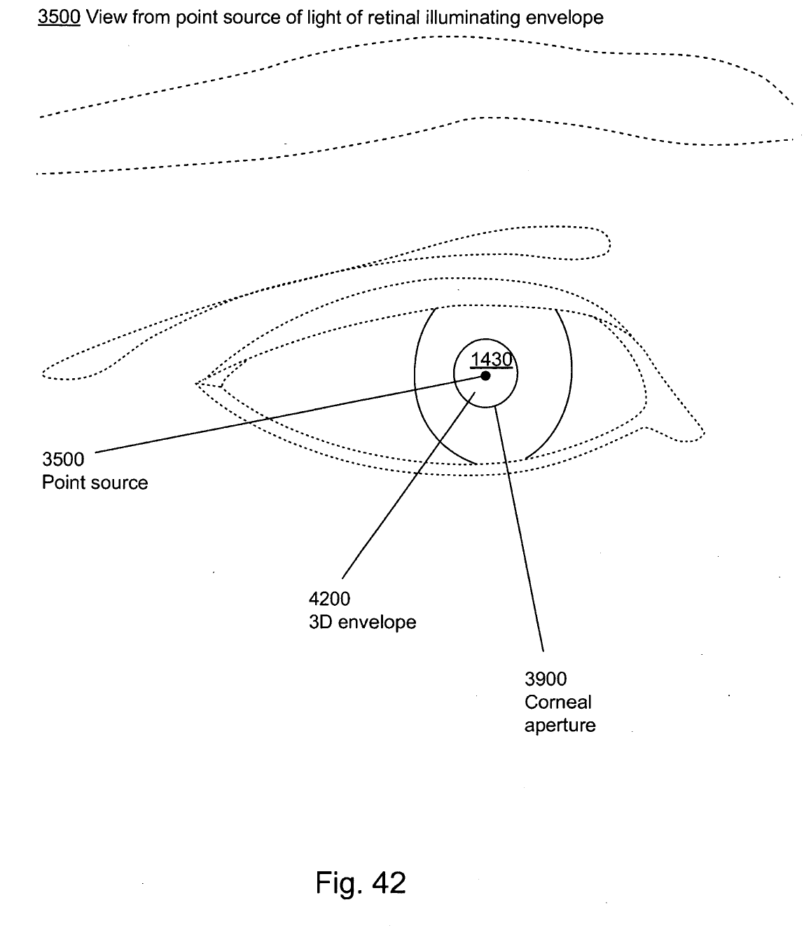

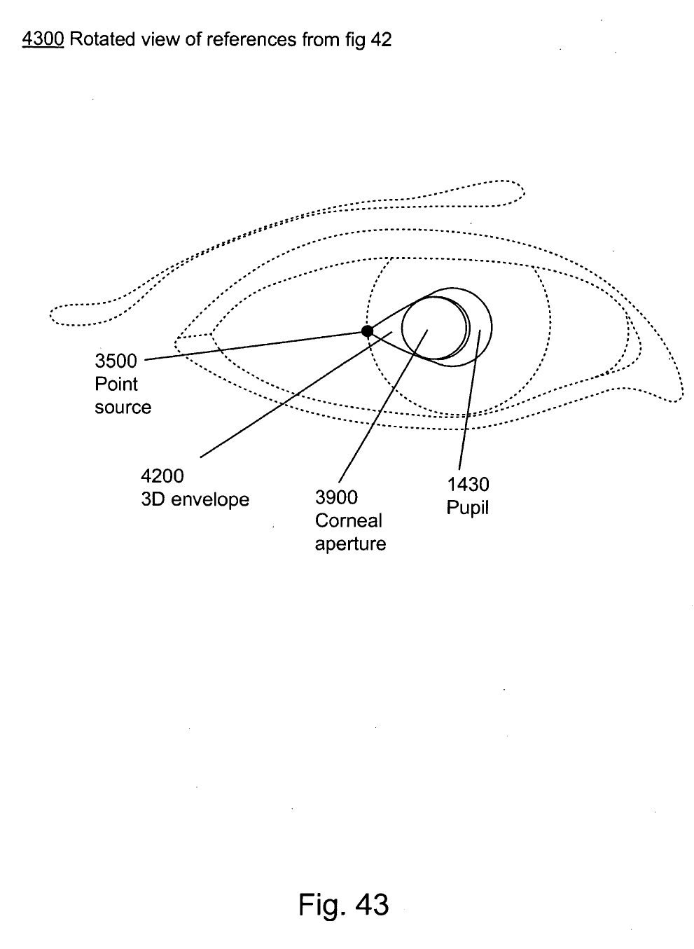

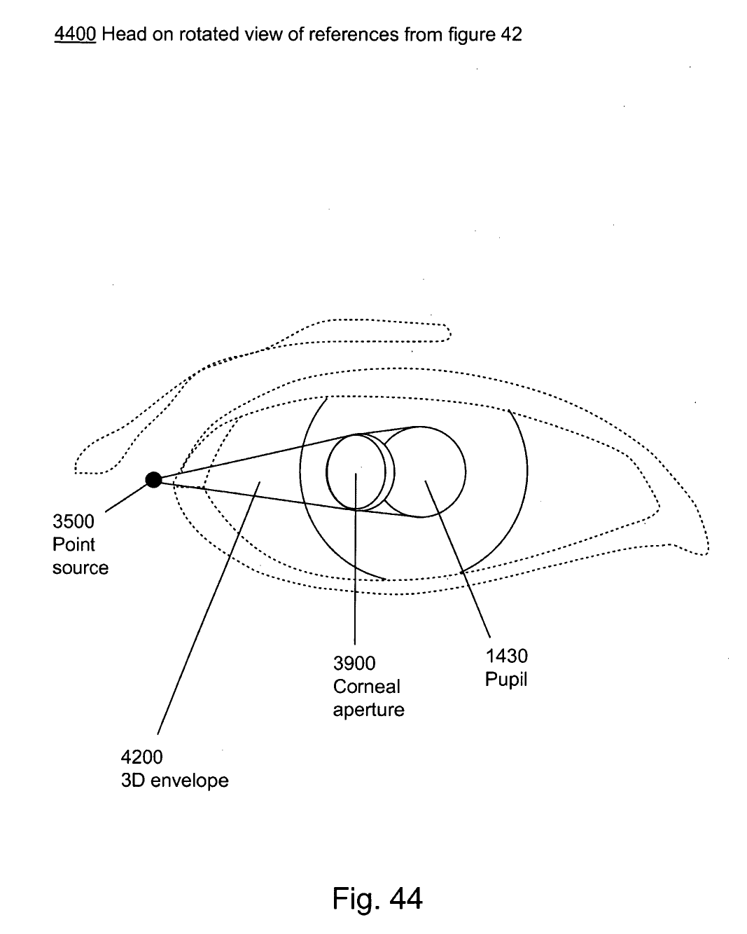

FIGS. 42 through 44 will move from the two dimensional cross section model of the eye to a full three dimensional illustration of the points made in the earlier Figures. FIGS. 42 through 44 are perspective drawings that show the same situation as FIG. 39, but seen from different points of view. In these Figures, the eye is the right eye and the point source 3500 is assumed to be off to the right of the person. Features of the face are shown in order to better show the changing three dimensional perspectives. In FIG. 42, the point of view is from the point source 3500 looking straight at the pupil 1430.

In FIG. 43, the point of view is half way between the point of view of FIG. 42 and a point of view that is head-on to the face. We now see in three dimensions the corneal aperture 3900 from this different angle.

FIG. 44 is from a point of view now looking head-on to the face. We now see the corneal aperture 3900 from more fully as the intersection of a cone with the cornea 1410 at an even larger angle in three dimensions.

Using a three dimensional model of the optics of (truncated) wavefronts of light from a point source of light in the external environment propagating through the optical elements of the eye, it has been shown that only a truncated wavefront covering only a small portion of the cornea 3900 will be the only external wavefronts that will eventually reach the small portion of the photosensitive retinal surface 1630 that images that point source (for reasonably focused conditions of the eye's optics relative to the external point source).

In turn, this proves that an eye mounted display need only generate wavefronts from a particular direction of propagation whose envelopes intersect a subset of the corneal aperture 3900 for each small region on the photosensitive retinal surface 1630 that the display wishes to form a pixel or similar object on, and still have the ability to form arbitrary images on the photosensitive retinal surface 1630. Using these smaller corneal regions for display results in many advantages. As will be described in more detail later, miniature display devices that are sub-parts of an EMD can be made considerably simpler and smaller than previous art displays that had to generate a significant portion of the entire image to be presented to the user's eye. As one example, they in fact can be made so small as to fit within a modified contact lens. In other examples, the display can be placed within the eye itself. Another advantage is a significant reduction in the amount of light that must be generated to form reasonably bright photopic images to a human 110 viewer. Many other advantages are described elsewhere in this document.

For a given eye, with a given radius pupil, and given lens accommodation, for a given receptive field center (the desired illuminated photosensitive retinal surface portion 1630), there exists a unique corneal aperture 3900 that will “address” this receptive field center. The job of an eye mounted display external to the cornea 1410 is to generate the properly shaped optical wavefronts and entry regions of the cornea 1410 to produce regions of photosensitive retinal surface 1630 illumination whose point spread functions are close in size to the size of the receptive field centers that are in the location of the photosensitive retinal surface 1630 (or smaller in some cases).

It should be noted that in nature, in the high resolution foveal region, it is not possible to produce spots of retinal illumination that enter only a single cone. Point sources of light outside the eye 1300 will generate spots of illumination that at a minimum will also enter the first layer of cones surrounding any specific cone, though at reduced brightness. It should also be noted that such small spots as were just described correspond to 20/10 vision, which only a small portion of the population have. The more typical resolution of the general population is in the range of 20/18 to 20/30. In terms of eye mounted displays, this means that the resolution limit for most of the population can be reached by displays whose smallest point spread functions generatable could be as large as four foveal cones (assuming the smallest cones of persons with 20/10 vision—most people have cones that are 2× or more larger at their smallest, or have equitant resolution limits in their eye's optical path). This larger limit will become important when discussing manufacturability of embodiments of specific designs of eye mounted displays.

The same analysis can be performed for the larger receptive fields of rods; but because in most ways such an analysis would be a sub-set of that performed for cones (except for dealing with significantly lower levels of light), and from the teachings given here, is easily derived by one skilled in the art, an analysis of the equitant for rods need not be expressly presented here.

The same analysis can be performed for eye mounted displays that produce optical wavefronts at locations within the human eye's optical path other than above the cornea. From the teachings given here, these alternative displacements can be derived by one skilled in the art. Accordingly, an analysis for all the other possible locations of light emission will not be presented here.

IV.B A New Approach for Display Technologies

Nearly all previous existing display technologies emulate optical reality at a level some distance away from the cornea. They generate spherical wavefronts with diameters at observation covering anywhere from several thousand feet (in a sports stadium display), to a dozen feet (home HDTV screen), to less than an inch, for the special case of instruments with a narrow entrance pupil for the observer's eye (e.g. a microscope or telescope eyepiece, and most head mounted displays). The vast majority of computer and television displays in use today are within the tight range of a foot to a few feet wide. At normal viewing distances, the radii of the spherical light wavefronts generated are approximately on the same order of size.

In contrast to existing display technologies, the display technology described below reduces the light emitted for a given pixel (or equitant object) to the retinal illuminating corneal sub-surface 3900, or a workable subset of this area (i.e., an underfilled corneal aperture). In theory, a display device generating a wavefront that covers the corneal aperture 3900 for every retinal center-surround receptive field 1405 center area in the eye 1300, would be able to match the eye's perception of almost any physical world scene. The device would be able to synthesize nearly any image at the same resolution that the eye can perceive.

An eye mounted display constructed to generate a number of wavefronts directed to different corneal apertures 3900, whose point spread function on the photosensitive retinal surface 1630 is at the approximate size, density, and shape as the retinal receptive field centers in the local vicinity of the addressed portion of the retina, but perhaps not exactly matched to the individual retinal receptive field centers of a specific eye, can generate a high quality and large field of view display. In fact, because the display is not locked to any specific retinal optical reception areas, a number of real-time corrections (warping, etc.) to the image can match other parameters (such as accommodation, or slip in coupling) changing. Also, consider that due to drifts, in the real world point sources of light are rarely imaged by a single cone. Instead a slightly blurred retinal image is spread across and sensed by two or more retinal center-surround receptive fields 1405.

Consider a display device that generates, for a given desired distribution of spot sizes and locations on the photosensitive retinal surface 1630, the corresponding full corneal apertures 3900. Then if one draws the outlines for all these apertures, they would overlap to greater or lesser extents a large number of other nearby apertures and there would be no way to partition the apertures into disjoint groups. In some embodiments, this is not a problem, and the appropriate radius expanding wavefronts of light from the appropriate directions are generated by and EMD truncated into all the appropriate corneal apertures 3900.

However, for other embodiments, it is more convenient if the corneal apertures 3900 generated can be partitioned into different non-overlapping groups. This is not possible if one wishes to fill each entire aperture. However, it is possible if one accepts a little more resolution loss due to diffraction. If in place of the full area corneal apertures 3900, instead (for example) a quarter area aperture of each corneal aperture 3900 is generated, such disjoint partitioning is possible. In other words, the pupil is underfilled. In this case, the less than full corneal aperture will be referred to as a corneal subaperture or an underfilled corneal aperture.

To see how a disjoint partitioning is possible, first note that the corneal quarter-aperture (i.e., a subaperture that is a quarter of the area of the full aperture) can be placed anywhere within the full aperture 3900 and still generate a spot of light at the same position on the photosensitive retinal surface 645. Next, note that if the position of the quarter-apertures can be biased toward one side of the corresponding corneal full-aperture 3900 in the direction of a local center point, then when all the quarter-apertures are drawn on the cornea, they can form disjoint sets around each local “center” point.

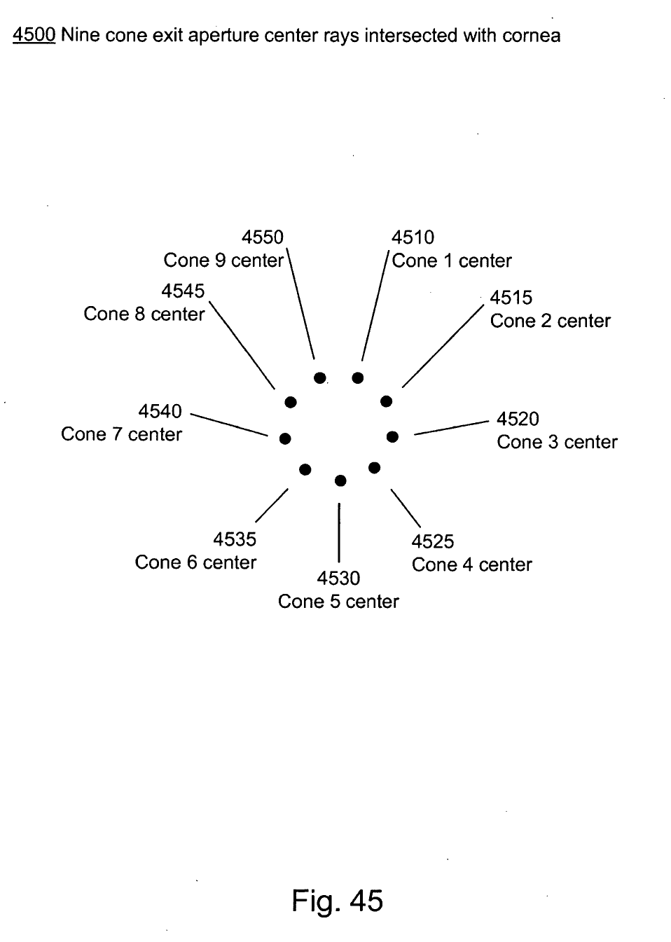

As a vastly simplified example to illustrate the point of the last paragraph, consider a retina that only has nine cones. FIG. 45, reference 4500, shows a diagram of the cornea for this simplified eye. Element 4505 is the outer extent of the cornea, as seen by orthographic projection down the optical axis of the cornea. Each of the nine cones has a corresponding corneal aperture, which are represented by the references 4510 through 4550, respectively. The positions of 4510 through 4550 shown correspond to the center of each corneal aperture. A 3 mm virtual entrance pupil was used in this computation. The cones are at a visual angle of 26.6°, and equally spaced around 360° with 40° between each.

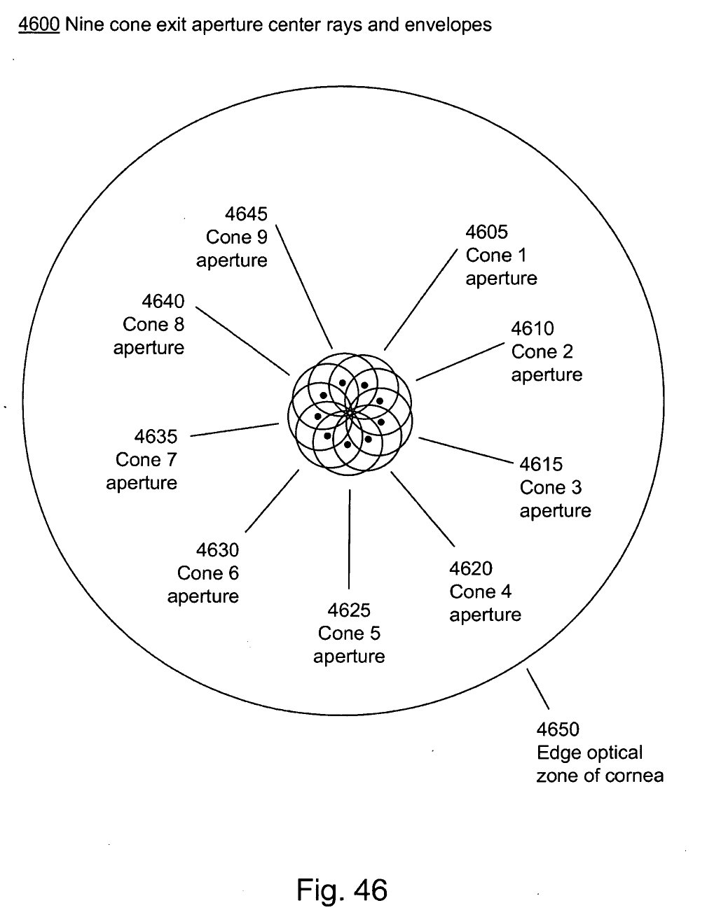

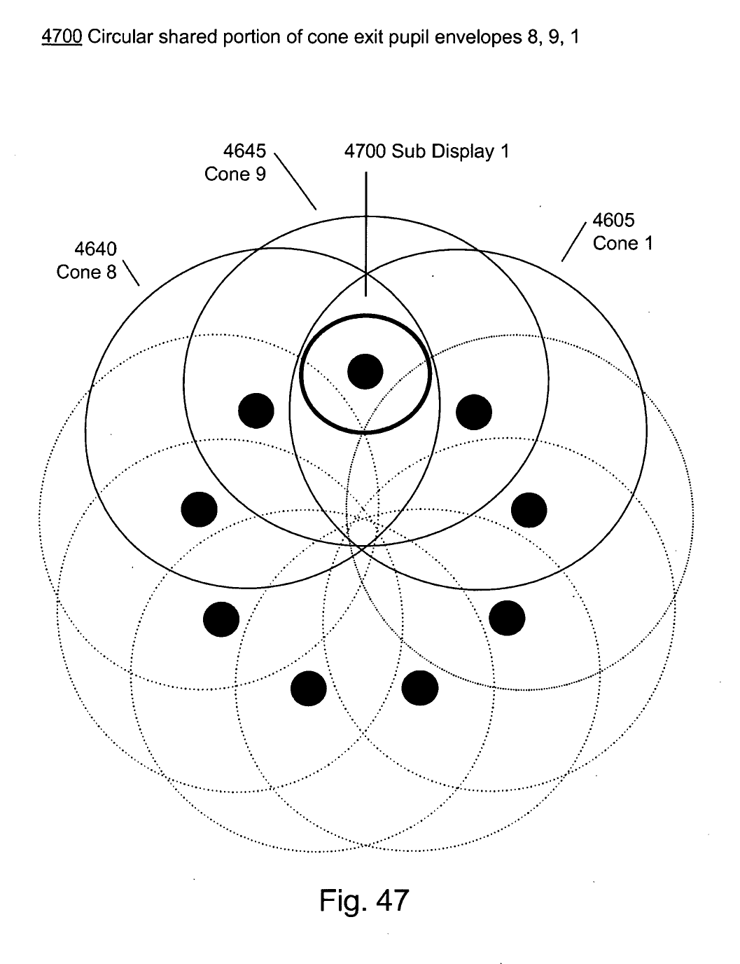

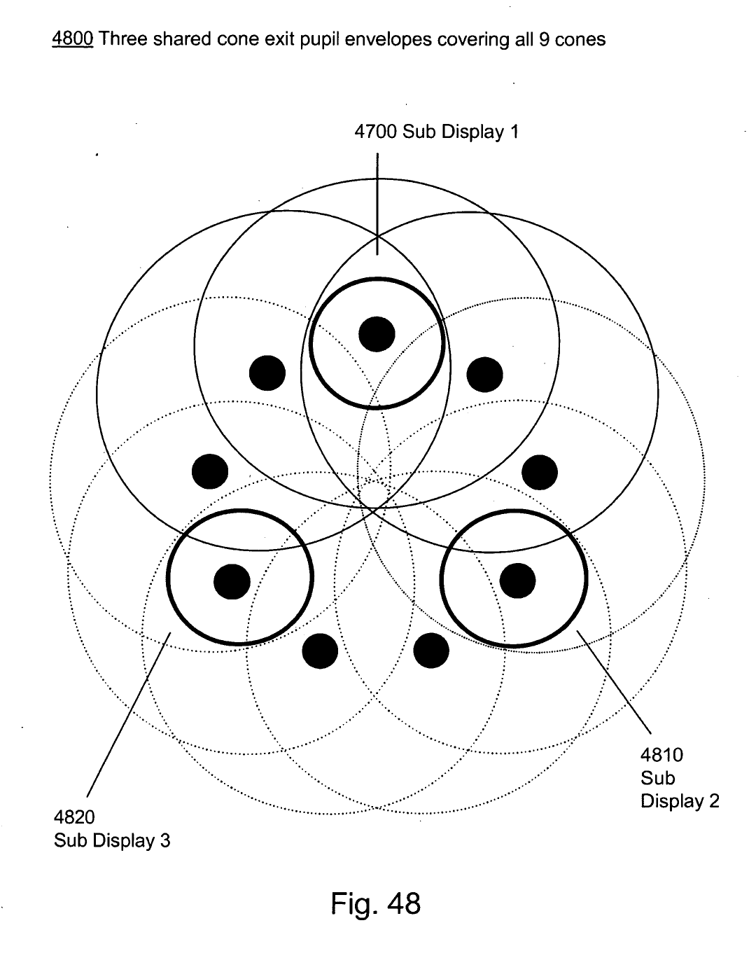

In FIG. 46, the edge of each corneal aperture has been added as the references 4605 through 4645, respectively. In other words, the corneal aperture for cone 1 is defined by the boundary 4605, which is centered at 4510. Note that even in this simplified example, the corneal apertures significantly overlap. However, as shown in FIG. 47, if one uses a display extent of less than the full aperture size, one sub-display 4700 can be used to address three separate cones whose corneal apertures are shown in solid lines: 4605, 4610, and 4615. The other six cones are shown in dashed lines for context. Note that even though the sub-display 4700 covers some of the corneal aperture of these other cones, no light will fall on any of these so long as the sub-display 4700 only generates wavefronts of light that focus on one of the targeted three cones. In FIG. 48, it is shown how three sub-displays 4700, 4810, and 4820 can address all nine cones.

Clearly we want a display that can address more than nine cones. But the optical properties for any number of cones operate in the same manner. Given a contiguous region of the retina for which one wants to generate a display, one can take the intersections of all the optical apertures at the retinal surface from all the cones in the region. So long as the region is convex, the same result can be achieved by taking the intersection for the cones on the boundary edge of the region. Furthermore, for the double truncated circular pie wedge (which is an advantageous shape to have a given sub-display display to), taking the intersection of the four cones at the four corners of the region can give the correct result. Given some quantization on the incremental size of a sub-display region by the receptor field center sizes, and any other desired constraints, exhaustive computer simulations of all possible numbers of, positions of, and sizes of, sub-display can be simulated, allowing one to optimize the design of sub-displays of an EMD to any desired constraints (so long as a solution exists).

One such constraint could be that the addressed portions of the retina by each sub-display slightly overlap all its neighbors. The overlaps can be “feathered” together, employing any of several techniques that have been used in the past with (much larger!) multiple projector displays.

In one embodiment, these sub-displays would be femto displays.

It is important to note that diffraction effects of employing a quarter (or other partial) corneal aperture verses a full area corneal aperture correspond to the diffraction limits of approximately 20/20 vision vs. 20/10 vision. As most people have closer to 20/20 vision, and relatively few are close to 20/10, the quarter area compromise will cause only a minor reduction in resolution over the best that they can perceive. This is an acceptable trade-off for many embodiments of EMDs.

We have now described at a high level the physical effects used to build many different embodiments of eye mounted displays. There are many embodiments for devices to produce multiple specified radius expanding spherical wavefronts of light of a specific frequency (or frequency spectra), propagating in a specific direction, and entering the corneal surface within a specific truncated outline (i.e., partial corneal aperture). One class of such examples is embodiments of femto displays as previously defined. This particular class of sub-display embodiments will later be used to describe more details of a complete EMD and EMDS 105. From this description it can be seen how such devices can be built with other embodiments of the sub-displays, or possibly using just one display.

IV.C Sub-Displays

The function of a sub-display is to generate the appropriate optical wavefronts for the corresponding retinal region. Typically, the sub-display will be able to generate many approximately spherical wavefronts, at slightly different directions of propagation, in one embodiment, all truncated by approximately the same outline within and smaller in area than the full area corneal aperture for the directions of propagation. In the case of spherical wavefronts, the radius of the spherical wavefronts produced could be controlled per wavefront or, in a simpler embodiment; they could all have the same pre-set radius. Such fixed radii would produce images that are in focus only for one focus distance of the crystalline lens (but which is also a fixed parameter for older people with presbyopia). A slight difference between the fixed radii of the sub-displays allows the surface of focus to be flat, cylindrical, spherical, etc. The collection of wavefronts produced from a particular direction over a time frame (for example, the time of one frame of display) has a statistically controllable intensity, as well as a statistically controllable mix of optical frequencies (color). If the sub-display embodiment is not much larger than the outline within the area where wavefronts of light are produced, this could allow a significant amount of normal external physical world produced light to pass through the cornea normally, thus producing a “see-through” display. In addition, if partially silvered front surface mirrors are used for the final optical element of the sub-display (as described later), then external light can come in throughout the EMD, just at a reduced intensity (which is desirable for limited output intensity EMDs).

So far the discussion has concentrated on embodiments of EMDs that produce light wavefronts outside the cornea, with an air gap between the EMD and the cornea, or an air gap between the EMD and a corrective lens that may be coupled to the cornea by tear fluid. This was done to make explicit the direct match between wavefronts of light in the physical world and the wavefronts of light produced by the new display technology. However, the definition of EMDs includes those in which the display can be placed on and/or in multiple locations within the eye. For these cases, the same sort of backward examination of modified light wavefronts from where the display elements are placed, on and/or within the eye, to the world outside, will describe the modified wavefronts of light that the display must produce to match how light wavefronts from the physical world would be modified at that point(s) on and/or within the eye. One simple example is an EMD in which the EMD is placed in a modified contact lens, with an air gap below the display and the posterior surface of the corrective contact lens. Now the matching task is to match the wavefronts that the contact lens, rather than the cornea, would normally “see” from the outside physical world. In other embodiments of EMDs placed further within the eye, the principle of “matching” wavefronts would be the same, but the wavefronts produced by the display can be quite different.

The description of all the parameters to be taken into account in order to produce each wavefront from the EMD that nearly exactly emulates a specified point source in the outside physical world can be fairly straight forward. In embodiments that only emulate fixed distances of focus, the position of the eye's lens will be known due to eye tracker 125 and/or head tracker 120. With near cone accuracy tracking of the orientation of the cornea relative to the head (or some other known coordinate frame) by the combination of eye-tracking and head tracking devices, the small target area of the retina that each wavefront (truncated to or within the appropriate outline) will be know, and can be used to determine what intensities and colors should be displayed by each separate wavefront generator (i.e., each sub-display).

IV.D Embodiments of Contact Lens Mounted Displays

One sub-class of eye mounted displays is cornea mounted displays (CMDs). One sub-class of cornea mounted displays is contact lens mounted displays (CLMDs). One sub-class of contact lens mounted displays (CLMDs) is modern sclera contact lens mounted displays (SCLMD). The discussion below will use a particular embodiment of SCLMDs as a concrete example of a complete instance of an EMD, but will also discuss more general CLMD issues.

When a contact lens is worn, most of the light bending now occurs in the contact lens, and now very little light bending occurs in the cornea. The proper wavefronts for the sub-displays to generate are now those expected at the surface of the contact lens, not at the surface of the cornea. This assumes that the contact lens is coupled to the cornea by tear fluid, and the sub-display has an air gap between its posterior and the anterior of the optical zone of contact lens. In some cases the optical zone of the contact lens is smaller than the field of view of the eye. In this case a vignetting of the eye's view will occur. This is a property of the contact lens. A contact lens with a suitably large optical zone will not have this limitation.

A relativity new type of contact lens is a hybrid of a soft large sclera lens for contact with the eye, and a small hard lens in the optical zone for vision correction. The sclera lens has a large amount of tear fluid beneath it. This reduces the physical contact of the appliance with the sensitive cornea and also allows the natural nutrients and waste products to be carried as normal by the tear fluid, which has a means for ingress and egress from the sclera contact lens. Because the sclera lens is large, it is possible for it to be quite thick (1.2 mm or more) in the center of the contact lens. Because the change in thickness is gradual, the only part of the eye that might notice the extra bulge, the eye lid, usually is not bothered by this. In the thick center of the soft sclera lens a cylindrical hole of soft lens material is removed, and a small hard contact lens is placed in. Because with the tear fluid there is little change of index of refraction from the bottom of the hard lens past through the cornea, the primary optical bending take place at the air-hard lens boundary on the front of the hybrid contact lens. Because the corneal lens effectively does not contribute to the optical function, any astigmatism (due to toroidal deformations of the eye extending to the cornea) can be effectively eliminated. The large sclera lens also does not move or rotate much, unlike more traditional contact lenses that can move up and down by their entire diameter during eye blinks to allow an exchange of tear layer to take place.

One embodiment of a CLMD is as a modified form of a modified sclera contact lens (SCLMD). The idea is to place a display device (or set of sub-display devices) in the cylindrical hole where the hard contact lens had been, and optionally also place a thinner hard contact lens under the display if opthalmological correction is needed. It is usually important that there is an air interface between the bottom of the display device and the top of the hard contact lens (if present) for proper functioning of the hard lens.

In one approach, as described above, the display task can be sub-divided to a number of sub-displays, each emitting a number of spherical wavefronts into their own particular partial corneal aperture. Many practical solutions to the multiple non-overlapping projector placement problem results in approximately 40 to 80 sub-displays using the same number of disjoint partial corneal apertures on the surface of the cornea or contact lens. These input regions will only cover about one fourth of the total surface area of the cornea or contact lens (or less), so the resulting optical system can have high quality see-through vision of the natural world. For the present purposes, for now let us assume that the embodiments of the sub-displays are as femto projectors, and we will call the individual wavefront generating regions pixels. Now turn to the details of implementing such femto projectors.

First a word about the pixels. In many embodiments it is more efficient to use hexagonal rather than rectangular shaped pixels, but many other shapes are possible. Also, like most direct view displays, rather than build multi-color pixels, it is easier to assign each pixel to a single color primary. However, unlike most direct view displays, the color primaries do not have to be equally represented or repeated. If three color primaries are used, targeting the optimal sensing frequency of the long, medium, and short wavelength cones, the three primaries would be just a variation of red, green, and blue. However, because the blue cones represent a ninth or less of the cones in the retina (and none in the central most portion of the fovea), only one out of every nine “pixels” could be blue. Measurements of the ratio of red to green cones in the human eye have varied from 2:1 to 1:2. Thus, in one embodiment, the remaining eight ninths of the pixels are equally split between red and green cones (four out of nine each).

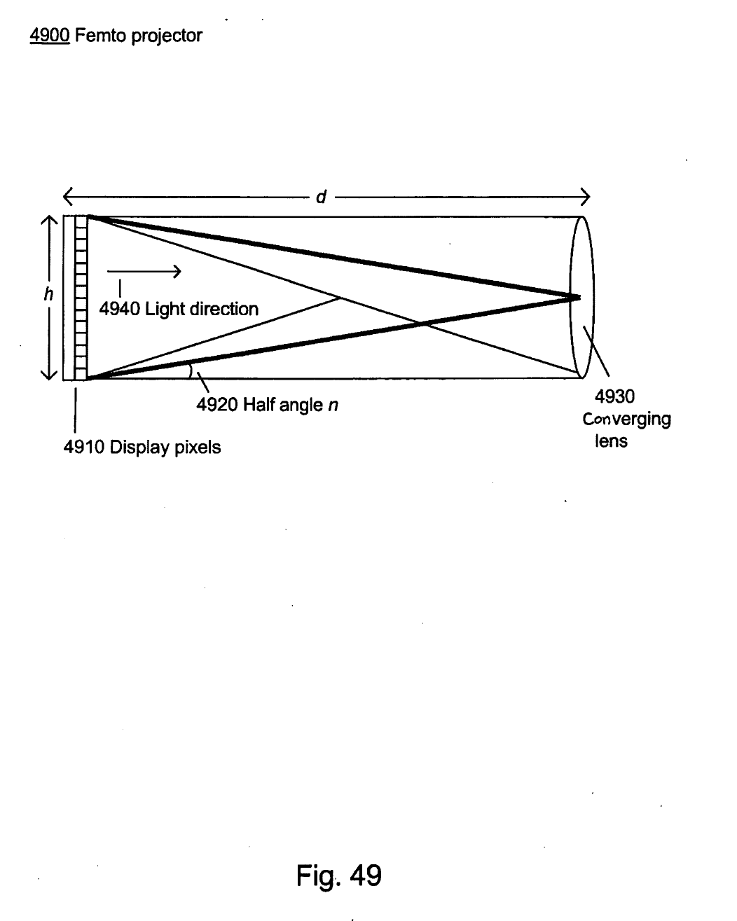

The abstract optical path for a femto projector can be simple. Place a 128×128 (or so) image plane of pixels far enough away from a lens to cause the angle of each pixel relative to the lens to correspond to the input wavefront angles desired over a particular patch of cones. Let this angle be 2*n. The lens is a simple converging lens (positive optical power). It causes spherical wavefronts whose radius is only a few millimeters to appear to have a radius of (say) six feet. A simplified two dimensional vertical cross section of such a femto display 4900 is shown in FIG. 49, with the light direction indicated by reference 4940. The display source (array of pixels) is reference 4910. The half-angle 4920 that a pixel makes with the lens is n. Let the distance from these display pixels (multiple point emitters of photons within the pixel active region) to the converging lens 4930 be d. Let the height of the display pixels be h. For this femto projector to produce light wavefronts subtending a half-angle of n the relationship between h and d is:

$$d = \frac{h}{2 ⋆ tan ( n )} \qquad ( 1 )$$

In many implementations, d will be fixed, as will be n by definition for a given sub-region of the retina to be addressed, so for a particular femto-projector h will then be fixed. As an example, a femto display with height h equal to 0.5 mm high and a desired spread angle n equal to 10° yields a separation distance d of 2.9 mm.

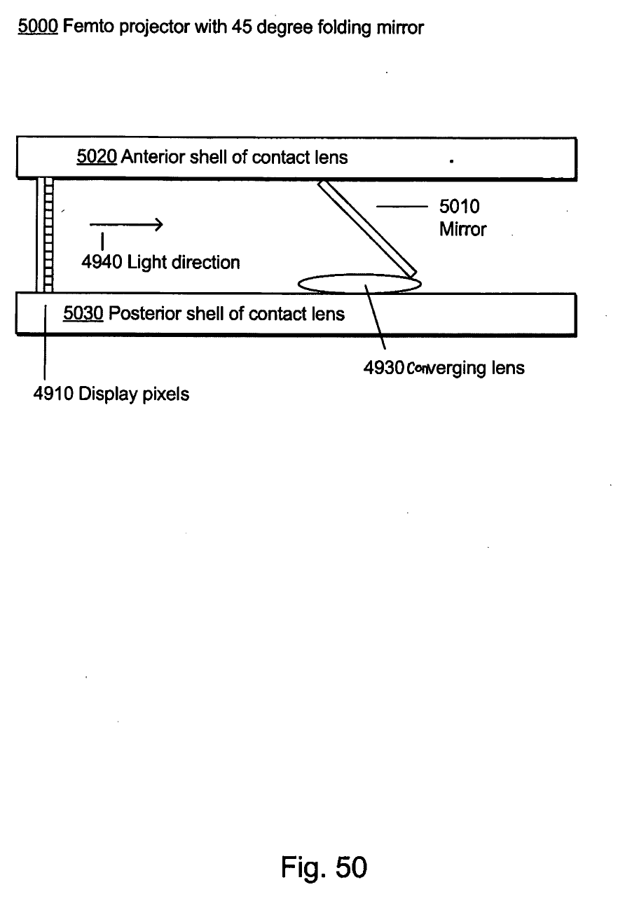

Unfortunately, in the allotted space for the set of femto-displays, on the order of a millimeter thick, there is not enough distance to place the pixel displays directly in line with their converging lens. So we fold the optics. As shown in FIG. 50, a two dimensional vertical cross section of a different femto display 5000, a 45° mirror 5010 allows one to use lateral space on the display body to optically back up the pixel displays far enough from their corresponding lenses to obtain the desired geometry. This figure shows the anterior 5020 and posterior 5030 outsides of the contact lens capsule.

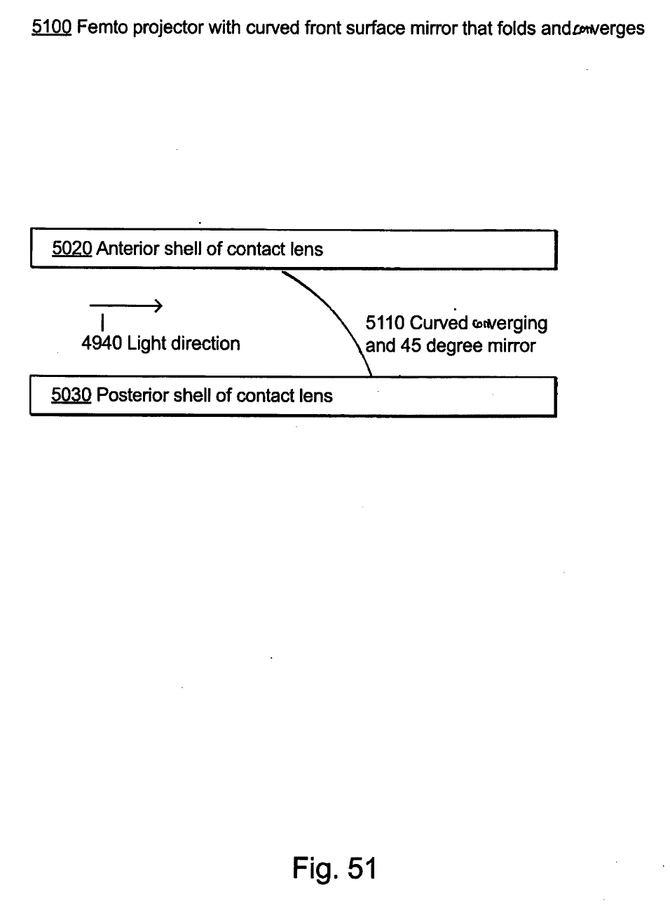

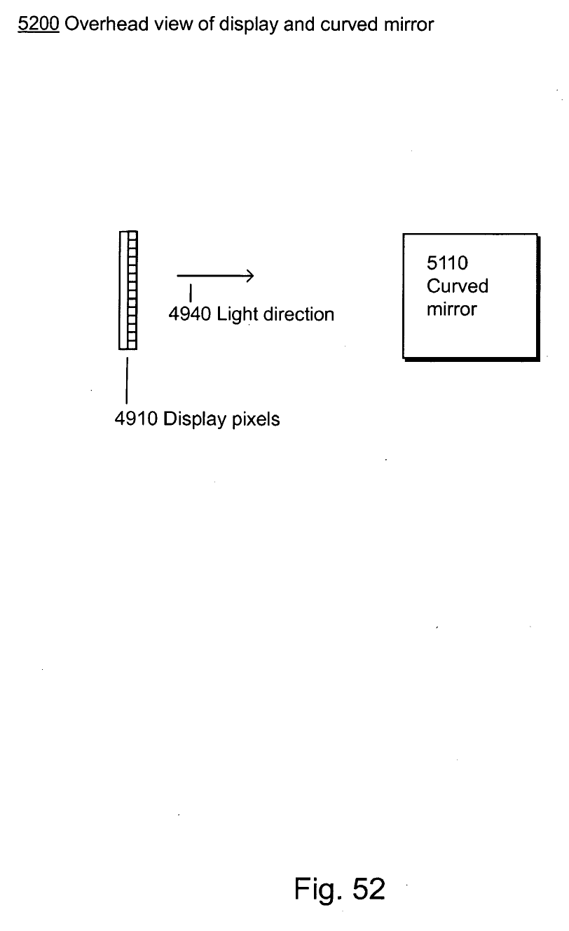

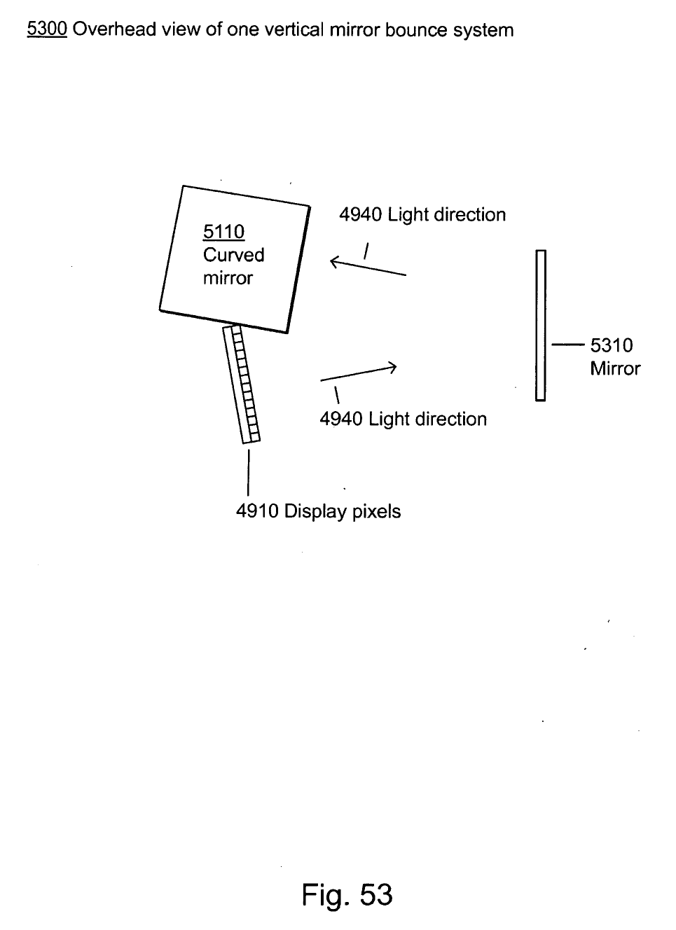

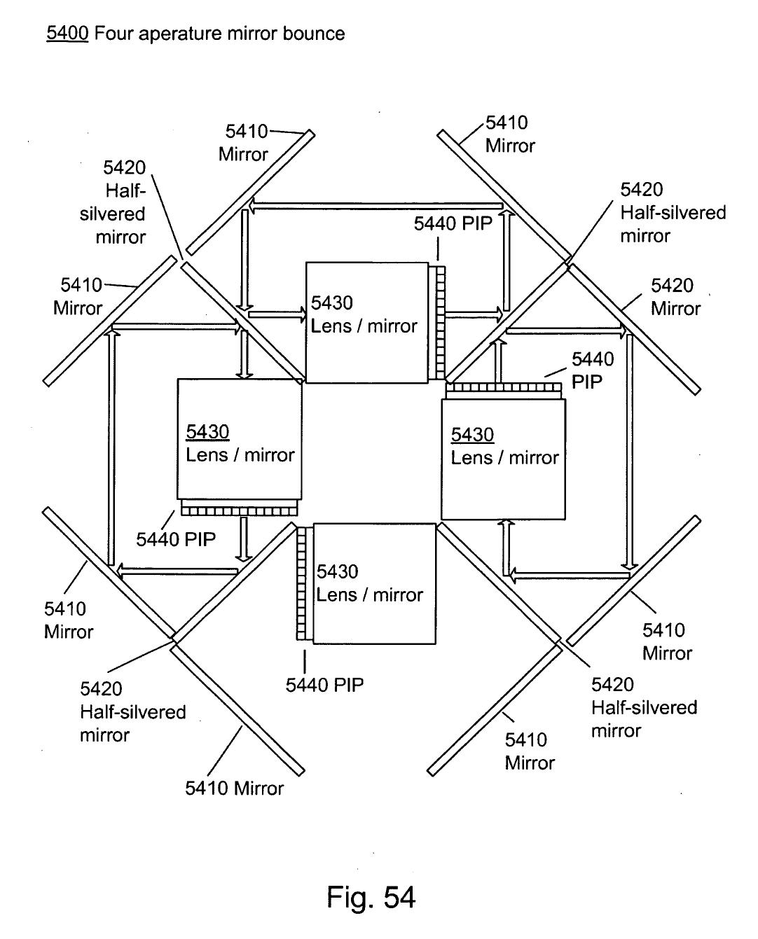

FIG. 50 shows the folded light path for one femto display. In a typical eye mounted display, there may be 40-80 femto-displays, each with its own folded light path. There are many different ways to let these different light paths cross through each other, and pack properly into the desired volume. As shown in FIG. 51, it is also possible to combine the lens and 45° turning mirror into one achromatic optical element 5110 by reshaping the 45° flat mirror into a curved optical mirror that performs both functions, creating a femto display 5100. FIG. 52 is an overhead view of the femto projector shown in FIG. 51. FIG. 53 shows an overhead view of another femto display created by folding the femto-display of FIGS. 51 and 52 in any of several different ways using an additional folding mirror 5310. FIG. 54 shows how four femto-displays can form a four times larger area synthetic apature, making use of several mirrors 5410, half-silvered mirrors 5420, 45 degree mirror and converging lens 5430, and pixel display 5440.

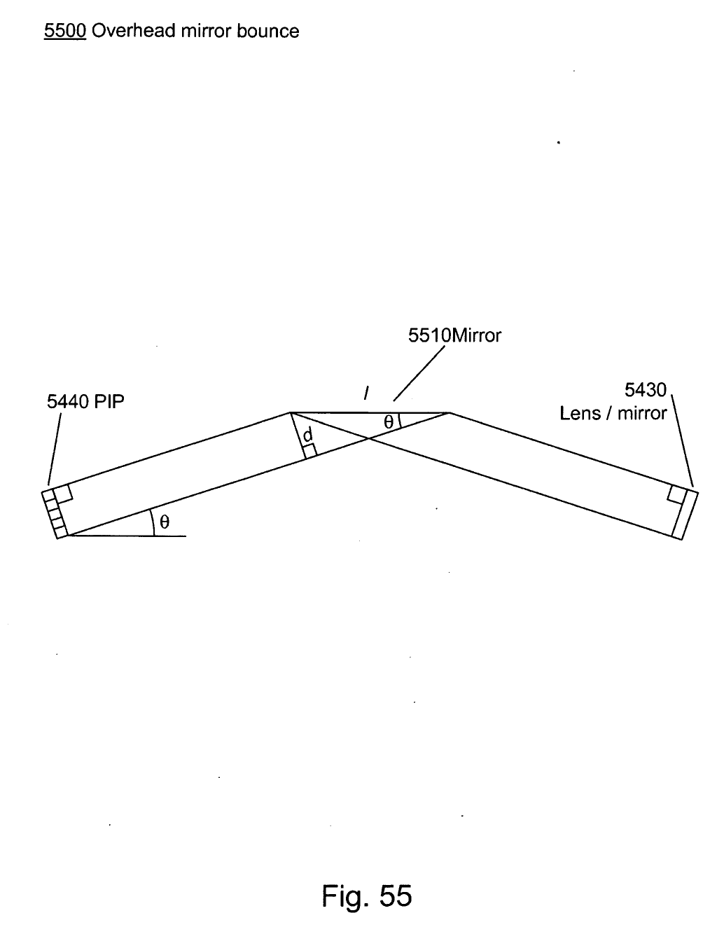

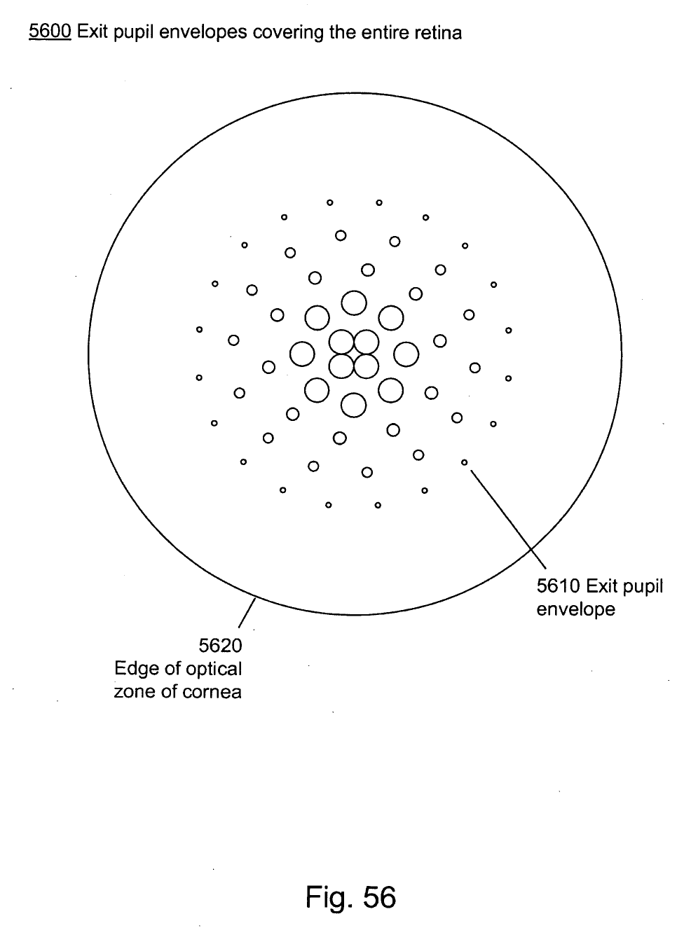

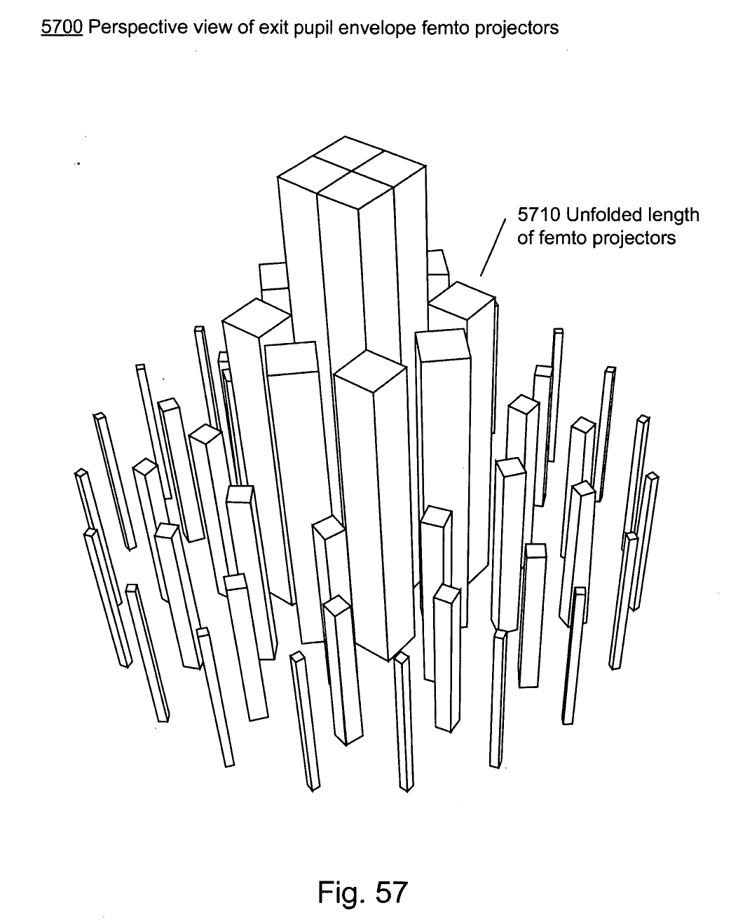

FIG. 55 shows how an overhead mirror 5510 can make a long femto projector more compactly fit into the area between two parabolic surfaces (such as within a contact lens), with the pixel display 5440 one the left end and the 45 degree mirror and converging lens 5430 on the right hand side.

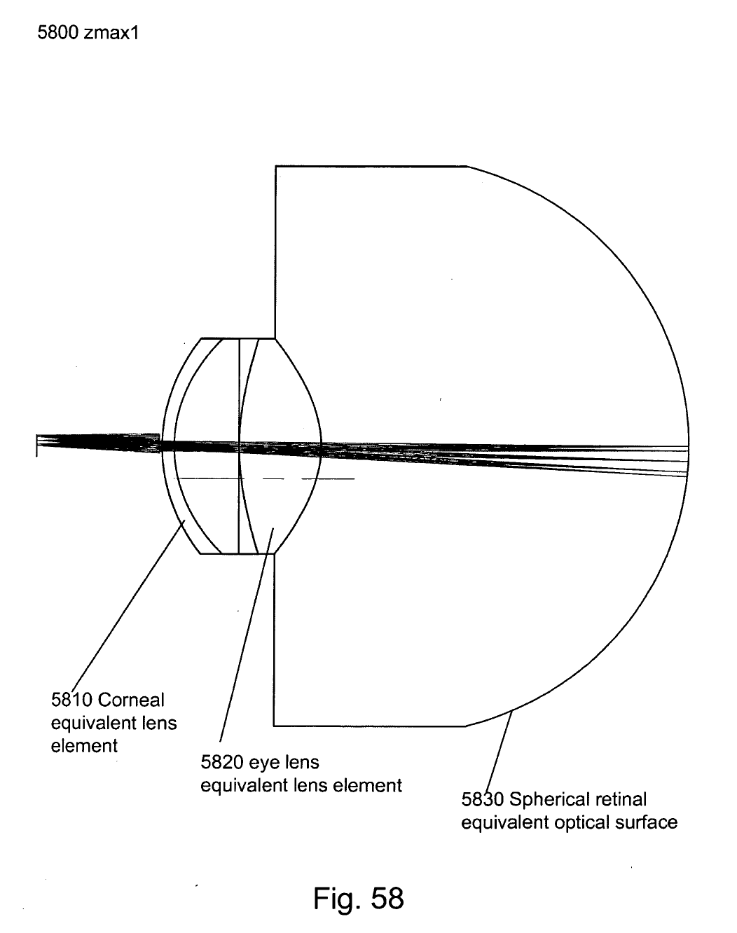

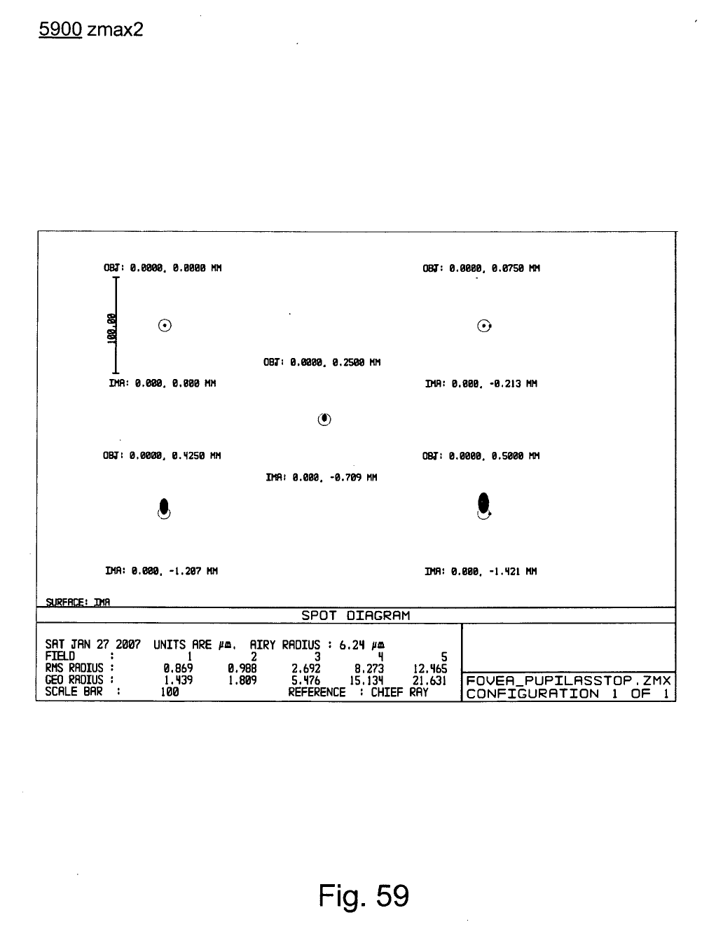

FIG. 58 shows a human eye optically modeled in the commercial optical package ZMAX. It contains a standard optical model lens 5810 equivalent to the human eye cornea, a standard optical model lens 5820 equivalent to the human eye lens and a standard optical model surface 5830 equivalent to the human eye retina. FIG xx shows the results from ZMAX computing retinal spot sizes of this combined lens/surface system. The sport sizes shown are comparable in size to the smallest human eye foveal cones, so the optics has met its design goal.

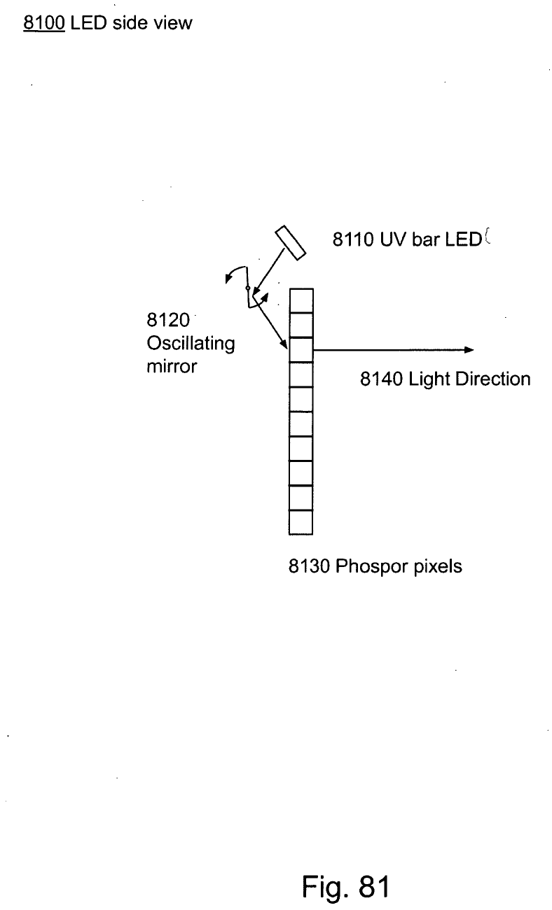

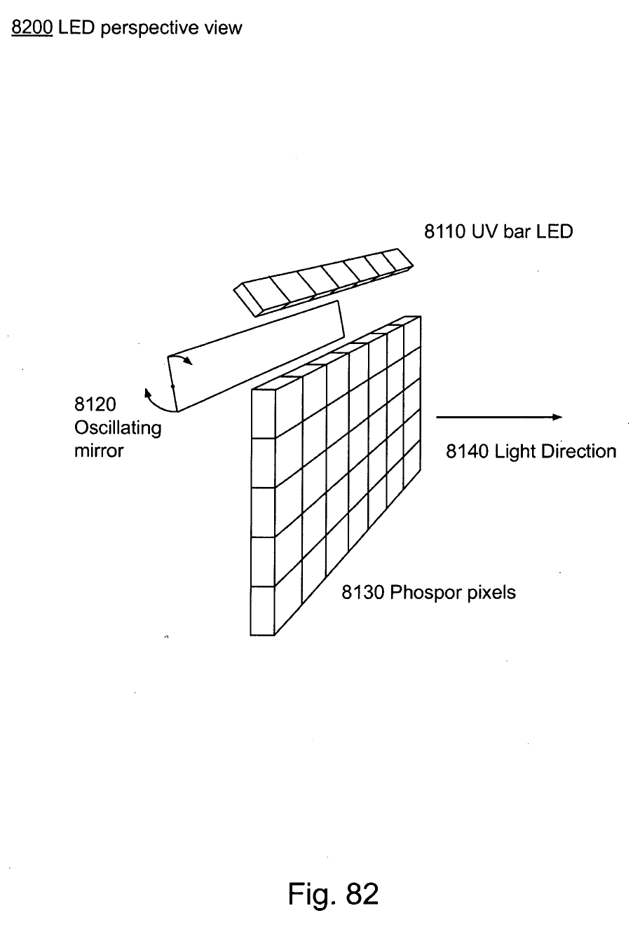

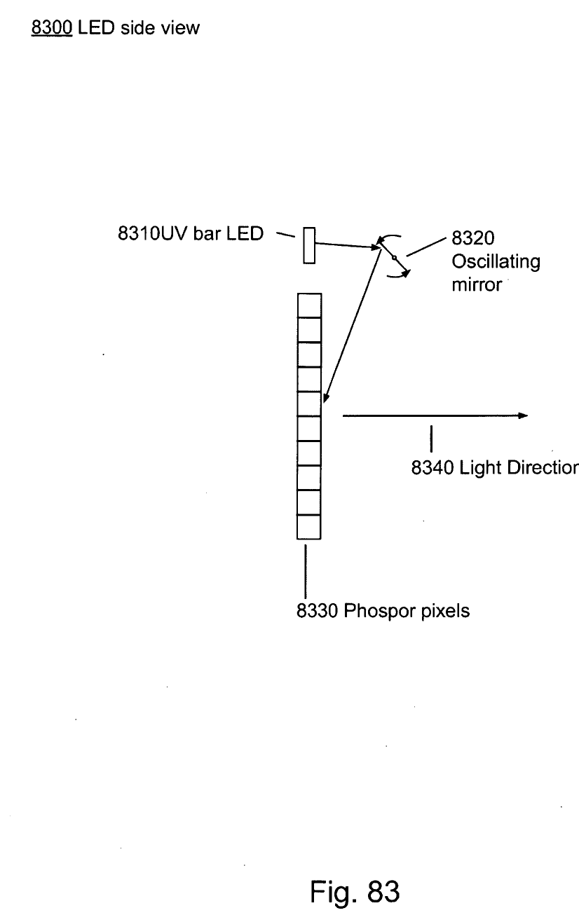

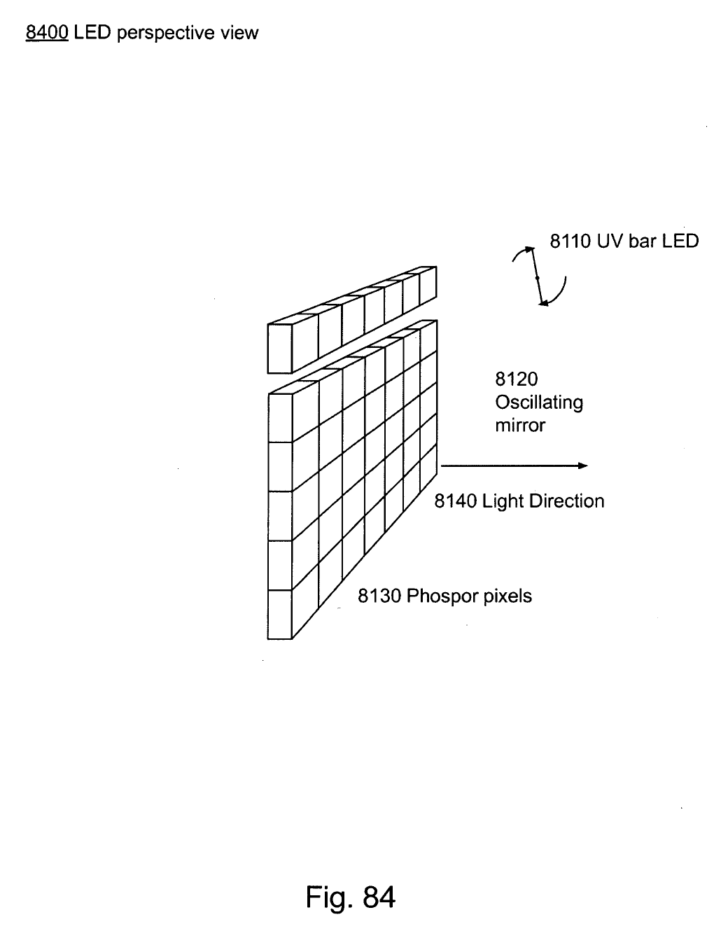

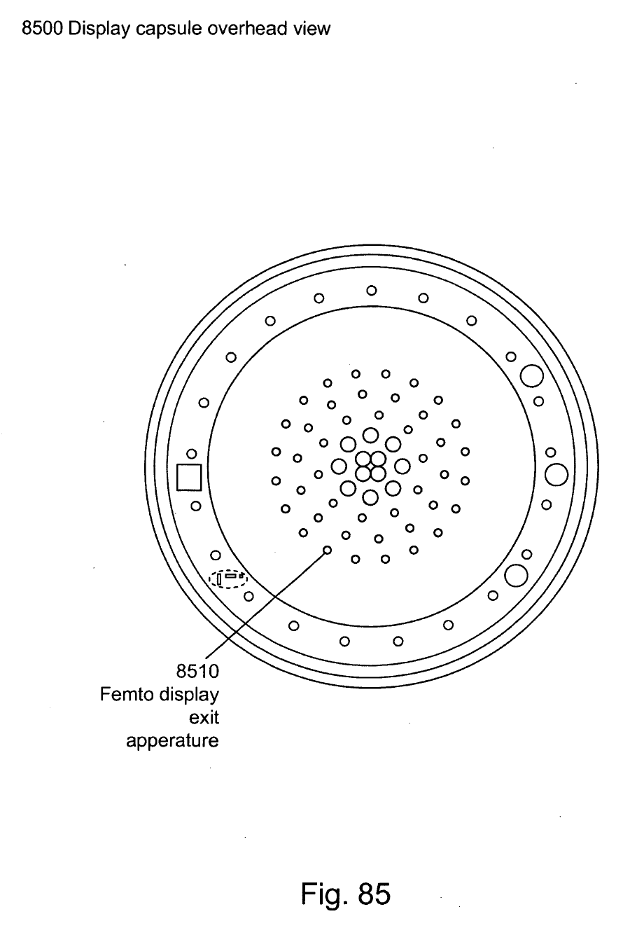

FIG. 81 shows a vertical cross section of one example of a femto-projector. A 128×1 pixel bar of individually addressable ultraviolet LEDs 8110 shines onto a MEMS oscillating UV mirror 8120, which reflects the line of UV pixels up and down across a 128×128 array of thin visible light phosphor pixels 8130. The output light direction is shown by arrow 8140. The relative placement of the elements is a simplified example. Many optimizations to the scanning are possible. FIG. 82, reference 8200, shows a perspective view of the display of FIG. 81. While thin phosphor coatings can be illuminated by UV light from behind (conventional CRT's are “lit from behind” phosphors), femto displays can also use phosphors lit from the front, as seen in horizontal cross section in FIG. 83, reference 8300, and in 3D perspective in FIG. 84, reference 8400.

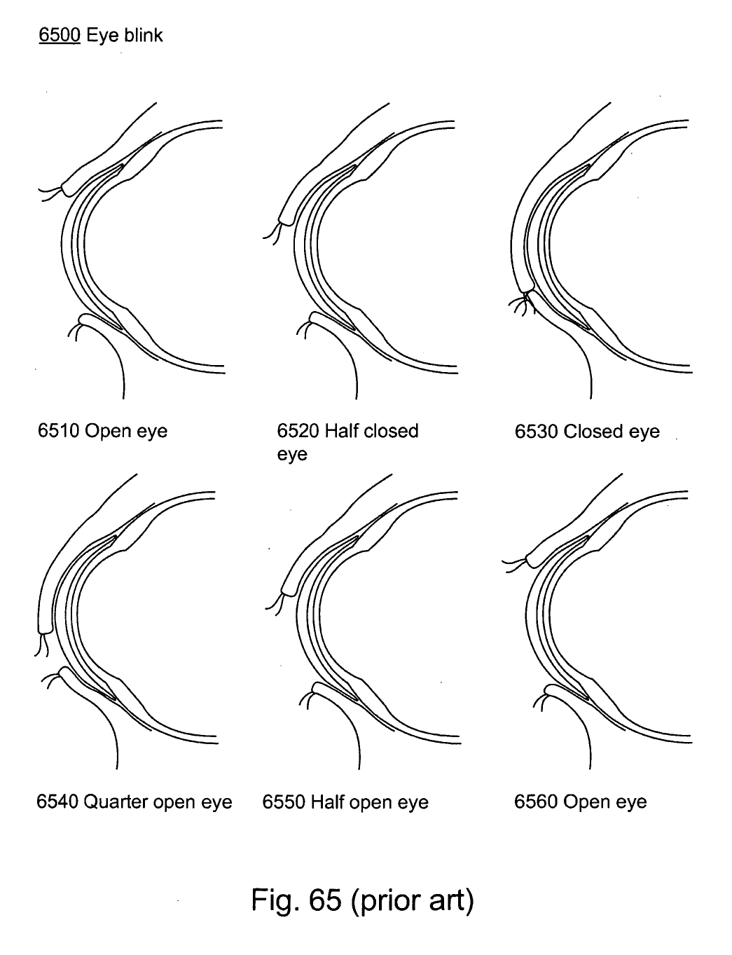

To fit within the rest of the constraints, the shape of the hard contact lens containing the femto displays is thin (approximately 1.0 mm to 2.0 mm in height) with spherical or parabolically curved outward top and inward bottom. We will call this the display capsule. In this design, the top of the display capsule forms a continuous surface with the top of the hybrid sclera contact lens, allowing the eye lids, reference 1710 and 1730, and eye lashes, references 1720 and 1740, to smoothly pass over the surface, as shown in FIG. 65, reference 6500, in six time steps referenced from opened to closed to opened again: 6510, 6520, 6530, 6540, 6550, and 6560.

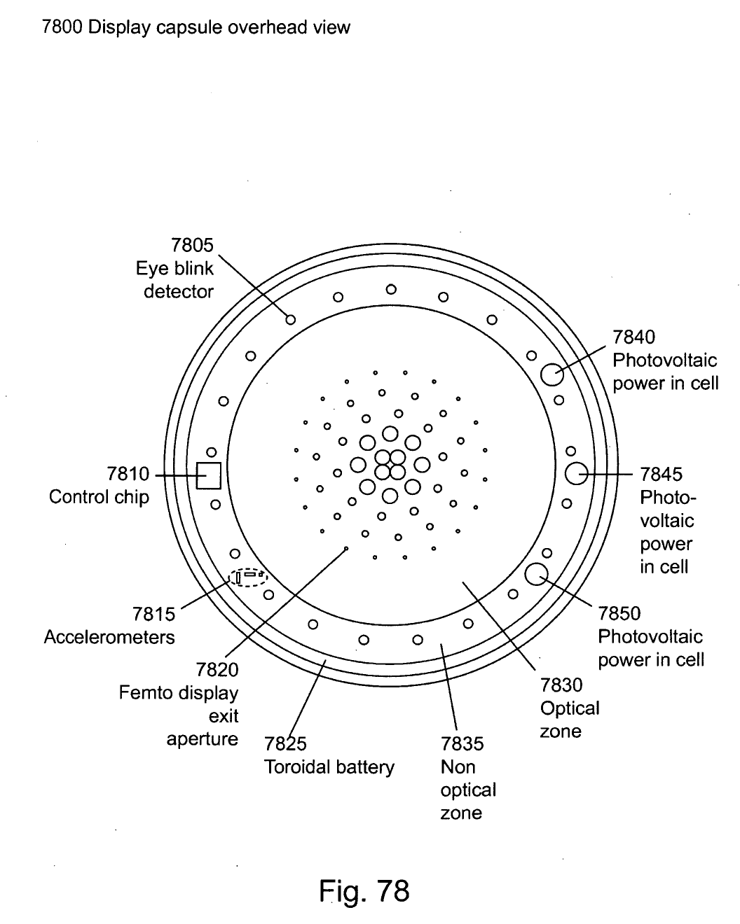

The bottom is concave to keep the posterior surface at a near constant distance from the cornea, and to allow an air gap between an opthalmological hard contact lens (if any) below the display capsule. The functional width of the display capsule preferably is at least the size of the optical zone of the underlying hard contact lens, which hopefully is at least as large as the primary optical zone of the front index of refraction modified cornea. The full width of the display capsule can be larger and the edges of the display capsule can be a good place for holding system component elements that do not emit light for transmission to the eye. This specifically includes the possibilities of EMD controller chip(s), batteries, camera chips and corresponding optics, accelerometers, eye blink detectors, input power and/or signal photodiodes, output signal transmission components from the EMD to the headpiece, etc., as is shown in FIG. 78.

The outside shell of the display capsule should be as thin as possible, to keep from introducing optical effects of its own, but also hard enough to withstand the normal forces that any contact lens is expected to take. There are several possible materials that can meet this requirement. One of them is vapor deposited diamond onto a mold. This technology is presently used to produce inexpensive heat sinks, and to coat the working tip of various cutting tools. A diamond display capsule could be made in two halves. The rest of the active components placed in between the two halves, and then the two halves of the diamond capsule would be hermetically sealed. There are also several special plastic materials now available that can be formed very accurately by molding. These have advantages over vapor deposited diamond. Both sides of each side of the display capsule can be formed, and the rough inner side of the vapor deposited diamond does not have to be optically polished (at a great cost). In some cases it may be possible to form parts of the optical paths directly via the mold surface itself (e.g., though silver depositing for mirrors may still be required) but most likely the inner sides to the two display capsule molds will instead provide points of attachment and calibration for separate optical and other components.

In FIG. 60 reference 6000, a perspective view of a complete assembled contact lens display is shown attached to the human eye 1300. In FIG. 61, an exploded view of the same contact lens display is shown as element 6100, containing the display capsule 6110, the battery 6120, and the scleral contact lens body 6140.

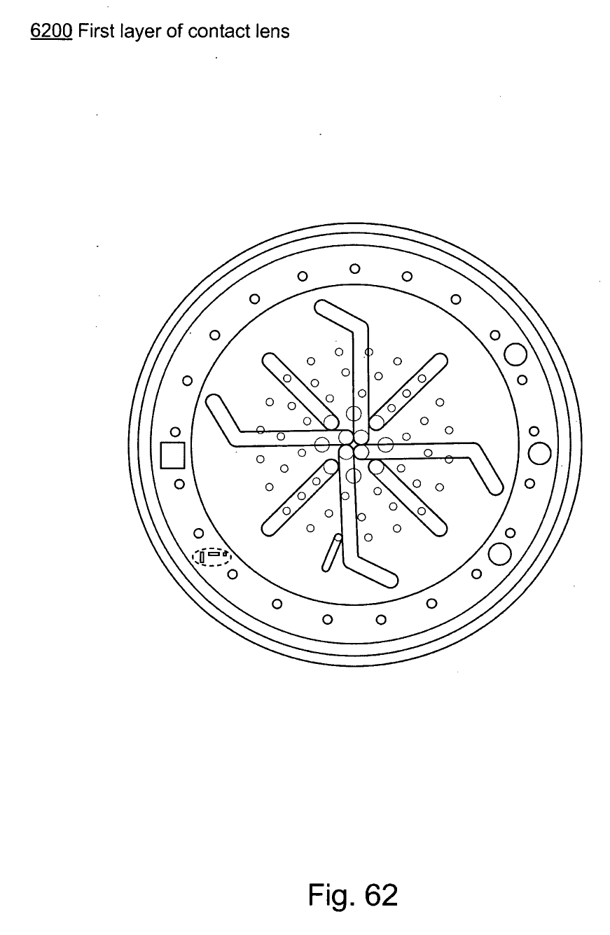

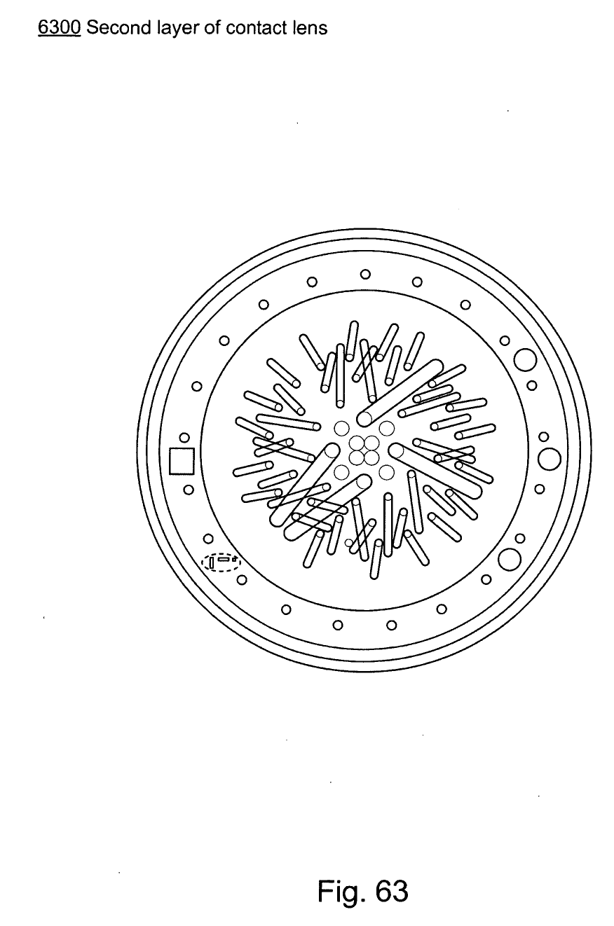

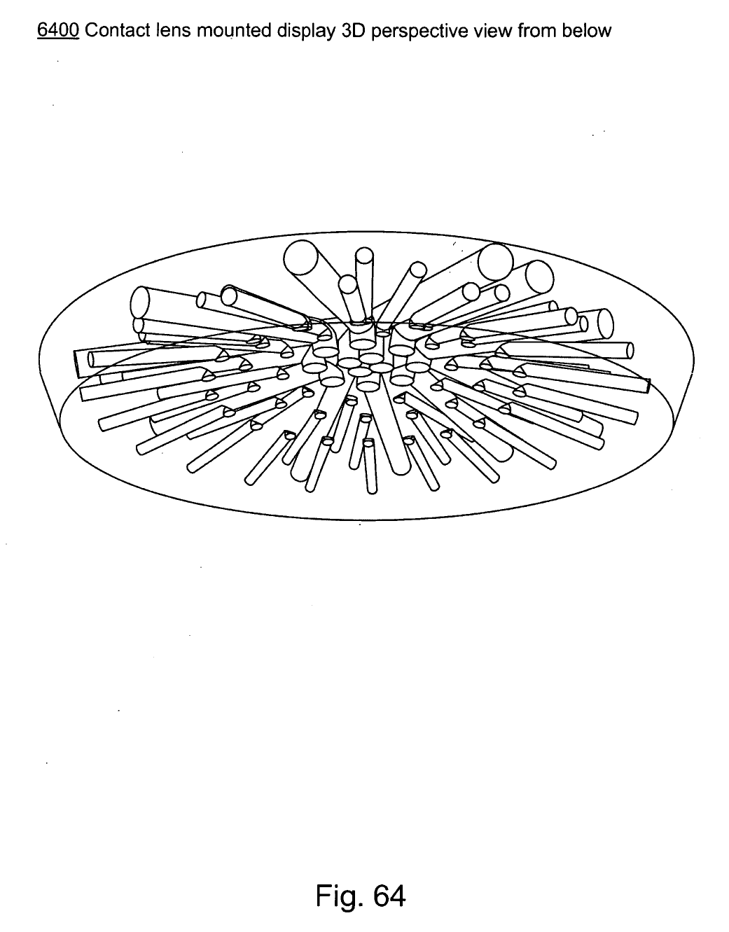

FIG. 62, reference 6200, shows one layer of femto projector light paths within the display capsule. FIG. 63, reference 6300, shows a second layer of femto projector light paths within the display capsule. These two layers allow all femto projectors blockage-free light paths from their phosphors to the corresponding fold mirrors that redirect the light down through the contact lens and into the cornea. This is further demonstrated in FIG. 64, reference 6400, a 3D perspective view of the contact lens femto-projector light paths as viewed from under the lens.

As mentioned before, eye mounted displays can be placed anywhere within the optical path of the eye. The next several figures illustrate several such different places. More that one of these may be used at the same time. For example, an additional structure closer to the outside of the eye may be used for eye tracking purposes.

FIG. 66, reference 6600, shows a horizontal slice view of a contact lens based eye mounted display 6610 in its natural environment—placed on top of the eye's cornea.

FIG. 67, reference 6700, shows a horizontal slice view of an eye mounted display in which a display capsule 6710 is placed inside of or in place of the cornea.

FIG. 68, reference 6800, shows a horizontal slice view of an eye mounted display in which a display capsule 6810 has been placed on the posterior (rear) surface of the cornea.

FIG. 69, reference 6900, shows in horizontal cross section a configuration in which a display capsule 6910 is part of an intraocular lens, placed between the cornea and the lens within the anterior chamber 1415. This technique has several advantages over a contact lens display. No contact lens need be put in and out of the eye. Ocular correction can be performed “traditionally,” either using exterior glasses, contact lenses, or various forms of cornea surgery (e.g. wavefront LASIK) (or just via natural clear vision). In addition, the display is positionally stable with respect to the eye and retina.

FIG. 70, reference 7000, shows in horizontal cross section a configuration in which a display capsule 7010 has been placed on the anterior (front) surface of the lens.

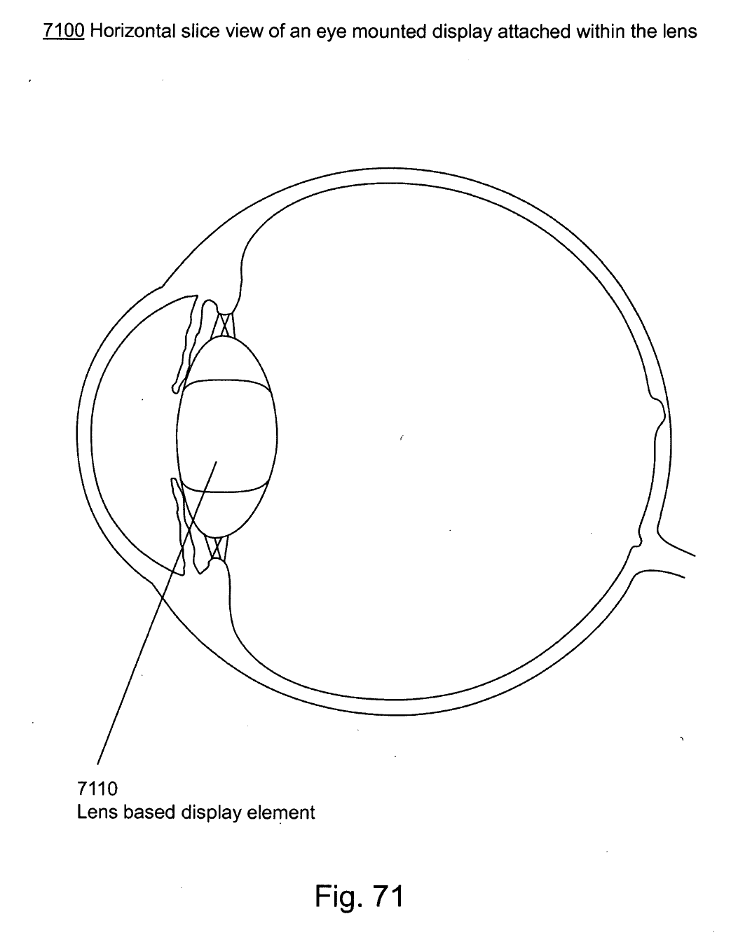

FIG. 71, reference 7100, shows in horizontal cross section a configuration in which a display capsule 7110 has been placed inside of or in place of the lens.

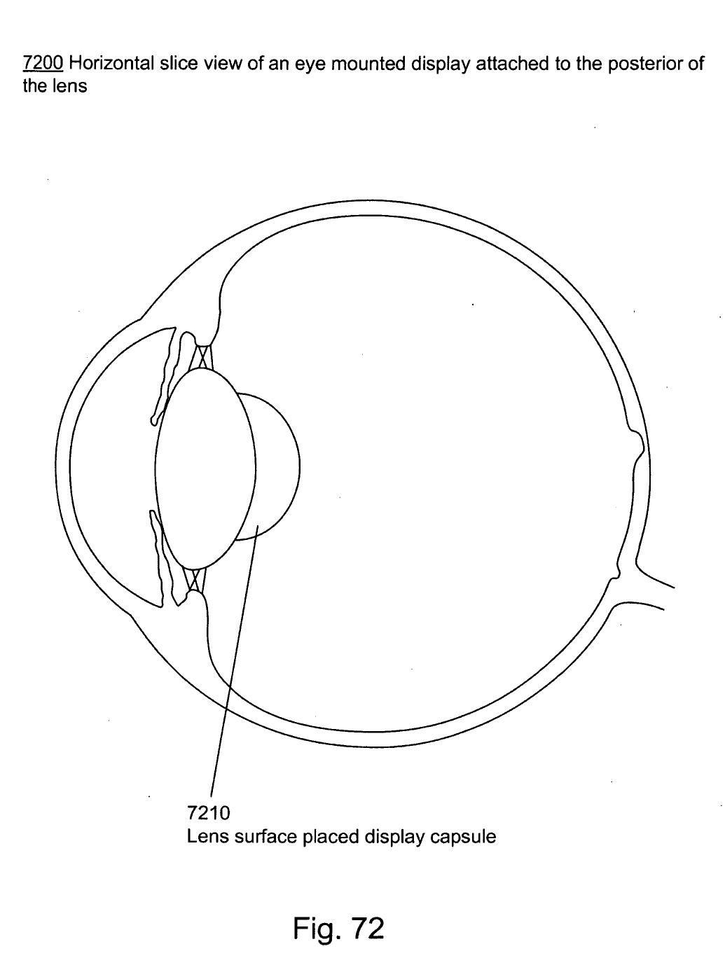

FIG. 72, reference 7200, shows in horizontal cross section a configuration in which a display capsule 7210 has been placed on the posterior (rear) surface of the lens.

FIG. 73, reference 7300, shows in horizontal cross section a configuration in which a display capsule 7310 has been placed within the posterior chamber 1445, between the lens and the retina 1460.

FIG. 74, reference 7400, shows in horizontal cross section a configuration in which a display capsule 7410 has been placed close to or directly on the surface of the retina 1460.

All of these examples simply represent single points among a continuum of possible ways of infiltrating artificial displays into the optical pathways of the human eye. So far all of these techniques have only described simple cases in which a display capsule was placed at a particular point within the optical path of the eye. This is not meant to preclude situations in which multiple artificial elements are introduced to the eye (not necessarily into the optical path). One specific example is the situation in which calibration marks for eye tracking have been made directly on the surface of the scalia for a reader that is tucked inside the eye orbit (and thus is cosmetically acceptable since nothing shows externally).

IV.E Internal Electronics of Eye Mounted Display Systems

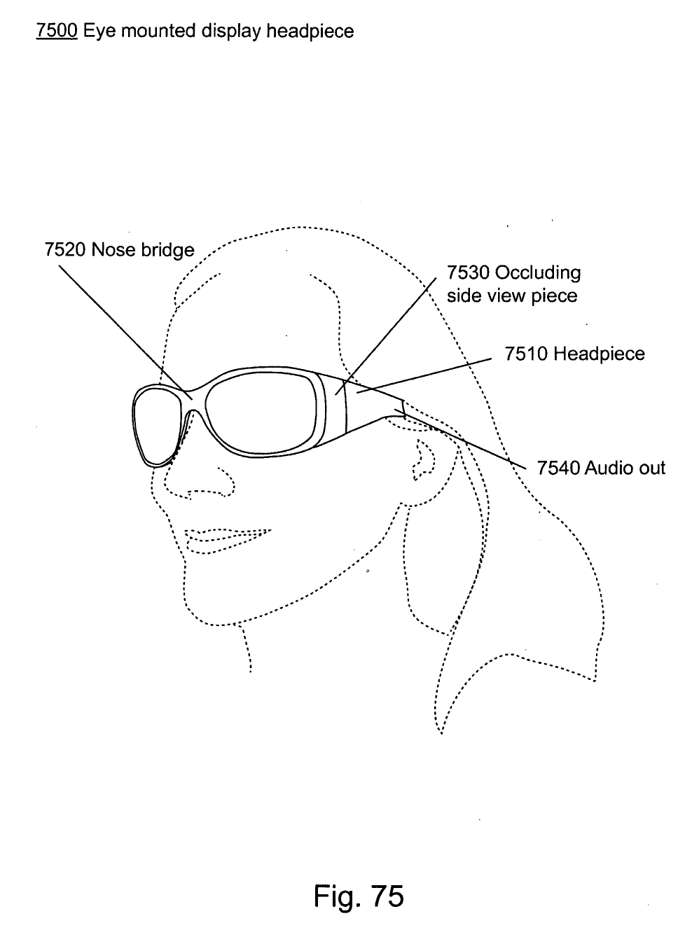

FIG. 75, reference 7500, shows one possible physical shape of a headpiece 7510, modeled after a pair of sunglasses. Also shown in FIG. 75 are the nose bridge 7520, the light occluding sides of the headpiece, and the left ear audio output 7540.

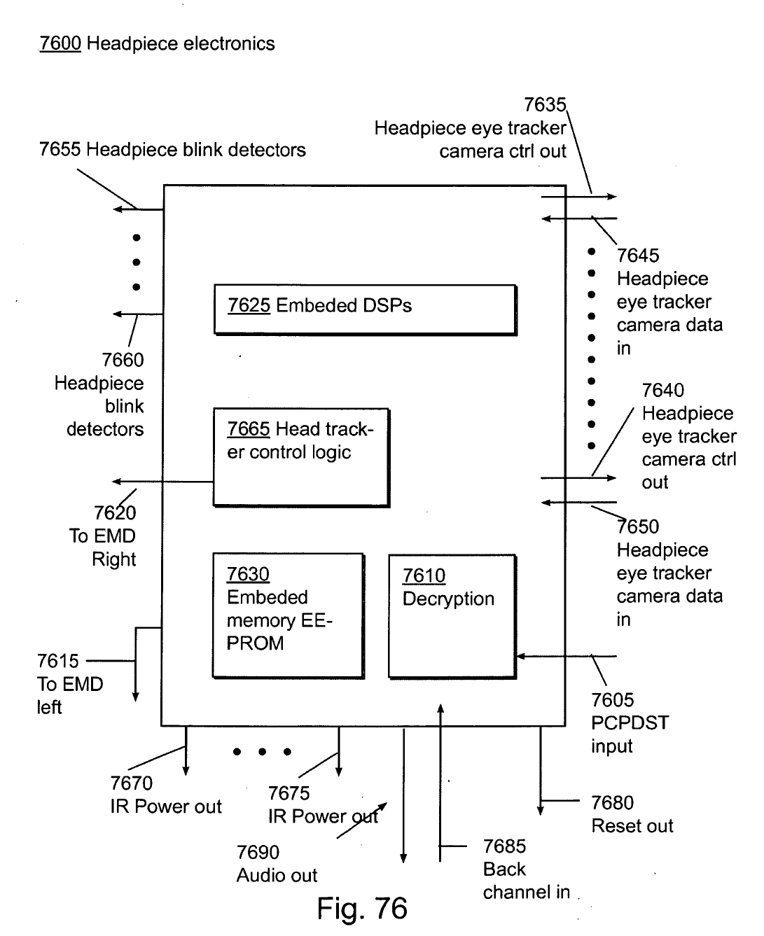

FIG. 76, reference 7600 shows a logical level example of the headpiece electronics. The pseudo cone pixel data stream 225 input is reference 7605. The rules for transmitting protected media content (like Blu-Ray™ or HD-DVD™ video discs) require specific encryption when full fidelity images are being transmitted. In all likelihood, the real-time variable resolution moving point of view pixel display frames will not be deemed to require encryption. However, the PCPDS information is preferably encrypted, and may be decrypted at this point by a specific decryption circuit 7610. Although most of the time, reference 225 is described as data flowing towards the eyes, in fact the channel 225 preferably is bidirectional, as calibration and other data can flow away from the eye, although probably with a lower bandwidth.

Reference 7615 and 7620 are the pseudo cone pixel data stream 225 signals going from the headpiece to the left and right EMD, respectively. These carry the pixel information for each frame of display. The data rate for this information channel preferably is high enough to carry single component pixel information for around 500,000 pixels every frame time, which can range from 50 Hz to 84 Hz or higher. Simple lossless compression techniques can be applied to this information flow, so long as the decompression algorithm requires only a small amount of computation. For relatively small field of view virtual screens within the very wide field of view display, there can be a lot of blank pixels that even simple run-length compression will easily handle. But also remember that the fovea, where 10% or more of the display pixels live, will be looking right at the small display, so the overall compression will be smaller than with a non variable resolution display. Slightly lossy compression algorithms may be acceptable in many cases, especially if it is “visually lossless.” Fortunately “eye safe,” water penetrating, mid infrared frequencies can easily handle the required data bandwidth, and at the safety-required low transmission powers. A portion of this infrared transmission can be picked up by one or more photo diodes 7840, 7845 or 7850 tuned to the same infrared frequency located just under the top of the display capsule, as is shown in FIG. 78, reference 7800. Because the eye rotation is tightly tracked, even lower power transmissions are possible if the transmission from the headpiece closely tracks where the closest display capsule photodiode is located.

Embedded DSP cores 7625 perform much of the data processing for the headpiece, and since they are programmed, in a re-programmable way. Which portions of which computations are in dedicated logic versus the DSP is an implementation dependent choice, but it the eye and head tracking algorithms do require some amount of programmable computational resource. The EEPROM 7630 (or some other storage medium) can contain all the code for the DSPs 7625, as well as specific calibration information for a particular pair of EMDs. This information is downloaded to the scaler subsystems 202 through 210 during system initialization. In this way, different people can plug into the same set of scalers (at different times).

The next set of signals relate to a specific class of optical based eye tracking algorithms. References 7635 through 7640 are control signals for a corresponding number of eye tracker camera and illumination sub-systems. References 7645 through 7650 are data signals back from these sub-systems, likely image pixel data to be processed in firmware by the DSPs.

FIG. 76 also shows eye blink detector inputs 7655 through 7660. Several simple schemes are possible, such as the change in IR spectral reflection between the open eye and the skin of the eye lid.

Reference 7665 represents dedicated (e.g., not programmed) control logic and state machines for wherever needed within the headpiece.

Ideally the power for the components in the display capsule could be brought in externally. So long as multiple interlocks have verified that the eye is covered by an EMD in its proper position, power via IR beams can be safely used to power the EMD wirelessly. References 7670 through 7675 are fixed position IR power emitters. These are powered up when the eye tracking system determines that one or more IR power receivers (FIG. 78, references 7840, 7845, and 7850) on the EMD are favorably aligned. Preferably an EMD would have a small internal battery (FIG. 78, reference 7825). It would be advantageous if the battery was capable of powering the EMD for an entire day and then recharge at night. Another possible power alternative included leaching power from the mechanical motion of the eye blinks. Other forms of electromagnetic, magnetic, sonic, or other radiation might be employed.

It is desirable for the headpiece to perform a “cold” reset of an EMD when necessary. A special IR input circuit, operating at a specific narrow frequency and pattern can be hardwired to a cold reset of the circuitry within an EMD. The IR signal generator that sends such a signal is reference 7680.

A low bandwidth back-channel free space communication of information from the display capsule to the external electronics attached to the headpiece is also desirable, reference 7685. In normal operation, the display capsule does not have much to communicate back to the rest of the system: perhaps “keep alive” pings, input FIFO fill status, capsule based blink detection, optional accelerometer data, or even very small calibration images of the retina. Also, when the CLMD is not being worn, it may reside in a containment case that possibly runs diagnostics. The back-channel itself can be a short burst low power infrared channel back to the headpiece electronics, but just as with the pixel input channel, other embodiments may use other communication techniques for the back-channel.

Many of the current video encoding formats also carry high fidelity audio. Such audio data could be passed along with the PCPDS, but separated out within the headpiece. Binaural audio could be brought out via a standard mini headphone or earbud jack 7690, but because the system in many cases will know the orientation of the head (and thus the ears) within the environment, a more sophisticated multi-channel audio to binaural audio conversion could be performed first, perhaps using individual HRTF (head related transfer function) data. Feed-back microphones in the earbuds would allow for computation of active noise suppression by the audio portion of the headpiece.

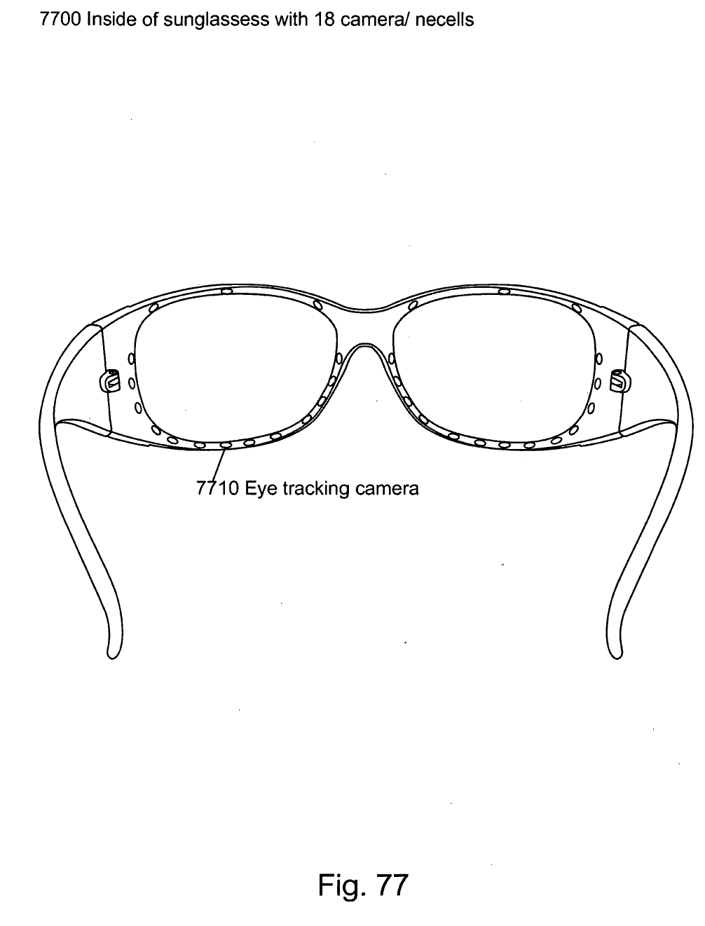

FIG. 77, reference 7700, shows an example headpiece from the back side. Here eye tracking camera nacelles 7710 through 7710 are shown, as well as the IR power out 7670 through 7675, and the cold reset out 7680.

It is usually desirable that as much electronics, processing, sensing, etc. be located external to the eye mounted display. However with today's electronics capability, several essential electronics and processing can be combined onto a single chip mounted within the display capsule, but outside the optical zone.

FIG. 78, reference 7800, shows an overhead view of the display capsule with the positions of several discrete components shown. Reference 7805 are the eye blink detectors. Reference 7810 is the main EMD control IC (or equivalent technology). Reference 7815 are accelerometers. Reference 7820 delineates the apertures for the femto projectors in this particular EMD. Reference 7825 shows one possible location outside the optical aperture for a (relatively) substantial rechargeable battery: a toroid around the outer edge of the display capsule. So long as external power is available, a considerably smaller battery would be more than sufficient; its size would likely be smaller than the controller IC. Reference 7830 delineates the optical zone limit for this particular EMD; the complement of this field is the non-optical zone 7835. Note that just as with any contact lens, the supported optical zone which defines limits on field of view of the eye does not have to be as large as the natural corneal optical zone equivalent field of view. Naturally as large as possible of optical zone is desirable (and supportable by EMD technologies), but people commonly use contact lenses and glasses that have limited optical zones. Possible infrared power in cells are shown as references 7840, 7845, and 7850.

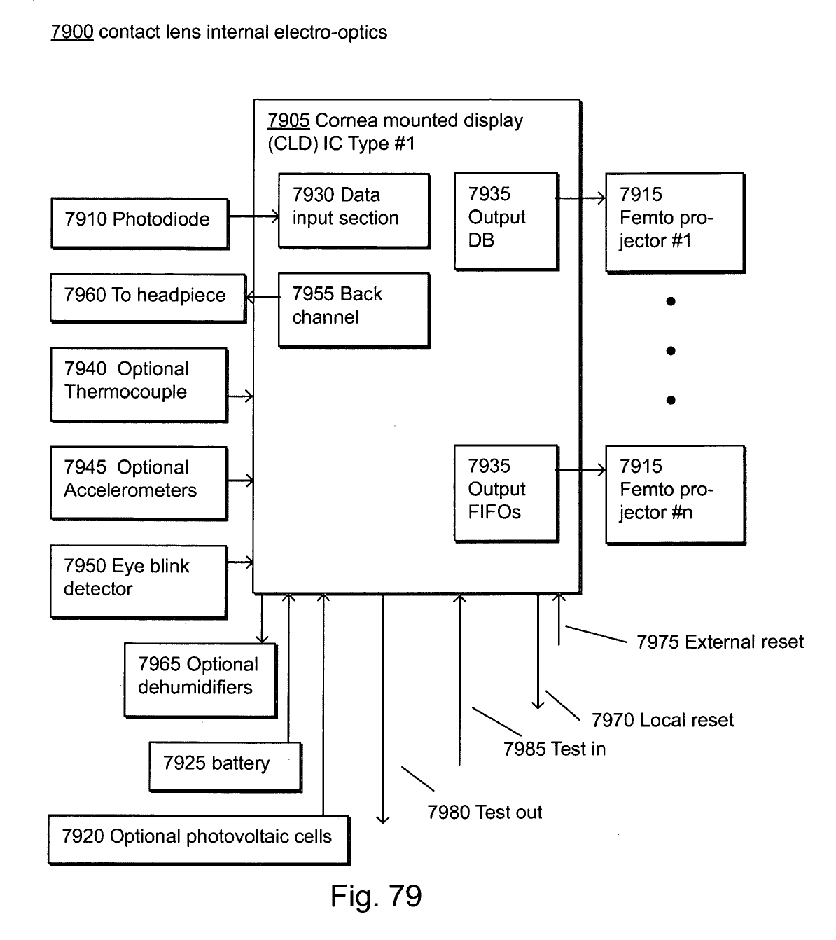

FIG. 79 describes much of the internal function and operation of the electronics within the display capsule at a block diagram level. Digital data streams of pseudo cone pixels are captured by light (sent by the headpiece) to photo-diode 7910 (or some similar mechanism), and then sent to the controller chip 7905 data input section 7930. This data input section has several responsibilities. First is decoding the data fields from the carrier, e.g. start bits, ECC or other similar data correction technique, decrypted data fields, monitoring internal FIFO status and re-impedance matching either by increasing or decreasing internal pixel clock rates, and/or sending data rate run over/under status to the headpiece via the back-channel 7955, where there is space for much larger impedance matching FIFOs. In cases where a data block is too corrupted for correction, the input block may send a re-send request for the entire block to the headpiece.

After correct decoded data has been captured, it is routed to the proper internal FIFOs on the chip 7905; one for each femto projectorfemto projector 7915 on the EMD. At the correct timing, the pseudo cone pixel data (plus control data) will be sent to the femto projectors via the pseudo cone pixel output 7935.

The control chip has several optional additional monitors of the physical world. Temperature via the thermocouple 7940, rapid eye movement via the accelerometers 7945, blink detection via a special blink detection circuit 7950 (possibly a line of photo-diodes), etc.

One method for positioning a CMD is to dehydrate tear fluid at the edges of the contact lens when it is first put on the eye. Dehydrated tear-fluid is mostly comprised of sticky mucous, and thus the user's own natural body elements are used to create temporary glue. When it is time to take the CMD off, a small amount of water eye-dropped into the eyes will re-hydrate the tear fluid “glue,” decoupling the CMD from the cornea for removal. One way for the CMD to de-hydrate a ring of tear fluid is to locally wick the water portion away. These wicks could be turned on and off by the controller chip 7905.

There are many mechanisms to build in high reliability, testability, and real-time resets of multiple chip based systems. Only a simple example will be given here. The “local reset” 7970 is an output of controller chip 7905. It resets all the internals of the femto projectors, but not the controller chip itself. It is possible that the femto projectors could be reset as often as once per frame, or otherwise as needed. The external reset 7975 is a low frequency signal sent by the headpiece to a separate circuit than the controller chip that allows the headpiece to perform a hard reset of the controller chip if it is not responding or behaving properly. It is possible that the controller chip could be reset as often as once per eye blink (˜every 3 to 4 seconds), or otherwise as needed.

Finally, a test loop out 7980 and test loop in 7985 on the controller chip are present to allow the controller chip to test the femto projectors during any system test time, which could be as often as every eye blink. It is also possible that there will be a linear camera chip somewhere outside the utilized, but inside the generated, optical path of each femto display that allows for per pseudo cone pixel calibration.

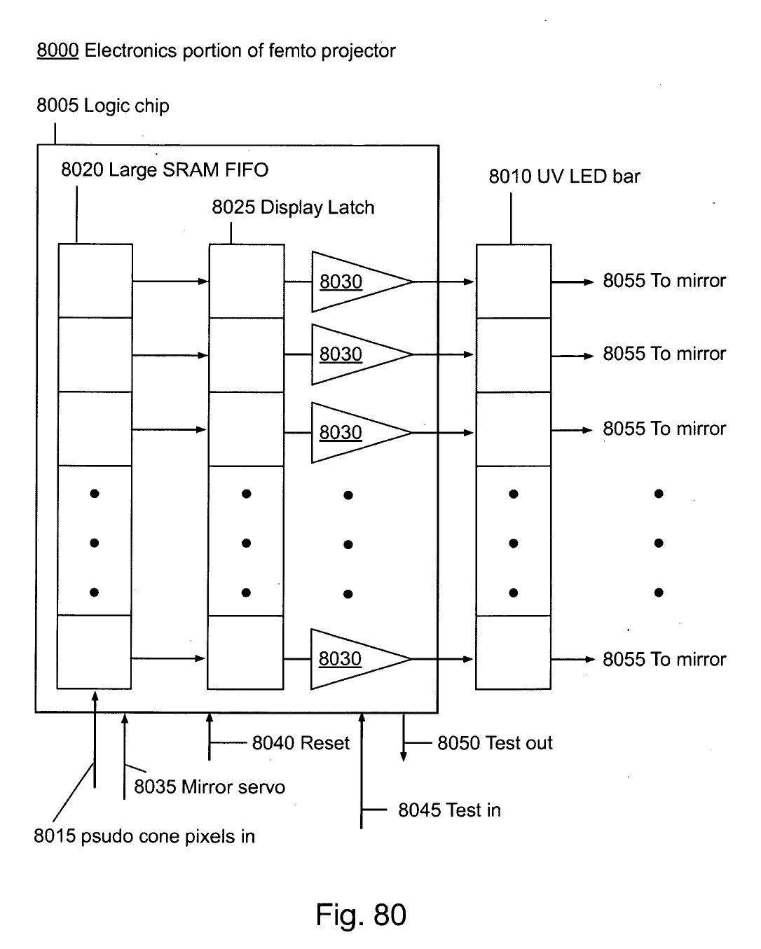

FIG. 80 shows a block diagram of the electronics portion 8000 of a femto display. It includes two chips: a logic chip 8005 with analog out control chip; and a gallium nitride chip 8010 with 128 UV LEDs arranged in a bar. The logic chip 8005 receives a stream of pseudo cone pixels from one of the outputs of the controller chip 7905. These are stored into an input FIFO 8020. After an entire new “scan line” of pseudo cone pixels have arrived in the input FIFO, the input FIFO transfers in parallel all of the pixels into a second FIFO, the output FIFO 8025. Each digital data value in the output FIFO is attached to an individual digital to analog converter circuit 8030, which analog outputs are wired one-to-one to analog inputs of the GaN UV LED chip. Thus the new line of values being transferred to the LEDs cause a new linear pixel array of UV light intensities to radiate out and reflect off the current orientation of the oscillating mirror 8120, and then strike the row of phosphors 8130 that the mirror 8120 is currently aiming at. In this way an entire frame of pseudo cone pixels is driven into the femto projector.

Because the individual logic chips 8005 have so little circuitry, if more FIFO space for data over/under run is needed within the CMD, it may make more sense to add several additional lines of pseudo cone pixels to the logic chip 8005 rather than n times more storage on the controller chip 7905, where n is equal to the number of individual femto projectors on the CMD, likely 40+. Also, along with each line of pseudo cone pixel data, several additional bits of control and state information can be loaded into the logic chips 8005 per line. This allows the controller chip 7905 to directly set the state machine(s) of the logic chip at will (think of this as “an instruction”).

A sub-circuit reference 8035 to help synchronize the oscillating mirror 8120 to the desired frame and sub-frame rate is also present within the logic chip 8005. This is part of a larger circuit responsible for powering and controlling the MEMS (or other) mirror 8120.

For completeness, FIG. 80 also shows the local reset 8040, test data in 8045, and test data out 8050.

The physical two dimensional cross sectional view of a UV LED bar, oscillating mirror, and phosphor that comprise the light generating portion of a femto projector for the case of the mirror and UV LED bar positioned to illuminate the phosphor array from behind is shown in FIG. 81, reference 8100. The three dimensional perspective view of the same configuration is shown in FIG. 82, reference 8200.

The physical two dimensional cross sectional view of a UV LED bar, oscillating mirror, and phosphor that comprise the light generating portion of a femto projector in the case of the mirror and UV LED bar positioned to illuminate the phosphor array from infront is shown in FIG. 83, reference 8300. The three dimensional perspective view of the same configuration is shown in FIG. 84, reference 8400.

Turning now to power for the CMD, a totally internal solution is a toroidal battery that is recharged at night, but this is only possible if the total power needs of the CMD over a total work day can be met by the battery technology that can fit into the CMD somewhere outside the optical zone. Another possibility is using the eye lid blinks to skim some of the mechanical power to internal electrical power. A smaller battery and/or a large capacitor would be needed for buffering.

External solutions can be any of many forms of radiated energy: electrical, magnetic, acoustical, IR optical, visible light optical, UV light optical, etc. Some sufficiently energetic form of light based power could be used where the interlocks guarantee that the power beam originating from the headpiece will be turned on only when it is known to a extremely high degree of probability that the power beam will only hit the outer surface of the CMD, and will not pass into the eye because the CMD will block that frequency range from propagating through to the eye. A simple example would be an infrared power beam 7670 from the headpiece pointing at a photovoltaic cell 7920 on the surface of the CMD. Completely IR-blocking coatings on later layers of the CMD might ensure that no spill over will enter the eye. If contact with the CMD is lost for any reason, the power beam will be cut off until calibrated contact is re-established.

Many different tests and data can be used in various combinations to ensure that the CMD is positioned properly over an eye. One test is to make sure that the low bandwidth back-channel from the CMD is being received by some portion of the headpiece, and that the data received describes normal operation. One piece of such backchannel data is “blink” detectors on the CMD. In one embodiment this can basically be a few dozen photo diodes whose data values can be sent back to the headpiece for interpretation. Proper eye blinks is a good indication that the CMD is properly placed. If the CMD contains a square and/or linear camera, placed outside the functional optical path, but in a position to view some portion of the retinal surface, then the “retinal print” seen by the camera(s) can be used as yet another way to validate the proper positioning of the CMD. Another test is for the headpiece-based eye tracker 125 to be functioning properly, and check that the eye positions and movements are consistent with a properly placed CMD.

IV.F Systems Aspects for Image Generators and Eye Mounted Displays

Moving now to EMDS systems aspects, when a headpiece is first connected to an EMDS and image generators, either physically or via free space, one or both sides can insist on digital signature verification before proceeding to normal operation.

Next, somewhere in the system, there may be calibration data for the individual left and right (or just one) CMDs. While such information could be stored somewhere in a networked environment, a convenient and logical place to place it is in some form of persistent storage in the headpiece. Once a connection is made between the headset and the rest of the EMDS, this calibration information can be copied down the link from the headpiece to the scaler components 202 through 210, where it is likely to be stored in the attached memory sub-system. This calibration information can be used to construct the sequential pseudo cone pixel descriptor list that is assessed during the variable resolution re-scaling operation.

There are many different methods for implementing head trackers, but a particular one will be used here as an example. Assume that infra-red (IR) LEDs are mounted on the outside of the headpiece, and are turned on briefly at a known set of times. The rest of the headtracker, the tracker frame 230, would contain three or more one dimensional or two dimensional infrared cameras. The sub-pixel accurate (via various techniques) location of the infrared LEDs captured by the cameras can be directly manipulated computationally to give an accurate position and orientation of the headpiece, and thus the position of human user's 110 eyes. To perform this task, there should be tight timing synchronization between the transmitters (IR LEDS) and the receivers (1D or 2D IR cameras) in the tracker frame 230. The tracker frame should also send the image data captured to a computational unit that can transform it into viewing matrices for image generators and matrix transforms for mapping the virtual screen to the EMDS. This computation could be performed anywhere within the system, but a good placement would be the headpiece that already will have a computational infrastructure for extracting eye orientation data. Note that the direction of information flow is from the scalers to the headpiece.

There are many different methods for implementing eye trackers, but for simplicity a particular example will be used here. In these cases, a contact lens display has special marks printed and/or embossed on or near its surface. These marks are illuminated by timed flashes of light from portions of the headpiece. Also on the headpiece are a number of linear or array cameras (likely infrared) that capture the interaction of the illumination bursts with the patterns. These cameras are advantageously placed as near the eye as possible. In this example, they are placed all around the inside rims of a pair of eyeglasses that form part of the headpiece. This way, no matter what direction an eye is looking, there will be several cameras able to obtain a good image of the pattern.

Because the illumination and the cameras are in this case part of the headpiece, it is advantageous to have the image processing performed on the camera outputs to determine the orientation of the eyes. This computation is simple enough that a custom image processor design is not needed. Existing DSP IP cores should be able to handle this job, and can also be handed the data from the head tracker cameras.

With the same DSP cores computing both the head and the eye tracking data, they are advantageously positioned to compute the transforms and other per-frame data that the scalers use to process the next frame, or in parallel frames, of video data. This information flow is from the headpiece to each scaler individually, as different virtual screens can use different data. As both the head and eye-tracking may be taking place at a higher rate than the video rate(s), the data for the scalers would be averaged (or more complexly) over several sub-frames, and only sent on to the scalers where the time was just before they need to start processing a new frame of data. Once they start, this completes the cycle.

IV.G Meta-Window Systems for Eye Mounted Displays

Now consider how to configure the position, orientation, size, and curvature of the (multiple) virtual display image(s). Certainly one way is for the EMDS to come with a small controller to allow individuals to set such parameters, similar to how CRTs had controls for the horizontal and vertical height, the horizontal and vertical size, etc., but setting up objects in three dimensions literally adds another dimension to the problem.

A more likely solution is for an application running on one of the computers controlling one or more image generators to have a GUI to let virtual displays be placed, orientated, and sized; and curvature parameters set if that option is available. Most modern window systems allow for some number (at least 8) of separate image generators to become the “tiled” portions of what is otherwise a single larger window workspace. Moving the cursor off to one side of a display causes it to appear on the physically neighboring display, if there is one there. This covers two of the more common uses of a single computer with an EMDS: n×m image generator separate video outputs form either a single large flat window in space, or a single cylindrically curved window. It is usually important for the EMDS to know when two window edges are intended to seamlessly abut versus one being to the rear, or front, of the other. Such virtual window configurations preferably are persistent, e.g. do not require the user to set them over again every time the computer(s) are re-booted. This can be addressed by having the application on a computer that handled the creation of the virtual screen placement parameters insert a “window system start-up time” job that will re-send the configuration information whenever the window system is booted. Another option would be to write the virtual screen parameter information into electronically alterable storage within the EMDS. It only need be changed when the configuration application is run again.

The conventional method to support multiple computers running at the same time in a single display is to use a KVM: Keyboard, Video, and Mouse switcher. This is a box that for example, has one USB keyboard and one USB mouse input, as well as one video output (in some format, analog or digital), but has n USB keyboard and mice outputs, and n video inputs. The scaler component of an EMDS effectively already performs a more sophisticated control of n video inputs. What is left is control of keyboard and mice. If two USB inputs and two USB outputs are added to each scaler black box (or multiples for black boxes that support more than one video in), then the scalers can perform a conventional job as a KM (keyboard mouse) switch.

Conventional KVMs allow the user to dynamically specify which of the up to n computers is currently active for keyboard and mouse by means of an additional multiple button interface device. It would be preferable to avoid adding such additional physical user interface devices. One possible solution is to allow the software program that is dynamically controlling the virtual displays to also dynamically control the keyboard and mouse focus. There are other alternatives: a rapid double “wink” in one eye of the user could change the keyboard and mouse focus to the computer controlling the virtual display that the user is currently looking directly at (e.g., use they eye tracking and blink tracking data).

With respect to minimizing a virtual screen, rather than collapsing the screen to a label on the top or bottom menu bar; it is possible to collapse it to a “flat” video image within the EMDS display space. Because such “collapsed” video streams are below any active windows, there is (usually) scaler computational bandwidth to include (a perhaps frozen video image contents) display of these “stubby” virtual screens, perhaps with a text tag associated with it. This “tag” part could be the same as current window systems. A user control of some sort would allow “un-closing” of the video window at a future point in time. They would then revert to a “normal” virtual screen.

IV.H Advantages of Eye Mounted Display Systems

The possible advantages of an eye mounted display system are numerous. One possible advantage is that keeping a display made up of variable resolution display elements coupled close to, or locked to, the variable resolution of the human eye's retinal receptive field centers, means that a device that meets or exceeds the resolution and field of view requirement of the human visual system can potentially be built.

In addition, just as one uses the same pair of glasses while at work, home, or other outside activities, another possible advantage of eye mounted display systems is that the same pair of eye mounted displays can be worn and thus replace many fixed displays at these locations. Thus even if an eye mounted display system costs more than any particular display, to be economical, it only has to cost less than all the other fixed displays it replaces.

A third potential advantage of eye mounted display systems is that because eye mounted display systems are inherently small and low in power consumption, they may be able to solve the display size and resolution limitations of current small portable electronic devices: cell phones, PDAs, handheld games, small still and video cameras, etc. In addition, the approach described here for eye mounted display systems is compatible with existing video display standards, and has the possible advantage that it can put more than one video input into the larger perceptual display space, without requiring the video sources to communicate with each other.

Another potential advantage is that for the specialized market where head mounted displays are used; an eye mounted display system provides orders of magnitude more perceptible display pixels, much lower weight and bulk, etc. With the combination of large field of view, high spatial resolution, integral head-tracking (on some models), see-through capabilities, and potentially low cost, the markets for immersive displays can expand to significant sections of the gaming and some of the other entertainment markets, while better serving the existing markets for head mounted displays in scientific visualization, virtual prototyping, simulators, etc.

Yet another possible advantage is because it is fairly natural to construct eye mounted displays that have similar variations in resolution as does the human eye, orders of magnitude fewer display elements (“pixels”) can be used on a display fixed to the eye than for displays that do not know where the eye is looking, and thus must provide uniformly high resolution over the entire field of the display or for displays that cannot assume that only one human 110 observer is present and again thus must provide uniformly high resolution over the entire field of the display. As an example, an eye mounted display with only 400,000 physical pixels can produce imagery that an external display may need 100 million or more pixels to equal (a factor of 200 times less pixels). In principle, a variable resolution display also allows image generation or capture devices, whether computer graphics systems, high resolution image playback systems, still or video camera systems, etc., to only compute, decompress, transmit, or capture (for cameras) orders of magnitude fewer pixels than would be required for non eye resolution coupled systems.

Eye mounted displays also require vastly fewer photons compared to existing displays and, therefore, vastly lower power also. Eye mounted displays have several properties that most external display technologies cannot easily take advantage of. Because the display is coupled in space relatively close to the rotations of the eye, only the amount of light that actually will enter the eye (through the pupil) need be produced. These savings are substantial. For an eye mounted display to produce the equitant retinal illumination as a 2,000 lumen video projector viewed from 8 feet away, the eye mounted display need only produce one one thousandth or less of a lumen. This is a factor of one million times fewer photons (both eyes).

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention.

What is claimed is:

1. An eye mounted display for projecting light onto a user's retina to form a visual sensation of an image, the eye mounted display comprising a plurality of sub-displays attached to the user's eye, each sub-display projecting light to different retinal positions within a portion of the retina corresponding to the sub-display, each such projection of light propagating through a partial corneal aperture for that retinal position.

2. The eye mounted display of claim 1 further comprising:
a sclera contact lens mountable on the eye;
a display capsule having an anterior shell and a posterior shell and an interior, the display capsule mounted in the sclera contact lens so that the anterior shell of the display capsule is flush to an anterior surface of the sclera contact lens, the plurality of sub-displays comprising a plurality of femto projectorfemto projectors located in the interior of the display capsule, the femto projectorfemto projectors projecting light through partial corneal apertures that are substantially non-overlapping.

3. The eye mounted display of claim 1 wherein sub-displays that project light to portions of the retina closer to the fovea project light through partial corneal apertures that are larger than the partial corneal apertures through which sub-displays project light to portions of the retina farther away from the fovea.

4. An eye mounted display system for use by a user, comprising:
an eye mounted display that projects light onto the user's retina to form a visual sensation of an image, the eye mounted display comprising a plurality of sub-displays attached to the user's eye, each sub-display projecting light to different retinal positions within a portion of the retina corresponding to the sub-display, each such projection of light propagating through a partial corneal aperture for that retinal position;
an eye tracker that tracks an orientation of the eye;
a scaler coupled to the eye mounted display and to the eye tracker, the scaler receiving video input and converting the video input, based in part on the orientation of the eye received from the eye tracker, to a format suitable for projection by the eye mounted display.

5. The eye mounted display system of claim 4 further comprising:
a headpiece worn by the user, on which is mounted a first portion of a head tracker, a first portion of the eye tracker, and a data link component communicatively coupling the scaler to the eye mounted display, the data link component receiving the converted video input from the scaler and wirelessly transmitting the converted video input to the eye mounted display;
a second portion of the head tracker positioned in a frame of reference, the first and second portions of the head tracker cooperating to track the user's head, the scaler converting the video input based in part on tracking of the user's head; and
the eye mounted display containing a second portion of the eye tracker, the first and second portions of the eye tracker cooperating to track the orientation of the eye.
